(19) United States
(12) Patent Application Publication
(10) Pub. No.: US 2015/0356654 A1
(43) Pub. Date: Dec. 10, 2015

(54) INFORMATION SYSTEM AND INFORMATION PROCESSING METHOD

(71) Applicant: Rakuten, Inc., Tokyo (JP)

(72) Inventor: Jun KATAKAWA, Tokyo (JP)

(73) Assignee: Rakuten, Inc., Tokyo (KR)

(21) Appl. No.: 14/731,498

(22) Filed: Jun. 5, 2015

(30) Foreign Application Priority Data
Jun. 8, 2014 (JP) 2014-118096

(51) Int. Cl. G06Q 30/06; G06Q 10/08

(52) U.S. Cl. CPC G06Q 30/0613; G06Q 30/0631; G06Q 10/083

(57) ABSTRACT

When an item indicated in received order details is a designated item, an information system outputs consideration information generated based on condition information so that a purchaser can confirm the consideration information. When receiving a confirmation notification indicating that the purchaser has confirmed that he/she has understood the consideration information, the information system updates a confirmation state to a completed state. The information system outputs the confirmation state so that whether a process for finalizing the sale of the designated item is ready can be determined.

### CROSS-REFERENCE TO RELATED PATENT APPLICATION

This application claims priority from Japanese Patent Application No. 2014-118096 filed Jun. 6, 2014, the entire disclosure of which, including the specification, the scope of claims, drawings, and abstract, is incorporated herein by reference in its entirety.

### FIELD OF DISCLOSURE

Aspects of the disclosure relate to a technical field of a system for providing information about an item, which a purchaser intends to purchase, from a seller.

### BACKGROUND

For example, JP 2002-24639 A discloses a system that allows a purchaser to consult an online shopping system counselor about the purchaser's physical condition and select an item for purchase from among items recommended by the counselor, who provides an answer and presents recommended items in response to the purchaser's question. In this system, the counselor provides information before the purchaser orders the item.

### SUMMARY

Incidentally, when medicines are sold via the Internet, it may be preferable that individualized information be provided to a purchaser to ensure safety even if the purchaser has decided a medicine for purchase. Specifically, it may be preferable that a seller provide information suitable for a user of the medicine in view of the condition of the user, such as the user's symptoms, and sell the medicine to the purchaser after confirming that the purchaser has understood the provided information. Such items are not limited to medicines. For example, also for food items, it may be preferable to provide information about food allergies and nutritional value foods.

However, when a purchaser purchases an item via the Internet, the procedure that the purchaser sends order details including, for example, an item for purchase, a shipping address, and a payment method is typically established. Thus, when individualized information is provided based on an item and the condition of a user, the provision of such information before the purchaser sends order details, for example, as in the system disclosed in JP 2002-24639 A, causes some modifications of the typically-established procedure. Consequently, this makes it harder for the purchaser to follow the procedure for sending the order details.

In view of the above point, aspects described herein have an object to provide an information system and an information processing method that allow for an easy-to-follow procedure for purchasing an item that requires the provision of individualized information to a purchaser before the sale (sales contract) of the item is finalized, even when the purchaser sends order details of the item, the procedure being as easy-to-follow as a procedure for purchasing an item that does not require any provision of such individualized information.

According to an exemplary non-limiting aspect of the disclosure, there is provided an information system that includes a computer storage operable to store program code and a computer processor coupled to the computer storage. According to an exemplary non-limiting aspect of the disclosure, the computer processor is programmed to receive, when an item ordered by a purchaser is a designated item, condition information indicating a condition related to the use of the item, the designated item requiring a seller of the item to provide consideration information for use to the purchaser; store order details of the items in the computer storage, when the order details of the item are received from the purchaser; scan the received order details and determine whether the item indicated in the received order details is the designated item; store a confirmation state of the consideration information in association with the order details stored in the computer storage, when the item indicated in the received order details is the designated item; receive, in response to the received order details, consideration information generated based on the designated item in the order details and the received condition information; automatically generate a confirmation webpage based on the consideration information and transmit the confirmation webpage page so that for confirmation of the consideration information by the purchaser; receive a confirmation notification indicating that the purchaser has confirmed that the purchaser has understood the consideration information; automatically update the confirmation state stored in the computer storage to a completed state, when the confirmation notification is received; and output the confirmation state stored in the computer storage to determine whether a process for finalizing a sale of the designated item indicated in the order details is ready.

According to the exemplary non-limiting aspect of the disclosure, the consideration information is provided and confirmed after the order details of the designated item are received. In addition, by referring to the output confirmation state that indicate whether the consideration information has been confirmed, the seller, for example, can perform the process for finalizing the sale of the item on the condition that the consideration information has been confirmed. Thus, the aspect of the disclosure allows for an easy-to-follow procedure for purchasing an item that requires the provision of individualized information to a purchaser before the sale (sales contract) of the item is finalized, even when the purchaser sends order details of the item. The procedure is as easy-to-follow as a procedure for purchasing an item that does not require any provision of such individualized information.

### BRIEF DESCRIPTION OF THE DRAWINGS

FIG. 1 is a diagram showing an example of a schematic configuration of an information processing system S1 according to an embodiment;

FIG. 2 is a flowchart showing an overview of a procedure for purchasing a designated medicine;

FIG. 3A is a block diagram showing an example of a schematic configuration of an online shopping mall server 1 according to an embodiment;

FIG. 3B is a diagram showing an example of functional blocks of a system controller 14 of the online shopping mall server 1 according to an embodiment;

FIG. 4A is a diagram showing an example of information stored in a member DB 12a:

FIG. 4B is a diagram showing an example of information stored in a store DB 12b:

FIG. 4C is a diagram showing an example of information stored in an item DB 12c:

FIG. 4D is a diagram showing an example of information stored in a shopping cart DB 12d:

FIG. 4E is a diagram showing an example of information stored in an order DB 12e:

FIG. 4F is a diagram showing an example of information stored in a message DB 12f;

FIG. 5 is a sequence diagram showing an example of a process in the information processing system S1 according to an embodiment;

FIG. 6 is a sequence diagram showing an example of a process in the information processing system S1 according to an embodiment;

FIG. 7 is a diagram showing a display example of an item page of a designated medicine;

FIG. 8A is a diagram showing a display example of a received order list page;

FIG. 8B is a diagram showing an example of the appearance of different confirmation status icons corresponding to different confirmation statuses;

FIG. 9 is a diagram showing a display example of a received order management page;

FIG. 10A is a diagram showing a display example of a message management page;

FIG. 10B is a diagram showing a display example of a message entry page;

FIG. 11 is a diagram showing a display example of an order history page;

FIG. 12A is a diagram showing a display example of a message confirmation page;

FIG. 12B shows an example of the message confirmation page in which check boxes 263 corresponding to all considerations have been checked off;

FIG. 13A shows a display example of the received order list page after a confirmation status is updated to “confirmed”;

FIG. 13B shows a display example of the message management page after the confirmation status is updated to “confirmed”;

FIG. 14A shows a display example of the received order list page when the confirmation status is not updated to “confirmed”;

FIG. 14B shows a display example of the message management page when the confirmation status is not updated to “confirmed”;

FIG. 15A shows a display example of the received order management page after a payment status is updated to “completed” and the confirmation status is updated to “confirmed”;

FIG. 15B shows a display example of the received order list page after a shipping status is updated to “waiting to be shipped”;

FIG. 16 is a flowchart showing an example of an order detail registration process in the system controller 14 of the online shopping mall server 1 according to an embodiment;

FIG. 17 is a flowchart showing an example of a received order list sending process in the system controller 14 of the online shopping mall server 1 according to an embodiment;

FIG. 18 is a flowchart showing an example of a store message registration process in the system controller 14 of the online shopping mall server 1 according to an embodiment;

FIG. 19 is a flowchart showing an example of an order history sending process in the system controller 14 of the online shopping mall server 1 according to an embodiment;

FIG. 20 is a flowchart showing an example of a purchaser message registration process in the system controller 14 of the online shopping mall server 1 according to an embodiment;

FIG. 21 is a flowchart showing an example of a shipping status control process in the system controller 14 of the online shopping mall server 1 according to a modification of an embodiment;

FIG. 22 is a diagram showing an example of a schematic configuration of an information processing system S2 according to an embodiment;

FIG. 23A is a block diagram showing an example of a schematic configuration of a store server 5 according to an embodiment;

FIG. 23B is a diagram showing an example of functional blocks of a system controller 54 of the online shopping mall server 1 according to an embodiment;

FIG. 24 is a sequence diagram showing an example of a process, in the information processing system S2 according to an embodiment, for providing consideration information;

FIG. 25 is a sequence diagram showing an example of a process, in the information processing system S2 according to an embodiment, for updating the confirmation status and the shipping status;

FIG. 26 is a flowchart showing an example of a shipping status update determination process in the system controller 54 of the store server 5 according to an embodiment;

FIG. 27A is a diagram showing a display example of the received order management page when the confirmation status is “confirmed”;

FIG. 27B is a diagram showing a display example of the received order management page when the confirmation status is “unconfirmed”;

FIG. 28 is a flowchart showing an example of a received order management page sending process in the system controller 14 of the online shopping mall server 1 according to an embodiment;

FIG. 29 is a diagram showing an example of a schematic configuration of an information processing system S3 according to an embodiment;

FIG. 30A is a diagram showing a display example of the received order management page when the confirmation status is “confirmed”;

FIG. 30B is a diagram showing a display example of the received order management page when the confirmation status is “unconfirmed”;

FIG. 31 is a flowchart showing an example of the received order management page sending process in the system controller 14 of the online shopping mall server 1 according to an embodiment;

FIG. 32 is a diagram showing an example of functional blocks of the system controller 14 of the online shopping mall server 1 according to an embodiment;

FIG. 33 is a flowchart showing an example of an automatic cancellation process in the system controller 14 of the online shopping mall server 1 according to an embodiment;

FIG. 34 is a diagram showing a display example of the order history page;

FIG. 35 is a diagram showing a display example of a reorder detail confirmation page;

FIG. 36 is a flowchart showing an example of the order history sending process in the system controller 14 of the online shopping mall server 1 according to an embodiment;

FIG. 37 is a flowchart showing an example of a reorder confirmation page sending process in the system controller 14 of the online shopping mall server 1 according to an embodiment;

FIG. 38 is a flowchart showing an example of a reorder detail registration process in the system controller 14 of the online shopping mall server 1 according to an embodiment;

FIG. 39 is a diagram showing a display example of the reorder detail confirmation page;

FIG. 40 is a diagram showing an example of information stored in a user condition question DB 12g;

FIG. 41 is a flowchart showing an example of the reorder confirmation page sending process in the system controller 14 of the online shopping mall server 1 according to an embodiment;

FIG. 42 is a flowchart showing an example of the reorder detail registration process in the system controller 14 of the online shopping mall server 1 according to an embodiment;

FIG. 43 shows an example of information stored in a delivery days DB 12h;

FIG. 44 is a flowchart showing an example of the automatic cancellation process in the system controller 14 of the online shopping mall server 1 according to an embodiment;

FIG. 45 is a diagram showing an example of functional blocks of the system controller 14 of the online shopping mall server 1 according to an embodiment;

FIG. 46 is a flowchart showing an example of a reminder interval determination process in the system controller 14 of the online shopping mall server 1 according to an embodiment;

FIG. 47 is a flowchart showing an example of the store message registration process in the system controller 14 of the online shopping mall server 1 according to an embodiment;

FIG. 48 is a flowchart showing an example of a reminder e-mail sending process in the system controller 14 of the online shopping mall server 1 according to an embodiment;

FIG. 49 is a flowchart showing an example of the reminder interval determination process in the system controller 14 of the online shopping mall server 1 according to an embodiment;

FIG. 50 is a flowchart showing an example of the store message registration process in the system controller 14 of the online shopping mall server 1 according to an embodiment;

FIG. 51 is a flowchart showing an example of the store message registration process in the system controller 14 of the online shopping mall server 1 according to an embodiment;

FIG. 52 is a diagram showing a display example of an order detail receipt completion page; and

FIG. 53 is a flowchart showing an example of an order detail receipt completion sending process in the system controller 14 of the online shopping mall server 1 according to an embodiment.

### DETAILED DESCRIPTION

Embodiments are described in detail below with reference to the drawings.

### 1. First Embodiment

### 1-1. Configuration and Functional Overview of Information Processing System

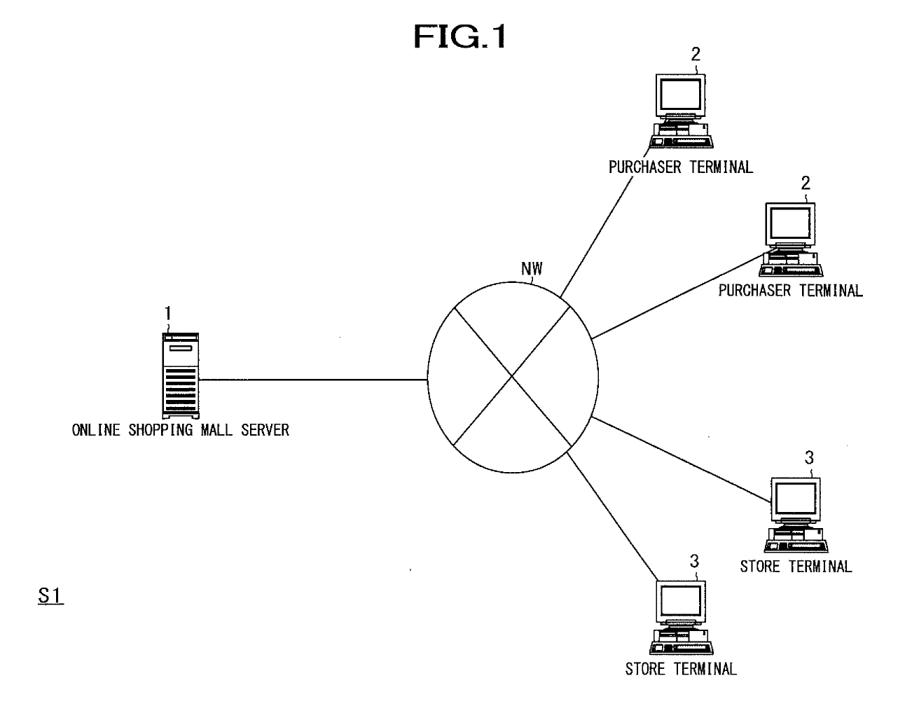

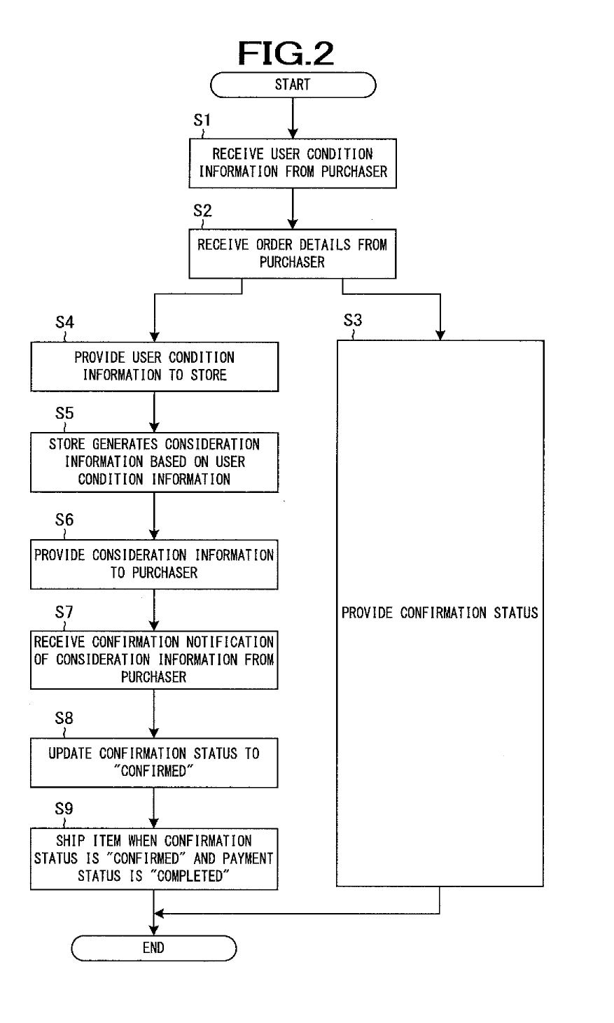

First, a configuration and a functional overview of an information processing system S1 according to the present embodiment will be described with reference to FIGS. 1 and 2. FIG. 1 is a diagram showing an example of a schematic configuration of the information processing system S1 according to this embodiment.

As shown in FIG. 1, the information processing system 51 includes an online shopping mall server 1, a plurality of store terminals 2, and a plurality of purchaser terminals 3. The online shopping mall server 1 can exchange data with each store terminal 2 and each purchaser terminal 3 via a network NW using communication protocols, such as TCP/IP. The network NW includes, for example, the Internet, a dedicated communication line (e.g., community antenna television (CATV) line), a mobile communication network (including a base station), and a gateway.

The online shopping mall server 1 is a server device that performs various processes related to an online shopping mall through which items can be purchased. The online shopping mall server 1 is an example of an information system. A purchaser who uses the online shopping mall can purchase a desired item from a desired store through the online shopping mall. The online shopping mall server 1, for example, sends web pages of the online shopping mall and performs processes related to item searches, orders, and the like, in response to requests from the store terminal 2 and the purchaser terminal 3.

The store terminal 2 is a terminal device used by, for example, an employee of a store in the online shopping mall. The store terminal 2 accesses a server device such as the online shopping mall server 1 in response to an operation by, for example, the employee. Thus, the store terminal 2 receives a web page from the server device to display the web page. The store terminal 2 has software, such as a browser and an e-mail client, installed on it. The employee, for example, enters information about items for sale into the online shopping mall and checks item order details by using the store terminal 2. A store is an example of a seller who sells items.

The purchaser terminal 3 is a terminal device of a purchaser who purchases items through the online shopping mall. The purchaser terminal 3 accesses the online shopping mall server 1 in response to an operation by the purchaser and receives a web page from the online shopping mall server 1 to display the web page. The purchaser terminal 3 has software, such as a browser and an e-mail client, installed on it. For example, a personal computer, a personal digital assistant (PDA), a portable information terminal such as a smartphone, and a mobile phone are used as the purchaser terminal 3.

To purchase an item through the online shopping mall, the purchaser causes the online shopping mall server 1 to search for items that suit his/her requirements. When the purchaser selects his/her desired item from among the retrieved items, the online shopping mall server 1 sends an item page to the purchaser terminal 3. The item page is, for example, a web page that displays detailed information about the item selected by the purchaser. The purchaser selects the quantity of the item on the item page. Some items require a purchaser to make a selection of a specific attribute on their item pages. Examples of such an attribute include the color and the size of the item. The purchaser adds the selected item to a shopping cart on the item page. The shopping cart is a virtual container to which item(s) for order selected by purchaser are added. When ordering the item added to the shopping cart, the purchaser enters order details. Examples of the order details include the purchaser's intension to purchase, the item to be ordered, the quantity of the item, a payment method for the purchase price, a shipping method, a delivery date, and a shipping address for the item. The item to be ordered and the quantity of the item are previously selected. An item indicated in order details is referred to as an item ordered. After the purchaser determines the order details, the order details are received by the online shopping mall server 1. When a process for payment of the purchase price of the item ordered is completed, a store, the seller of the item ordered, ships the item ordered to the purchaser.

The online shopping mall sells various kinds of items. Some items for sale require stores to preferably provide individualized information to purchasers to ensure safety use. In Japan, examples of such items include class-1 over-the-counter (OTC) drugs and class-2 OTC drugs. The class-1 OTC drugs and the class-2 OTC drugs are designated by the Minister of Health, Labor and Welfare. These drugs are referred to as designated medicines. Such a designated medicine is an example of a designated item. A user of a designated medicine that a purchaser intends to purchase is referred to as simply a user. The purchaser and the user of the designated medicine may be the same, or they may be different. For example, the purchaser may purchase the designated medicine on behalf of the user. To ensure safe use of a designated medicine by the user, the online shopping mall server 1 performs a process for providing, from the store, individualized information based on the user's condition to a purchaser who intends to purchase the designated medicine and a process for finalizing the sale (sales contract) of the designated medicine on the condition that the purchaser has confirmed that he/she has understood the information provided from the store. Information indicating a user's condition is referred to as user condition information. The user condition information is an example of condition information. Examples of the user condition information may include the user's gender, age, symptoms, whether he/she experienced any side effect, side effect details, whether he/she is chronically diseased, chronic disease details, whether he/she had any consultation at medical facilities, consultation details, pregnancy status, whether she is breast-feeding, and other concerns. Information provided based on a user's condition from a store to a purchaser is referred to as consideration information. Examples of the consideration information may include directions, a dosage, considerations for use, precautions after use, and an inquiry as to whether there are any questions. The designated medicines may include class-3 OTC drugs in addition to the class-1 OTC drugs and the class-2 OTC drugs. Alternatively, the designated medicines may include only the class-1 OTC drugs. Alternatively, specific items different from the designated medicines may be items that requires the above information provision. Examples of such items include food items having food allergies and nutritional value. Assume in this embodiment that the class-1 OTC drugs and the class-2 OTC drugs are the items requiring the provision of consideration information. Items that do not require any provision of consideration information are referred to as general items.

The following describes an overview of a procedure for purchasing a designated medicine. FIG. 2 is a flowchart showing an overview of a procedure for purchasing a designated medicine. First, the online shopping mall server 1 receives user condition information of a user who uses a designated medicine ordered by a purchaser (Step S1). The user condition information that is to be entered may be predefined for each designated medicine, for example, by a store. The purchaser can enter user condition information, for example, on an item page of the designated medicine. When the purchaser performs an operation for adding the designated medicine to a shopping cart after entering the user condition information, the purchaser terminal 3 sends the user condition information to the online shopping mall server 1. Alternatively, for example, when the purchaser performs an operation for adding the designated medicine to the shopping cart, the online shopping mall server 1 may send a web page for entering the user condition information to the purchaser terminal 3 and receive the user condition information entered on this web page.

Then, the purchaser enters order details about the item added to the shopping cart. The purchaser terminal 3 sends the entered order details to the online shopping mall server 1, and the online shopping mall server 1 receives the order details (Step S2). The online shopping mall server 1 stores the order details and the user condition information in association with each other in storage means, which is included in the online shopping mall server 1. When the item ordered is a designated medicine, the online shopping mall server 1 further stores a confirmation status in association with the order details in the storage means. The confirmation status indicates whether the purchaser has confirmed that he/she has understood consideration information provided from the store. The confirmation status is set to any of “unconfirmed” and “confirmed”. The confirmation status at the time of receiving the order details is “unconfirmed”. After that, the online shopping mall server 1 can provide the confirmation status to the store (Step S3). Here, the online shopping mall server 1 process the confirmation status so that whether a process for finalizing the sale of the item ordered is ready can be determined. For example, when sending a web page for displaying information about the received order to the store terminal 2, the online shopping mall server 1 puts information indicating the confirmation status in this web page. In this embodiment, shipping the item ordered, for example, is defined as the process for finalizing the sale of the item ordered. That is, in this embodiment, the confirmation status is information for determining whether the item ordered is ready for shipment. Alternatively, the store's sending an e-mail for confirming the order details to the purchaser, for example, may be defined as the process for finalizing the sale of the item ordered.

After receiving the order details of the designated medicine, the online shopping mall server 1 provides the user condition information to the store terminal 2 (Step S4). The store terminal 2 generates consideration information based on the user condition information (Step S5). For example, a pharmacist working for the store enters consideration information based on the user condition information. The store terminal 2 sends the consideration information to the online shopping mall server 1, and the online shopping mall server 1 provides the consideration information to the purchaser terminal 3 (Step S6). Here, the online shopping mall server 1 provides the consideration information so that the consideration information can be confirmed. The purchaser enters an answer to the consideration information provided from the store. Then the purchaser terminal 3 sends the entered answer to the online shopping mall server 1. When the purchaser performs an operation for answering that he/she has understood the consideration information, the online shopping mall server 1 receives the answer sent from the purchaser terminal 3 as a notification indicating that the purchaser has understood the consideration information (Step S7). The online shopping mall server 1 that has received this notification updates the confirmation status to “confirmed” (Step S8).

The store to which confirmation status is provided determines whether the process for finalizing the sale of the item ordered is ready, based on the confirmation status. In this embodiment, the store determines whether the item ordered is ready for shipment. For example, in addition to the confirmation status, a payment status may be the information for determining whether the item ordered is ready for shipment. The payment status is an example of a processing status. The payment status indicates whether the process for payment of the purchase price of the item ordered is completed. The payment status is set to any of “uncompleted” and “completed”. When the confirmation status is “unconfirmed” or when the payment status is “uncompleted”, the store determines that the item ordered is not ready for shipment. When the confirmation status is “confirmed” and when the payment status is “completed”, the store determines that the item ordered is ready for shipment. Then the store ships the item ordered (Step S9). When the store's sending an e-mail for confirming the order details to the purchaser is defined as the process for finalizing the sale of the item ordered, for example, if the confirmation status is “confirmed”, the store may determine that the process for finalizing the sale is ready regardless of the payment status.

Basically, there is no difference between general items and designated medicines in the procedure up to the purchaser's sending the order details. The purchaser can enter user condition information for ordering a designated medicine just as he/she enters attributes such as the color and the size of a general item. Thus, the procedure is easy for the purchaser to follow. The online shopping mall server 1, for example, may perform control to cause the purchaser to enter the user condition information after the order details are sent. After receiving the order details, the online shopping mall server 1 provides the confirmation status indicating whether the purchaser has confirmed considerations so that whether the process for finalizing the sale is ready can be determined. This can prevent the store from performing the process for finalizing the sale by mistake.

### 1-2. Configuration of Online Shopping Mall Server

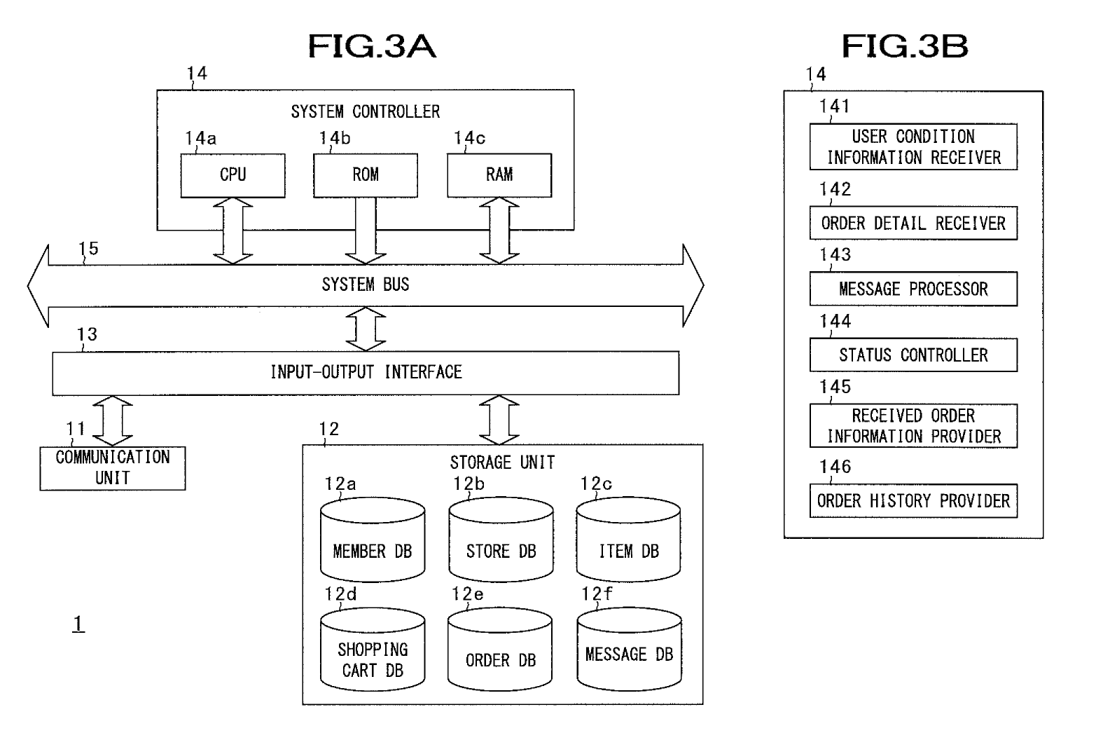

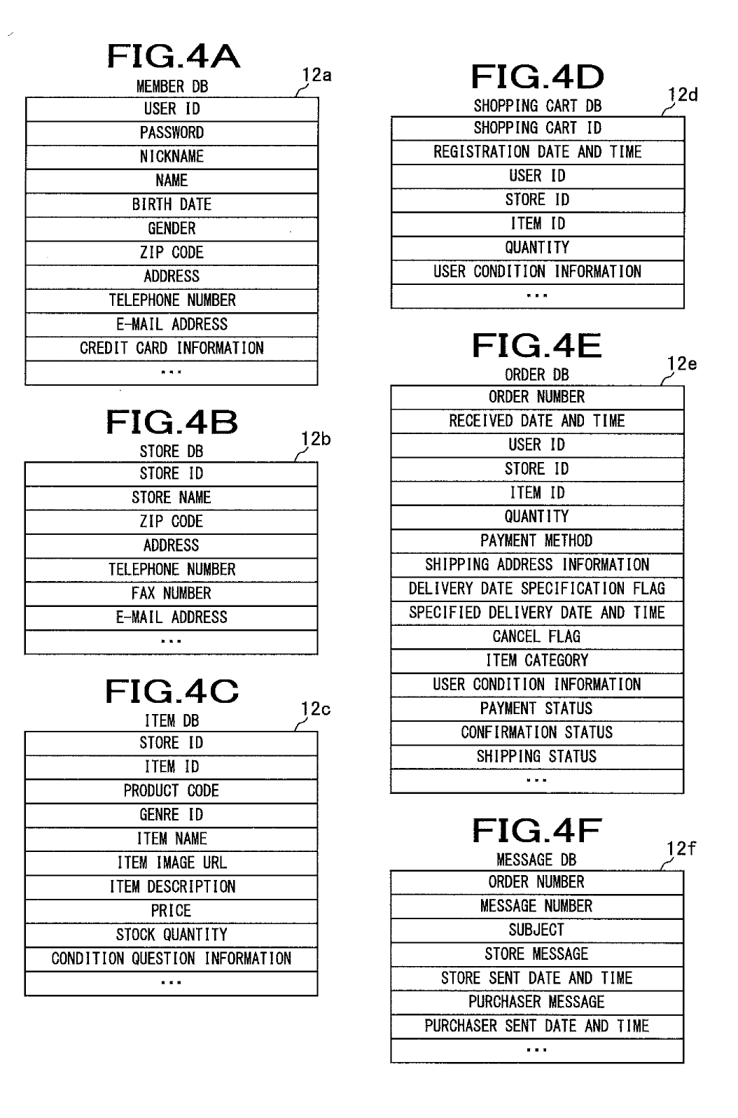

The following describes a configuration of the online shopping mall server 1 with reference to FIGS. 3 and 4. FIG. 3A is a block diagram showing an example of a schematic configuration of the online shopping mall server 1 according to this embodiment. As shown in FIG. 3A, the online shopping mall server 1 includes a communication unit 11, a storage unit 12, an input-output interface 13, and a system controller 14. The system controller 14 and the input-output interface 13 are connected via a system bus 15.

The communication unit 11 connects to the network NW and controls the state of communications with the store terminal 2, the purchaser terminal 3, and the like.

The storage unit 12 includes, for example, a hard disk drive. The storage unit 12 is an example of order detail storage means, confirmation state storage means, state storage means, and condition information storage means. For example, at least two of the order detail storage means, the confirmation state storage means, the state storage means, and the condition information storage means may be in the same storage device. Alternatively, these storage means may be in storage devices that are different from each other. In this storage unit 12, a member DB 12a, a store DB 12b, an item DB 12c, a shopping cart DB 12d, an order DB 12e, a message DB 12f, and other databases have been created. “DB” is an abbreviation for “database”.

FIG. 4A is a diagram showing an example of information stored in the member DB 12a. The member DB 12a stores member information about purchasers who have signed up for the online shopping mall. Specifically, the member DB 12a stores purchaser attributes, such as a user ID, a password, a nickname, a name, a birth date, a gender, a zip code, an address, a telephone number, an e-mail address, and credit card information, in association with each purchaser.

FIG. 4B is a diagram showing an example of information stored in the store DB 12b. The store DB 12b stores store information about stores that sell items through the online shopping mall. Specifically, the store DB 12b stores store attributes, such as a store ID, a store name, a zip code, an address, a telephone number, a fax number, and an e-mail address, in association with each store. The store ID is identification information of the store.

FIG. 4C is a diagram showing an example of information stored in the item DB 12c. The item DB 12c stores item information about items sold through the online shopping mall. The item information includes information entered by the stores. Specifically, the item DB 12c stores a store ID, an item ID, an product code, a genre ID, an item name, the URL of an item image, an item description, a price, a stock quantity, condition question information, and other information, in association with each of the items sold by the stores. The store ID indicates a store which sells the item. The item ID is identification information of the item and is used for the store to manage the item for sale. The product code is a code number that identifies the item. When a plurality of stores sell the same items, each of the items is given the same product code. Examples of the product code include Japanese article number (JAN) codes. The genre ID is identification information for identifying which genre the item belongs to among various item genres. Some of the genre IDs indicate “class-1 OTC drug” and “class-2 OTC drug”. The system controller 14 can identify whether an item is a designated medicine based on its genre ID. The condition question information is stored when the genre ID indicates “designated medicine”. The condition question information is information for asking a question about the condition of a user of a designated medicine. For example, the condition question information may include, for each question, a text indicating the question and a text indicating options for answer to the question.

FIG. 4D is a diagram showing an example of information stored in the shopping cart DB 12d. The shopping cart DB 12d stores shopping cart information about items added to shopping carts. Specifically, the shopping cart DB 12d stores a shopping cart ID, a registration date and time, a user ID, a store ID, an item ID, an item quantity, and user condition information, and other information, in association with each of the items added to the shopping carts. The shopping cart ID is identification information of each piece of the shopping cart information. The registration date and time indicates the date and time at which the item was added to the shopping cart. The user ID indicates the purchaser who added the item to the shopping cart. The combination of the store ID and the item ID indicates the item added to the shopping cart. When the item added to the shopping cart is a designated medicine, user condition information is stored in the shopping cart DB 12d. The user condition information stored in the shopping cart DB 12d indicates the condition of the user of the item added to the shopping cart.

FIG. 4E is a diagram showing an example of information stored in the order DB 12e. The order DB 12e stores order information about orders for items. The order information is used not only as information for order management by the stores but also as information about order histories of purchasers. An order history is a receipt history of order details. The term “order history” may be written as, for example, “purchase history”. Specifically, every time the online shopping mall server 1 receives order details from a purchaser, an order number, a received date and time, a user ID, a store ID, an item ID, an item quantity, a payment method, shipping address information, a delivery date specification flag, a specified delivery date and time, a cancel flag, an item category, user condition information, a payment status, a confirmation status, a shipping status, and other information are stored in association with each other in the order DB 12e. The order number is identification number of the order. The received date and time indicates the date and time at which the order details were received.

The user ID, the store ID, the item ID, the item quantity, the payment method, the shipping address information, the delivery date specification flag, and the specified delivery date and time indicate the order details. The user ID indicates the purchaser who ordered the item. The store ID indicates the store that received the order. The combination of the store ID and the item ID indicates the item ordered. The payment method indicates how to pay the purchase price of the item. Examples of the payment method include a credit card payment, a bank transfer, a payment at a convenience store, and a cash on delivery. The shipping address information includes the recipient's zip code, address, and name. The delivery date specification flag indicates whether the purchaser specified a delivery date or a delivery date and time of the item or not. The specified delivery date and time is stored when the delivery date specification flag is set to TRUE. The specified delivery date and time indicates the specified delivery date or the specified delivery date and time. The cancel flag indicates whether receipt of the order details has been canceled. The item category indicates whether the item ordered is a designated medicine or a general item that does not require any provision of consideration information. When the item category is “designated medicine”, user condition information is stored in the order DB 12e. The user condition information stored in the order DB 12e indicates the condition of the user of the item ordered.

The payment status indicates which state the process for payment of the purchase price of the item ordered is in. The payment status is set to, for example, any of “uncompleted” and “completed” . The status “uncompleted” indicates that the process for payment of the purchase price is not completed. The status “completed” indicates that the process for payment of the purchase price is completed. For example, the payment status may be updated to “completed” based on an operation from the online shopping mall server 1 or from an employee of the store. For example, when the payment method is a credit card payment, the online shopping mall server 1 may perform an authorization process for the payment of the purchase price with a credit card, and update the payment status to “completed” if the payment with the credit card is authorized. When the payment method is a bank transfer or a payment at a convenience store, for example, after confirming payment from the purchaser, the store may have the online shopping mall server 1 update the payment status to “completed” by operating the store terminal 2.

The confirmation status is stored in the order DB 12e when the item category is “designated medicine”. The confirmation status is set to any of “unconfirmed” and “confirmed”. The status “unconfirmed” may include, for example, statuses “unsent from store”, “unanswered by purchaser”, and “answered but ongoing”. The status “unsent from store” indicates a state before the store sends consideration information. The status “unanswered by purchaser” indicates a state where the store sent the consideration information and the purchaser has not yet returned an answer to the consideration information. The status “answered but ongoing” indicates a state where the purchaser returned an answer to the consideration information once but a confirmation regarding at least a portion of the consideration information has not yet been obtained from the purchaser.

The shipping status indicates which phase the shipment of the item ordered is in. The shipping status may be set to, for example, any of “unshippable”, “waiting to be shipped”, and “shipped”. The status “unshippable” indicate a state where the item ordered cannot be shipped. The status “waiting to be shipped” indicates a state where the item ordered can be shipped but has not yet been shipped. The status “shipped” indicates that the item ordered is already shipped. The shipping status may be updated, for example, based on an operation by the store employee.

FIG. 4F is a diagram showing an example of information stored in the message DB 12f. When an item ordered is a designated medicine, messages exchanged between the purchaser and the store are stored in the message DB 12f. Specifically, every time a message is sent from the store terminal 2 to the online shopping mall server 1, an order number, a message number, a message subject, a store message, a store sent date and time, and other information are stored in the message DB 12f. The order number stored in the message DB 12f indicates the order number of the order details associated with the message from the store. The message number is a number indicating what number message the message sent from the store is. The store message is the message sent from the store. The store message with a message number of 1 is consideration information. The store sent date and time indicating the date and time when the store message was sent. When the purchaser sent an answer message in response to the message sent from the store, a purchaser message and a purchaser sent date and time are further stored in the message DB 12f. The purchaser message is the message sent from the purchaser. The purchaser sent date and time indicates the date and time at which the purchaser message was sent.

The following describes other information stored in the storage unit 12. The storage unit 12 stores various data, such as hypertext markup language (HTML) documents, extensible markup language (XML) documents, image data, text data, and electronic documents, for displaying web pages. For example, the storage unit 12 stores image data of confirmation status icons corresponding to the confirmation statuses. The storage unit 12 also stores various setting values.

The storage unit 12 also stores various programs, such as an operating system, a World Wide Web (WWW) server program, a database management system (DBMS), and an e-commerce management program. The e-commerce management program is a program for performing various processes related to e-commerce. The various programs, for example, may be acquired from another server device or the like via the network NW, or may be recorded in a recording medium, such as an optical disk, and be read via a drive device. The e-commerce management program and other programs may be program products.

The input-output interface 13 performs interface processing between the communication unit 11 and the storage unit 12, and the system controller 14.

The system controller 14 includes, for example, a CPU 14a, a read only memory (ROM) 14b, a random access memory (RAM) 14c. The CPU 14a is an example of a processor. This embodiment can be applied to various processors different from CPUs. The storage unit 12, the ROM 14b, and the RAM 14c each are an example of a memory. This embodiment can also be applied to various memories different from hard disks, ROMs, and RAMs.

The online shopping mall server 1 may include a plurality of server devices. For example, server devices, such as a server device that handles orders for items through the online shopping mall, a server device that performs processes for providing information about designated medicines, a server device that sends web pages in response to requests from the store terminal 2 and the purchaser terminal 3, and a server device that manages databases, may be connected to each other via a LAN or the like.

### 1-3. Functional Overview of System Controller

The following describes a functional overview of the system controller 14 with reference to FIG. 3B. FIG. 3B is a diagram showing an example of functional blocks of the system controller 14 of the online shopping mall server 1 according to this embodiment. As shown in FIG. 3B, programs such as the e-commerce management program, read and executed by the CPU 14a, enable the system controller 14 to function as, for example, a user condition information receiver 141, an order detail receiver 142, a message processor 143, a status controller 144, a received order information provider 145, and an order history provider 146. The user condition information receiver 141 is an example of condition information receiving means. The order detail receiver 142 is an example of order detail storage control means, confirmation state storage control means, state storage control means, and condition information storage control means. The message processor 143 is an example of consideration information output means and notification information output means. The message processor 143 is an example of confirmation notification receiving means. The status controller 144 is an example of updating means. The received order information provider 145 is an example of confirmation state output means. The order history provider 146 is an example of link information presentation control means.

When an item ordered by a purchaser is a designated medicine, the user condition information receiver 141 receives user condition information of a user of the item from the purchaser. When order details of the item are sent from the purchaser terminal 3 to the online shopping mall server 1, the order detail receiver 142 receives the order details. The order detail receiver 142 stores, as order information, the received order details, the payment status set to “uncompleted”, the shipping status set to “unshippable”, the user condition information received by the user condition information receiver 141, and other information in association with each other in the order DB 12e. When the item ordered that is indicated in the received order details is a designated medicine, the order detail receiver 142 further stores the confirmation status set to “unsent from store” (“unconfirmed”) in association with the order details in the order DB 12e. The message processor 143 performs a process for storing a store message sent from the store terminal 2 in the message DB 12f and a process for providing the store message to the purchaser terminal 3. When the item ordered is a designated medicine, the message processor 143 also outputs consideration information generated based on the item ordered and the user condition information so that the purchaser can confirm the consideration information. The message processor 143 also performs a process for storing a purchaser message sent from the purchaser terminal 3 in the message DB 12f and a process for providing the purchaser message for the store terminal 2. The message processor 143 also receives, from the purchaser terminal 3, a notification indicating that the purchaser has confirmed that he/she has understood the consideration information output by the message processor 143. When the message processor 143 receives the notification indicating that the purchaser has confirmed that he/she has understood the consideration information, the status controller 144 updates the confirmation status stored in the order DB 12e to “confirmed”. The received order information provider 145 sends a web page for order management to the store terminal 2. The web page for order management is a web page for managing the order indicated by the order details received for the store. The received order information provider 145 also outputs the confirmation status stored in the order DB 12e so that whether the process for finalizing the sale of the item ordered that is indicated in the order details stored in the order DB 12e is ready can be determined. The order history provider 146 sends an order history page to the purchaser terminal 3. The order history page is a web page showing an order history of the purchaser. Detailed processes in these units are described below.

### 1-4. Operation of Information Processing System

### 1-4-1. Operation of Overall System

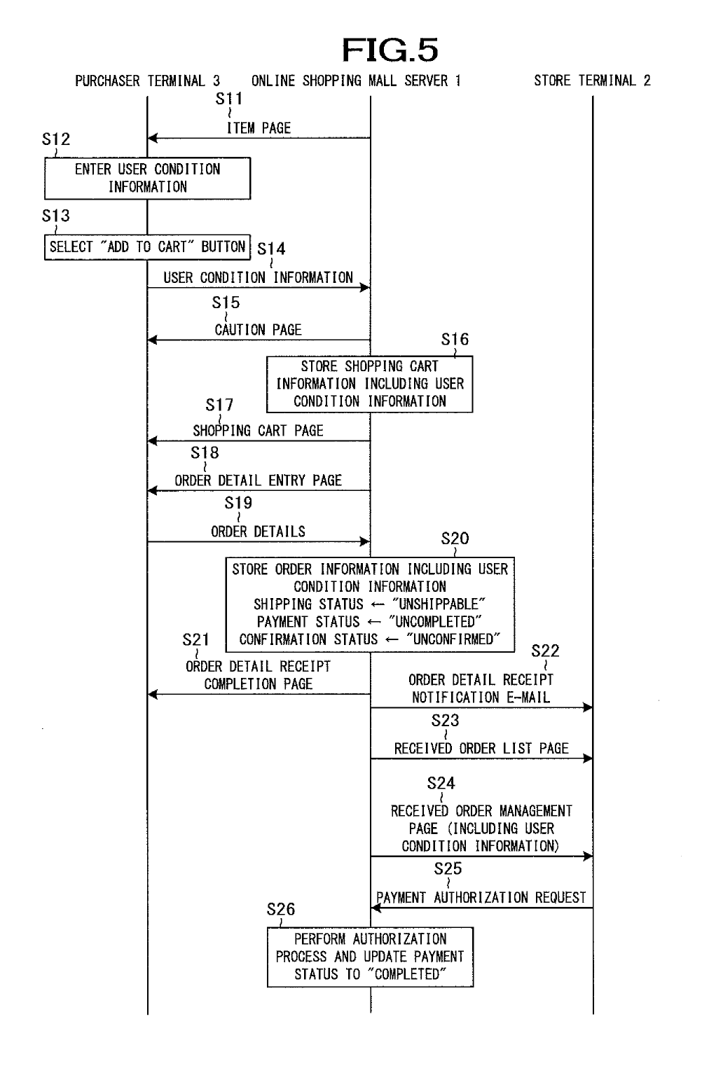

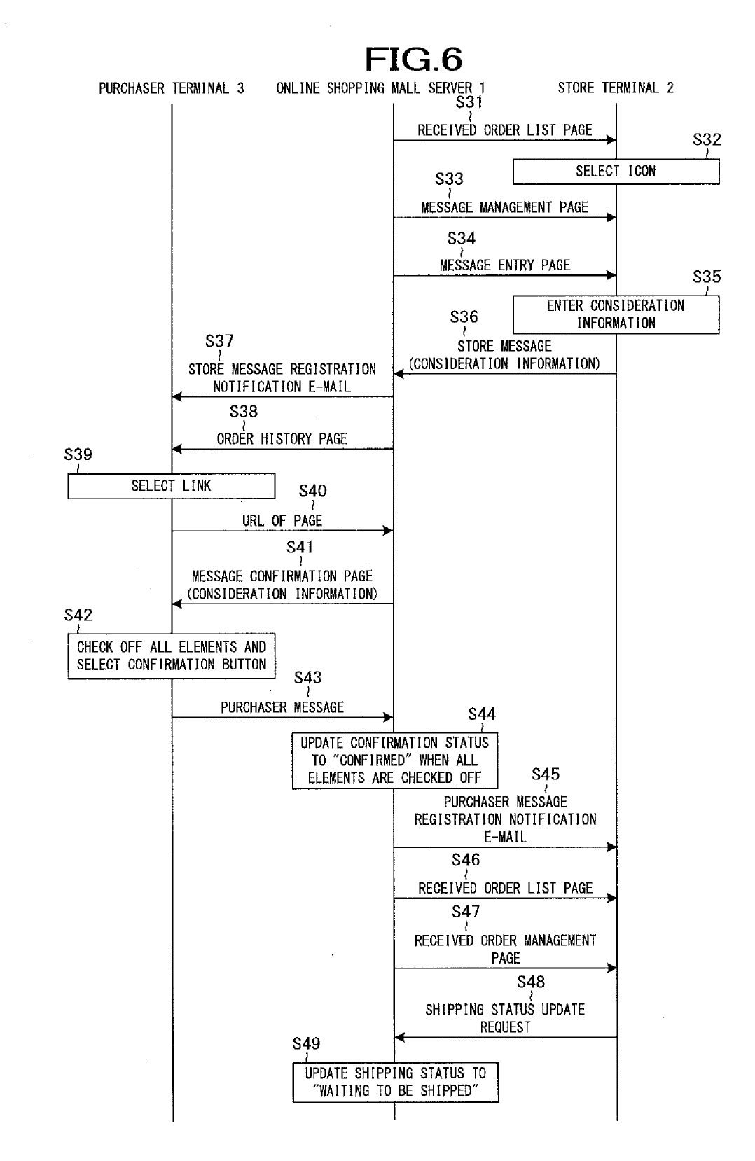

The following describes an overall operation of the information processing system S1 with reference to FIGS. 5 to 15. FIGS. 5 and 6 each are a sequence diagram showing an example of a process in the information processing system S1 according to this embodiment. A purchaser has the online shopping mall server 1 search for items, for example, by operating the purchaser terminal 3. When the purchaser selects a desired item, for example, a designated medicine from among the retrieved items, as shown in FIG. 5, the system controller 14 of the online shopping mall server 1 sends an item page of the selected designated medicine to the purchaser terminal 3 in response to a request from the purchaser terminal 3 (Step S11).

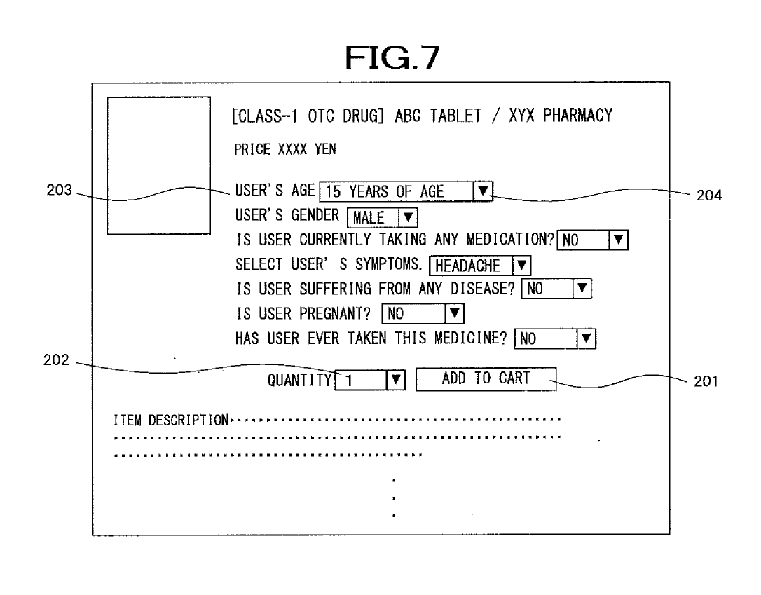

FIG. 7 is a diagram showing a display example of the item page of the designated medicine. As shown in FIG. 7, the item page displays information about the item, such as the name of the item, the price, an image of the item, and a description of the item. The item page also displays an “add to cart” button 201 and a quantity entry field 202. The “add to cart” button 201 is a button for adding the item shown in the item page to a shopping cart. The quantity entry field 202 is an entry field for entering the quantity of the item to be ordered. In the case of a designated medicine, the item page further displays condition question information. Specifically, the item page displays a question 203 and a selection menu 204 for each question about the condition of a user. The question 203 is a text indicating the question. The selection menu 204 is a pull-down menu for selecting an answer to the corresponding question. The system controller 14 generates an HTML document of the item page based on the item information stored in the item DB 12c. When the genre ID included in the item information indicates “designated medicine”, the system controller 14 obtains the condition question information from the item information. The system controller 14 then adds data for displaying the questions 203 and the selection menus 204 to the HTML document of the item page based on the condition question information.

When ordering the selected designated medicine, the purchaser selects the condition of the user by operating the selection menu 204 as needed (Step S12). Then, when the purchaser selects the “add to cart” button 201 (Step S13), the purchaser terminal 3 sends a shopping cart registration request to the online shopping mall server 1 (Step S14). The shopping cart registration request includes, for example, the user ID of the purchaser, the store ID and item ID corresponding to the item to be added to the shopping cart, and the quantity of the item. The shopping cart registration request also includes user condition information. For example, the user condition information includes, in association with each question, a text indicating the question and a text indicating the condition selected by the purchaser. The user condition information receiver 141 retrieves, from the item DB 12c, the genre ID corresponding to the store ID and item ID included in the shopping cart registration request, and then determines whether the genre ID indicates “designated medicine”. If the genre ID does not indicate “designated medicine”, the user condition information receiver 141 adds the information included in the received shopping cart registration request as shopping cart information to the shopping cart DB 12d. On the other hand, if the genre ID indicates “designated medicine”, the user condition information receiver 141 sends a caution page to the purchaser terminal 3 (Step S15). The caution page is a web page for calling attention of the purchaser who orders a designated medicine. When the purchaser selects a button for indicating that he/she has agreed to precautions displayed in the caution page, the user condition information receiver 141 stores, in response to a request from the purchaser terminal 3, the information included in the shopping cart registration request as the shopping cart information, in the shopping cart DB 12d (Step S16). Thus, the user condition information receiver 141 receives the user condition information.

Subsequently, the system controller 14 sends a shopping cart page to the purchaser terminal 3 (Step S17). The shopping cart page is a web page that displays information about the item added to the shopping cart. When the purchaser selects a button for ordering the designated medicine added to the shopping cart on the shopping cart page, the order detail receiver 142 sends an order detail entry page in response to a request from the purchaser terminal 3 (Step S18). The order detail entry page is a web page for entering at least a portion of order details. On the order detail entry page, the purchaser enters, for example, a payment method, a shipping method, whether he/she specifies a delivery date and time, a specified delivery date and time, and a shipping address. Then, when the purchaser selects a button for determining the order details, the purchaser terminal 3 sends information about the order details, such as the entered information, the user ID of the purchaser, the store ID and item ID corresponding to the item ordered, and the quantity of the item, to the online shopping mall server 1 (Step S19). The order detail receiver 142 stores order information including the received information in the order DB 12e (Step S20). At this time, the order detail receiver 142 sets the shipping status to “unshippable” and sets the payment status to “uncompleted” in the order information. The order detail receiver 142 also sets the cancel flag to FALSE. When the item ordered is a designated medicine, the order detail receiver 142 retrieves the user condition information from the shopping cart DB 12d, and puts the user condition information and the confirmation status set to “unsent from store” (“unconfirmed”) in the order information. After receiving the order details in such a manner, the order detail receiver 142 sends an order detail receipt completion page to the purchaser terminal 3 (Step S21). The order detail receipt completion page is a web page that displays a message indicating that the order details have been received. The order detail receiver 142 also sends an order detail receipt notification e-mail to the store identified by the store ID included in the order information (Step S22). The order detail receipt notification e-mail is an e-mail notifying that the order details of the item sold by the store have been received. The body of the order detail receipt notification e-mail includes, for example, at least a portion of the order details, the order number, and the received date and time. The body of the order detail receipt notification e-mail may also include, for example, the user condition information.

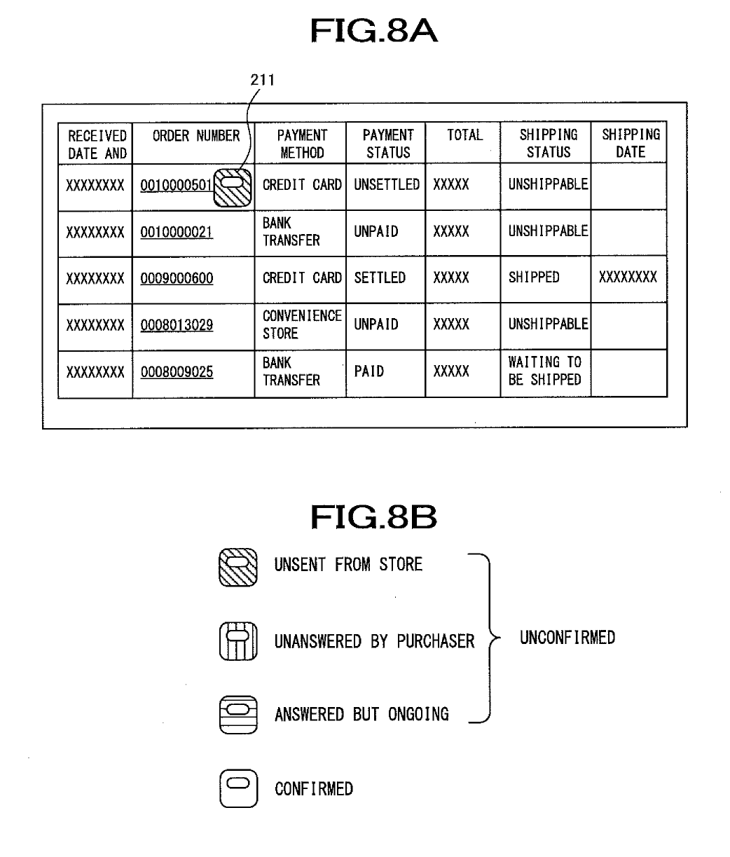

A store employee who has read the order detail receipt notification e-mail performs an operation for displaying received order information. Then the received order information provider 145 sends a received order list page to the store terminal 2 in response to a request from the store terminal 2 (Step S23). The received order list page is a web page that displays a list of orders to the store. The received order list page is an example of information for sellers. FIG. 8A is a diagram showing a display example of the received order list page. As shown in FIG. 8A, the received order list page displays, for example, order dates and times, order numbers, payment methods, payment statuses, amounts billed to purchasers, shipping statuses, and shipping dates, for the individual received orders. A confirmation status icon 211 is displayed in the row including information about the order for a designated medicine. The confirmation status icon is an image indicating the confirmation status. The appearance of the confirmation status icon changes depending on the confirmation status. For example, the confirmation status icon may be changed in color, shape, design, or size. FIG. 8B is a diagram showing an example of the appearance of different confirmation status icons corresponding to different confirmation statuses. In the example of FIG. 8B, the color of the confirmation status icon changes depending on the confirmation status. The confirmation status icon 211 shown in FIG. 8A indicates that the confirmation status is “unsent from store”. Displaying the confirmation status icon 211 enables the store to determine whether the item ordered is a designated medicine that requires the provision of consideration information, and to easily recognize the current confirmation status. The confirmation status icon is an example of images that are changed in appearance depending on a confirmation state. Such images are not limited to icons. For example, images indicating graphics or symbols may be used.

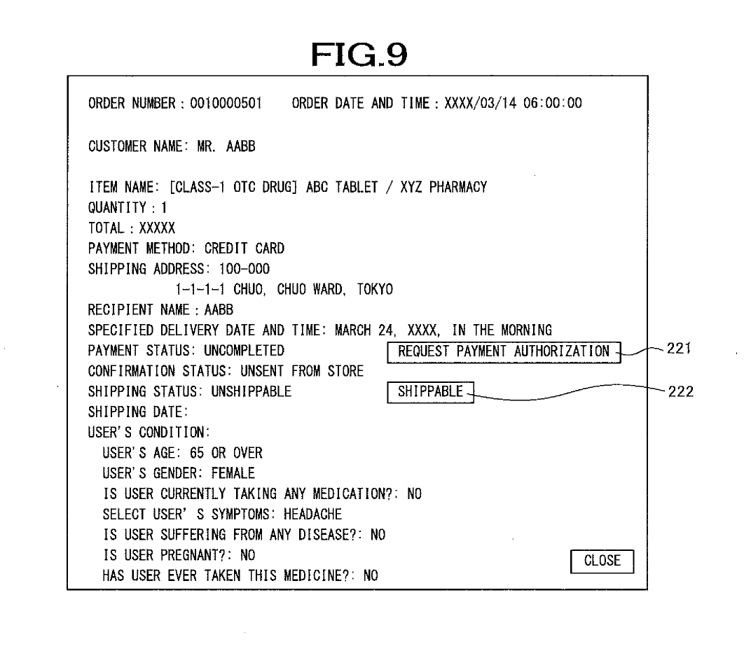

When the employee selects any of the order numbers, the received order information provider 145 sends a received order management page to the store terminal 2 in response to a request from the store terminal 2 (Step S24). The received order management page is a web page for managing the order identified by the selected order number. FIG. 9 is a diagram showing a display example of the received order management page. As shown in FIG. 9, the received order management page displays, for example, the content of the order information stored in the order DB 12e. The received order management page displays, for example, the order number, the received date and time, the purchaser's name, the item ID, the item name, the item quantity, the amount billed, the shipping address information, the payment method, the specified delivery date and time, the payment status, the shipping status. The received order management page further displays, for example, a payment authorization request button 221 and a shipping status update request button 222. The payment authorization request button 221 is a button for requesting the online shopping mall server 1 to authorize the payment of the amount billed when the payment method is a credit card payment. When the payment method is not a credit card payment, a payment status update request button is displayed instead of the payment authorization request button 221. The payment status update request button is a button for updating the payment status to “completed”. The shipping status update request button 222 is a button for updating the shipping status from “unshippable” to “waiting to be shipped”. When the item ordered is a designated medicine, the received order management page further displays the confirmation status and the user's condition.

For example, when the employee selects the payment authorization request button 221, the store terminal 2 sends a payment authorization request to the online shopping mall server 1 (Step S25). In response to this, the status controller 144 performs an authorization process for payment with the credit card based of the purchaser's credit card information, for example, in cooperation with a server device of a credit sales company. Then, only when the result indicating that the payment is authorized is obtained, the status controller 144 updates the payment status to “completed” (Step S26). When the payment method is not a credit card payment, the employee selects the payment status update request button after confirming a process for payment of the purchase price by the purchaser. Then the status controller 144 updates the payment status to “completed”.

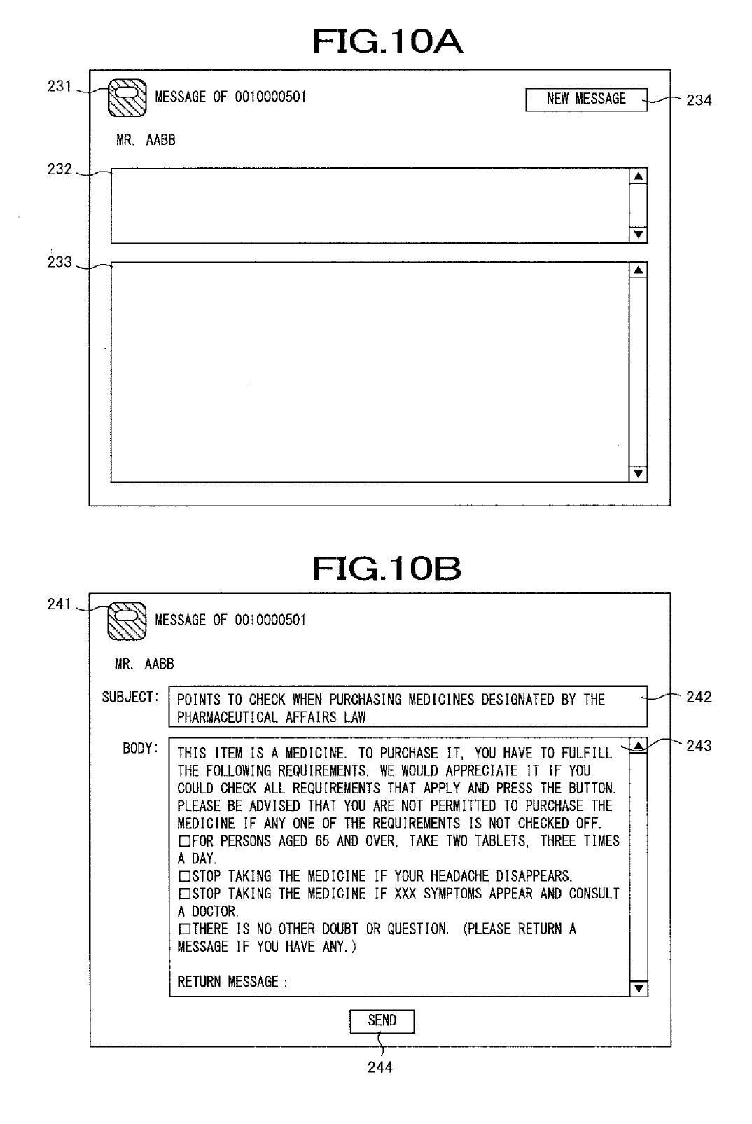

After that, for example, the received order information provider 145 sends a received order list page to the store terminal 2 in response to an operation by the employee as shown in FIG. 6 (Step S31). When the employee selects, for example, the confirmation status icon 211 on the received order list page (Step S32), the message processor 143 sends a message management page to the store terminal 2 in response to a request from the store terminal 2 (Step S33). The message management page is a web page for displaying purchaser messages regarding the order corresponding to the selected confirmation status icon 211. FIG. 10A is a diagram showing a display example of the message management page. As shown in FIG. 10A, the message management page displays a confirmation status icon 231, a message list display area 232, a message display area 233, and a new message button 234. The message list display area 232 displays a list of purchaser messages. Each purchaser message is sent as an answer to the corresponding store message. Thus, when no store message regarding an order was sent, that is, when no consideration information was generated, no purchaser message is usually stored. The message display area 233 displays the purchaser message selected from the message list display area 232. The new message button 234 is a button for entering a store message.

When the employee selects the new message button 234, the message processor 143 sends a message entry page to the store terminal 2 in response to a request from the store terminal 2 (Step S34). FIG. 10B is a diagram showing a display example of the message entry page. As shown in FIG. 10B, the message entry page displays a confirmation status icon 241, a subject entry field 242, a message entry field 243, and a submit button 244. The subject entry field 242 is an entry field for entering the subject of the store message. The message entry field 243 is an entry field for entering the store message. The submit button 244 is a button for sending the entered subject and store message.

The employee enters a subject and a store message on the message entry page. When entering the first store message regarding an item, the employee enters consideration information based on user condition information displayed in the received order management page (Step S35). The message management page or the message entry page may display the user condition information. When entering the consideration information, the employee enters, for each consideration, a character representing a check box before the content of the consideration, for example. This character is referred to as a check-box-representing character. The check-box-representing character may be, for example, a character representing a quadrangle. The check-box-representing character is data for actually displaying a check box for the purchaser to operate to confirm that he/she has understood the consideration information presented to him/her. When taking a question or the like from the purchaser, the employee enters, for example, “:”. After entering the consideration information, the employee selects the submit button 244. Then, the store terminal 2 sends the subject and the consideration information as the store message to the online shopping mall server 1 (Step S36). When the consideration information is received, the message processor 143 stores the consideration information in the message DB 12f and sends a store message registration notification e-mail to the purchaser (Step S37). The store message registration notification e-mail is an e-mail notifying the purchaser that the store message has been stored and that the consideration information requires confirming. The store message registration notification e-mail is an example of notification information.

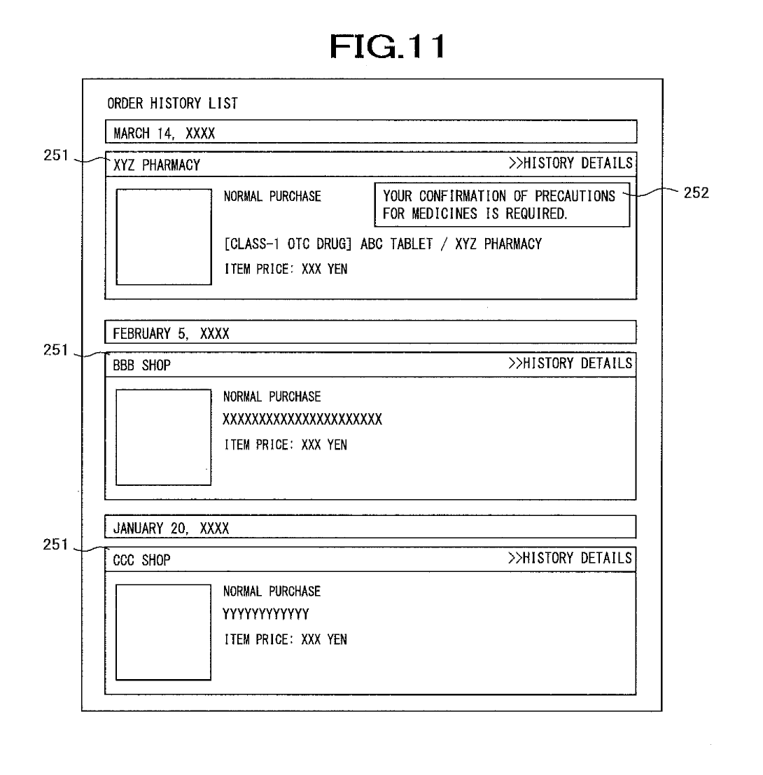

The purchaser who has read the store message registration notification e-mail operates the purchaser terminal 3 to request his/her order history. Then, the order history provider 146 sends an order history page to the purchaser terminal 3 (Step S38). Thus, the order history provider 146 causes the purchaser terminal 3 to present a link to the consideration information. FIG. 11 is a diagram showing a display example of the order history page. As shown in FIG. 11, the order history page displays an order detail display area 251 for each of the orders placed by the purchaser. The order detail display area 251 displays at least a portion of the order details. For example, the order detail display area 251 displays the name of the item, the name of the store from which the item was purchased, the price, and an image of the item. When the item ordered is a designated medicine, the order detail display area 251 further displays a store message confirmation link 252. The store message confirmation link 252 is an example of link information. The store message confirmation link 252 is a hyperlink to a message confirmation page regarding the corresponding order. The message confirmation page is a web page for displaying a store message and for entering an answer to the store message as a purchaser message. For example, the message processor 143 may put the URL of the message confirmation page in the store message registration notification e-mail.

When the purchaser selects the store message confirmation link 252 (Step S39), the purchaser terminal 3 sends the URL of the message confirmation page to the online shopping mall server 1 (Step S40). The message processor 143 identifies the order number by referring to the received URL, and retrieves the subject, the store message, and the store sent date and time corresponding to the order number, from the message DB 12f. Subsequently, the message processor 143 generates the message confirmation page based on the retrieved information and sends the page to the purchaser terminal 3 (Step S41). When a plurality of store messages are stored, the message processor 143 may generate the message confirmation page so that, for example, the latest store message is displayed.

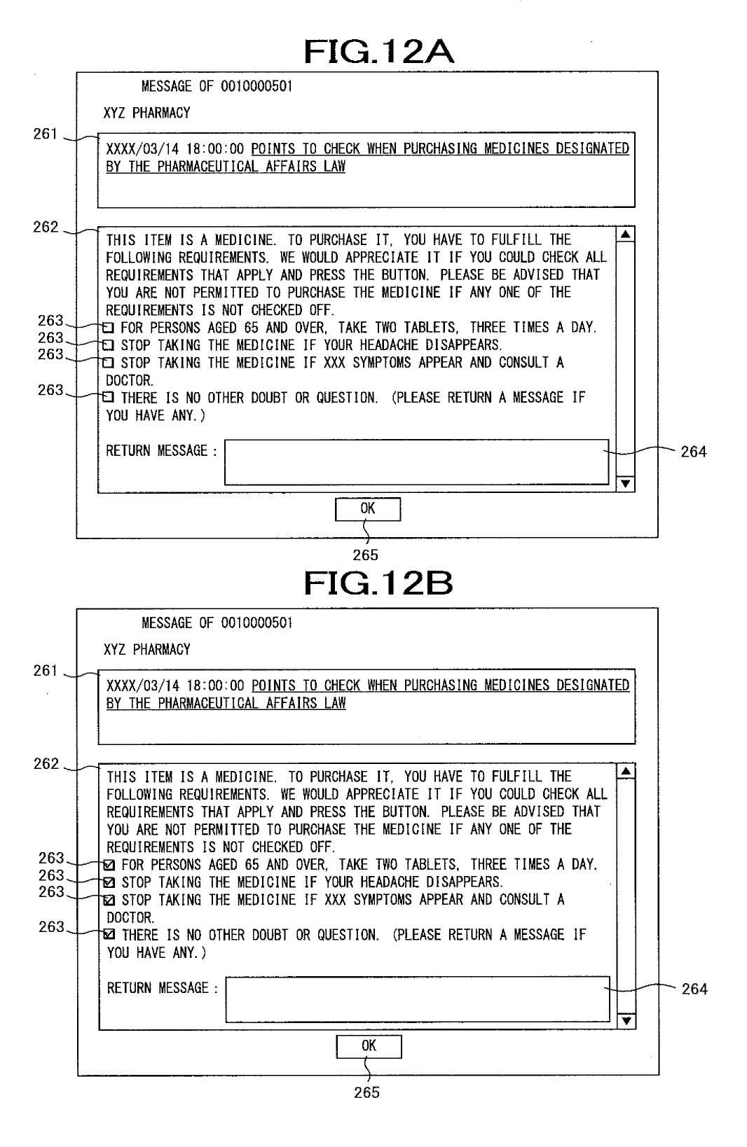

FIG. 12A is a diagram showing a display example of the message confirmation page. As shown in FIG. 12A, the message confirmation page displays a message list display area 261, a message display area 262, and an OK button 265. The message list display area 261 displays a list of store messages. The message display area 262 displays the store message selected from the message list display area 261. Here, the check-box-representing characters entered by the store employee are converted into check boxes 263. An entry field 264 is also displayed after “:”. The purchaser enters a question or the like in the entry field 264 as needed. The OK button 265 is a button for sending the purchaser message. The check boxes 263 and the OK button 265 each are an example of a confirmation element. Thus, the message processor 143 causes the check boxes 263 and the OK button 265, which can be operated to indicate that the purchaser has confirmed that he/she has understood the consideration information, to be presented with the consideration information. After understanding each consideration, the purchaser selects the corresponding check box 263 to check it off (Step S42). FIG. 12B shows an example of the message confirmation page in which the check boxes 263 corresponding to all the considerations have been checked off. When the purchaser selects the OK button 265, the purchaser terminal 3 sends the entered purchaser message to the online shopping mall server 1 (Step S43). For example, the purchaser message includes the text of the store message in the message display area 262. Check-box-representing characters are inserted at the positions where the check boxes 263 were displayed in the message display area 262. At this time, the inserted check-box-representing characters are different depending on whether the corresponding check boxes 263 are checked off or unchecked. When a question or the like is entered in the entry field 264, the purchaser message further includes the question or the like.

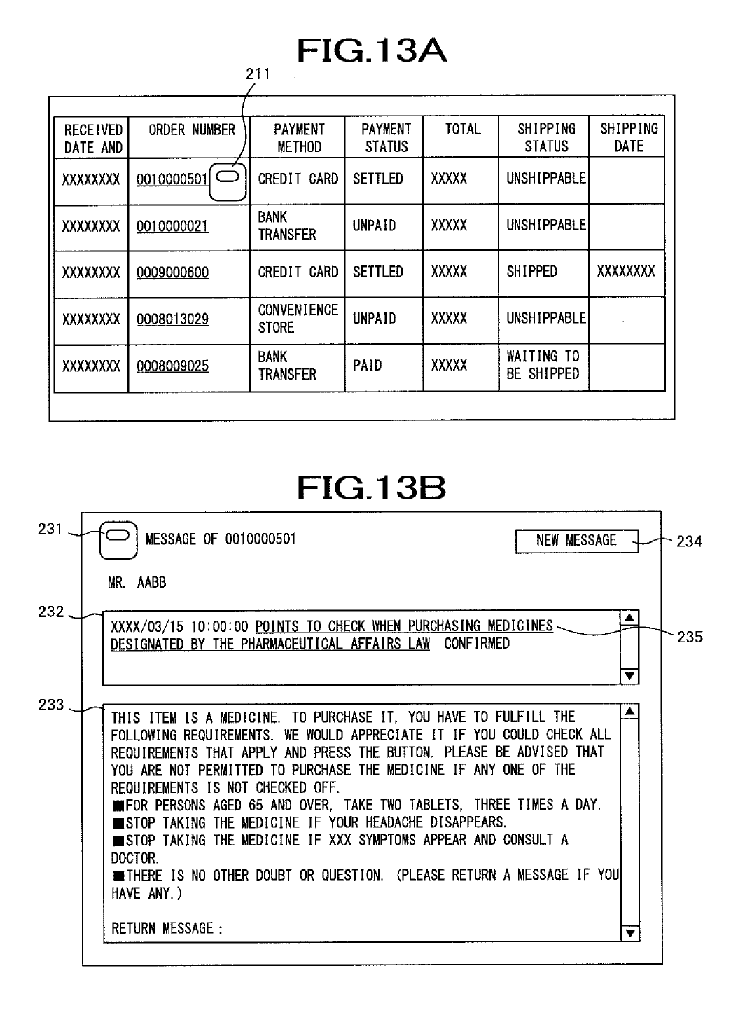

The status controller 144 that has received the purchaser message updates the confirmation status to “confirmed” when all of the check-box-representing characters included in the purchaser message indicate “checked off” (Step S44). The purchaser message in which all the check-box-representing characters indicate “checked off” is an example of a confirmation notification. Subsequently, the message processor 143 sends a purchaser message registration notification e-mail to the store (Step S45). The purchaser message registration notification e-mail is an e-mail notifying the store that the purchaser message has been stored. After the employee who has read the purchaser message performs an operation for displaying the received order information, the received order information provider 145 sends the received order list page to the store terminal 2 (Step S46). FIG. 13A shows a display example of the received order list page after the confirmation status is updated to “confirmed”. As shown in FIG. 13A, the confirmation status icon 211 indicates “confirmed”. The payment status is “completed”. When the employee selects the confirmation status icon 211 here, the message processor 143 sends the message management page to the store terminal 2. FIG. 13B shows a display example of the message management page after the confirmation status is updated to “confirmed”. As shown in FIG. 13B, the confirmation status icon 231 indicates “confirmed”. A message 235 indicating “confirmed” is displayed beside the subject in the message list display area 232. In the purchaser message in the message display area 233, all the check-box-representing characters indicate “checked off”.

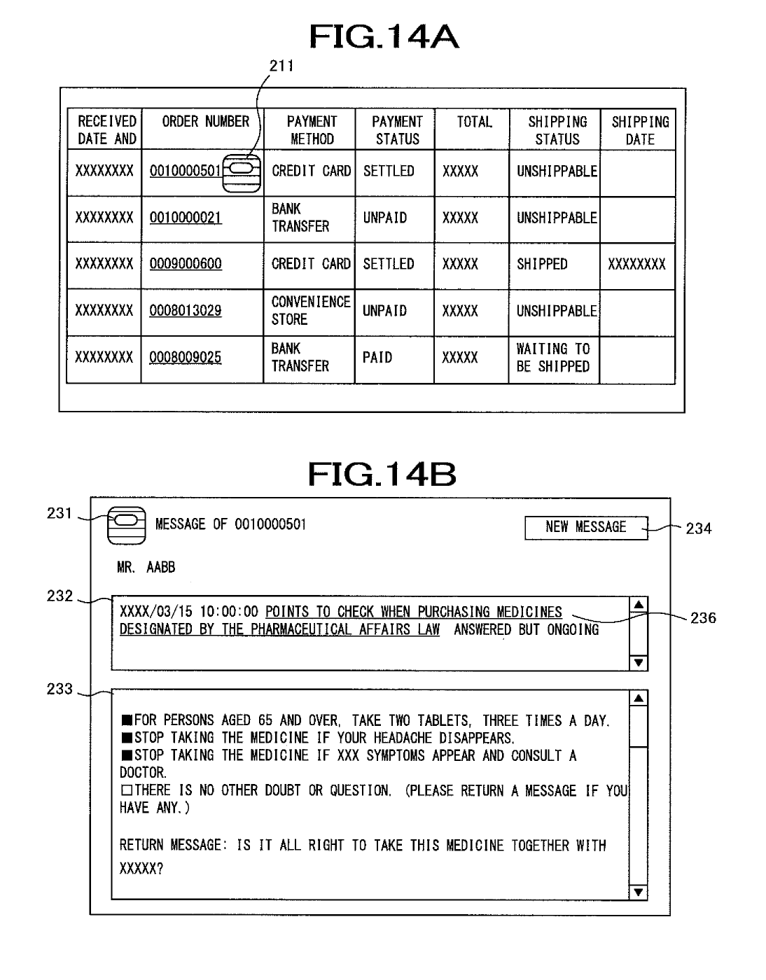

When the purchaser did not check off at least one of the check boxes on the message confirmation page, the status controller 144 does not update the confirmation status to “confirmed”. Also in this case, the message processor 143 sends the purchaser message registration notification e-mail. FIG. 14A shows a display example of the received order list page when the confirmation status is not updated to “confirmed”. As shown in FIG. 14A, the confirmation status icon 211 indicates “answered but ongoing”. FIG. 14B shows a display example of the message management page when the confirmation status is not updated to “confirmed”. As shown in FIG. 14B, the confirmation status icon 231 indicates “answered but ongoing”. A message 236 indicating “answered but ongoing” is displayed beside the subject in the message list display area 232. In the purchaser message in the message display area 233, at least one of the check-box-representing characters indicates “unchecked”. In such a case, the employee causes the store terminal 2 to display the message entry page and enters another store message to the purchaser message. At this time, the employee enters one or more check-box-representing characters. For example, when a question has been entered by the purchaser, the employee may enter an answer to the question. The employee then enters a check-box-representing character for confirming that there is no other question or the like. The subsequent steps for exchanging messages between the store and the purchaser are basically the same as Steps S31 to S43. Until all the check boxes are checked off by the purchaser, such messages are repeatedly exchanged.

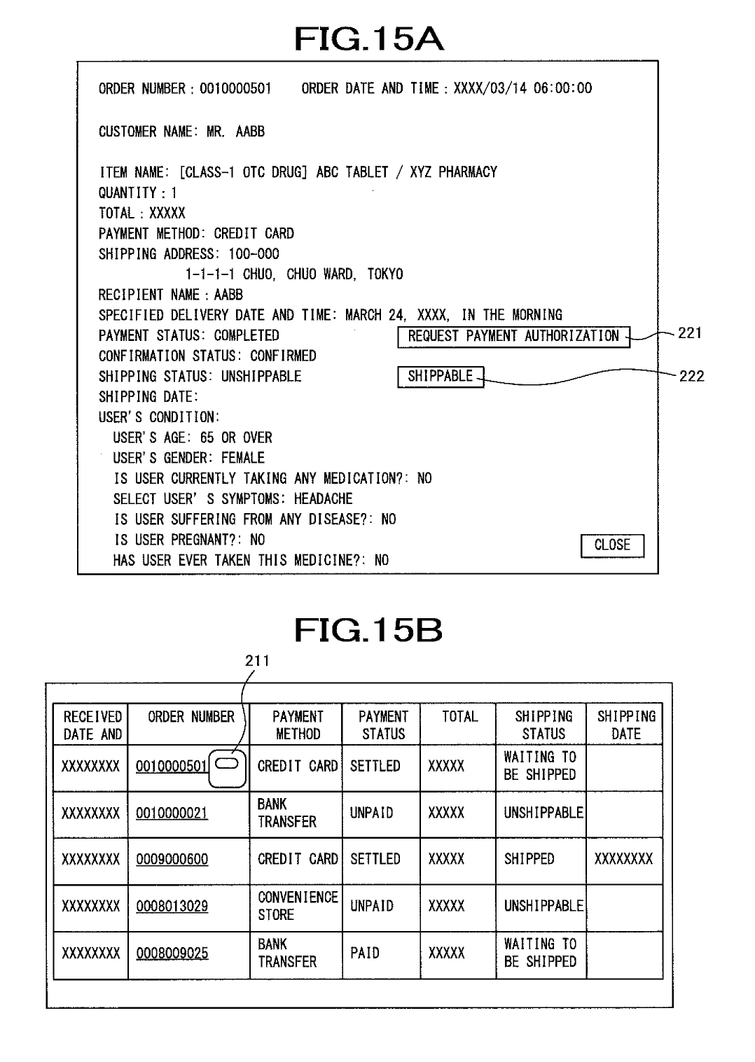

When the employee selects the order number corresponding to the confirmation status icon 211 on the received order list page after the confirmation status is updated to “confirmed” (FIG. 13A), the received order information provider 145 sends the received order management page to the store terminal 2 (Step S47). FIG. 15A shows a display example of the received order management page after the payment status is updated to “completed” and the confirmation status is updated to “confirmed”. For example, after recognizing that the payment status is “completed” ant the confirmation status is “confirmed” on the received order management page (FIG. 15A) or on the received order list page, the employee selects the shipping status update request button 222. Then, the store terminal 2 sends a shipping status update request to the online shopping mall server (Step S48). The status controller 144 that has received the shipping status update request changes the shipping status to “waiting to be shipped” (Step S49), and sends a completion response to the store terminal 2. Then, the store terminal 2 changes the shipping status on the received order management page to “waiting to be shipped”. FIG. 15B shows a display example of the received order list page after the shipping status is updated to “waiting to be shipped”. The employee that has recognized that the shipping status is “waiting to be shipped” on the received order management page or on the received order list page (FIG. 15B) ships the designated medicine, which is the item ordered.

In the example of the FIGS. 5 and 6, the payment of the purchase price is processed first, and then the consideration information is provided and confirmed. Alternatively, the consideration information may be provided and confirmed first, and then the payment of the purchase price may be processed. Alternatively, these processes may be performed in parallel.

### 1-4-2. Operation of System Controller

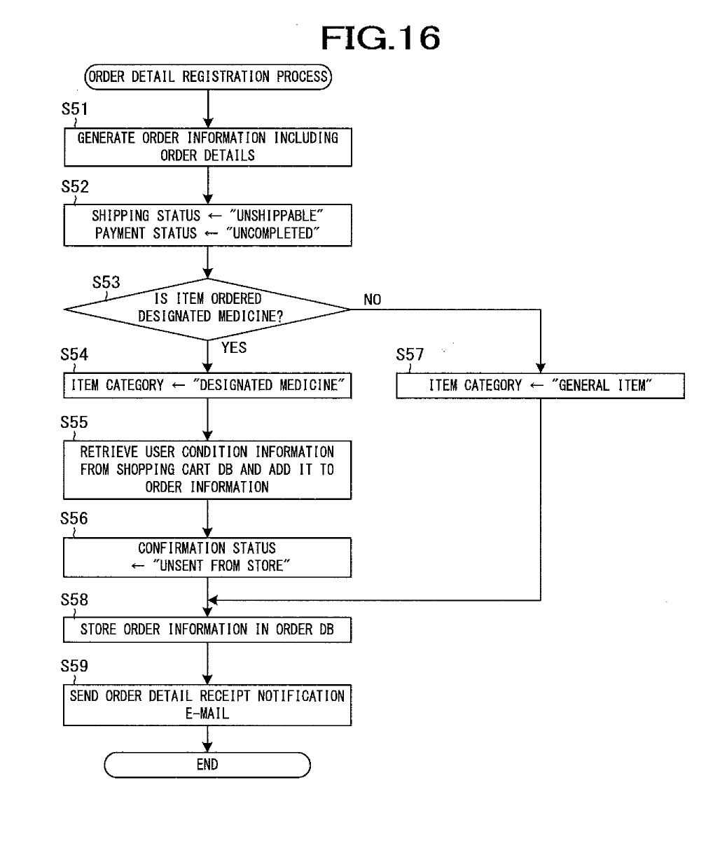

The following describes a specific operation of the system controller 14 of the online shopping mall server 1 with reference to FIGS. 16 to 20. FIG. 16 is a flowchart showing an example of an order detail registration process in the system controller 14 of the online shopping mall server 1 according to this embodiment. When the order details and the like entered on the order detail entry page are received, the system controller 14 performs the order detail registration process (e.g., Steps S20 and S21 of FIG. 5). As shown in FIG. 16, the order detail receiver 142 generates order information including the received order details and the like (Step S51). At this time, the order detail receiver 142 generates a new order number and obtains the current date and time as the received date and time. Then, the order detail receiver 142 sets the shipping status of the generated order information to “unshippable” and sets the payment status to “uncompleted” in the generated order information (Step S52). Subsequently, the order detail receiver 142 determines whether the item ordered is a designated medicine (Step S53). Specifically, the order detail receiver 142 retrieves the genre ID corresponding to the store ID and item ID included in the order information from the item DB 12c. If the genre ID indicates any of “class-1 OTC drug” and “class-2 OTC drug”, the order detail receiver 142 determines that the item ordered is a designated medicine (YES in Step S53). In this case, the process proceeds to Step S54.

In Step S54, the order detail receiver 142 sets the item category of the order information to “designated medicine”. Subsequently, the order detail receiver 142 retrieves the user condition information corresponding to the user ID, store ID, and item ID included in the order information, from the shopping cart DB 12d. The order detail receiver 142 then adds the user condition information to the order information (Step S55). Next, the order detail receiver 142 adds the confirmation status to the order information and sets the confirmation status to “unsent from store” (Step S56). After that, the process proceeds to Step S58.

If the order detail receiver 142 determines that the item ordered is not a designated medicine in Step S53 (NO in Step S53), the process proceeds to Step S57. In Step S57, the order detail receiver 142 sets the item category to “general item”. Then, the process proceeds to Step S58.

In Step S58, the order detail receiver 142 stores the generated order information in the order DB 12e. Subsequently, the order detail receiver 142 sends an order detail receipt notification e-mail to the purchaser who sent the order details (Step S59). After Step S59, the order detail receiver 142 terminates the order detail registration process.

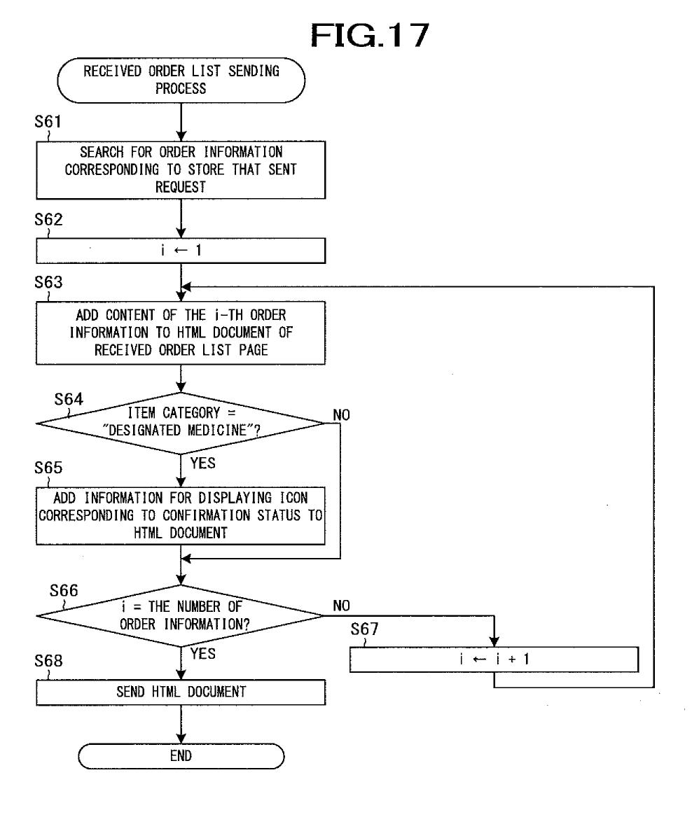

FIG. 17 is a flowchart showing an example of a received order list sending process in the system controller 14 of the online shopping mall server 1 according to this embodiment. When a request for the received order list page is received from the store terminal 2, the system controller 14 performs the received order list sending process (e.g., Step S23 of FIG. 5 and Steps S31 and S46 of FIG. 6). The request for the received order list page includes, for example, the store ID of the store that requested the received order list page and search criteria to search for order information. As shown in FIG. 17, the received order information provider 145 searches the order DB 12e for order information that corresponds to the store ID included in the received request (Step S61). At this time, the received order information provider 145 searches for order information that meets the search criteria. Subsequently, the received order information provider 145 sets a variable i to 1 (Step S62). The received order information provider 145 also retrieves an HTML document, a template, of the received order list page from the storage unit 12. Then, the received order information provider 145 adds the content of part of the i-th order information among the retrieved order information, such as the received date and time, the order number, the payment method, the payment status, and the shipping status, to the HTML document (Step S63).

Next, the received order information provider 145 determines whether the item category included in the i-th order information is “designated medicine” (Step S64). If the received order information provider 145 determines that the item category is “designated medicine” here (YES in Step S64), the process proceeds to Step S65. In Step S65, the received order information provider 145 obtains the URL of the image data of the confirmation status icon corresponding to the confirmation status included in the i-th order information. The received order information provider 145 also generates the URL of the message management page, for example, based on the order number included in the i-th order information. Subsequently, the received order information provider 145 adds, for example, the URL of the image data, and tag data or a script including the URL of the message management page, as information for displaying the confirmation status icon, to the HTML document. Then, the process proceeds to Step S66. On the other hand, if the received order information provider 145 determines that the item category is not “designated medicine” (NO in Step S64), the process proceeds to Step S66.

In Step S66, the received order information provider 145 determines whether the variable i is equal to the number of the retrieved order information. If the received order information provider 145 determines that the variable i is not equal to the number of the order information here (NO in Step S66), the process proceeds to Step S67. In Step S67, the received order information provider 145 adds 1 to the variable i, and the process proceeds to Step S63. On the other hand, if the received order information provider 145 determines that the variable i is equal to the number of the order information (YES in Step S66), the process proceeds to Step S68. In Step S68, the received order information provider 145 sends the completed HTML document of the received order list page to the store terminal 2. After Step S68, the received order information provider 145 terminates the received order list sending process. The store terminal 2 that has received the HTML document displays the received order list page. When the HTML document includes the information for displaying the confirmation status icon, the store terminal 2 obtains, in accordance with this information, the image data of the confirmation status icon from the online shopping mall server 1 to display the icon. The received order list page is thus displayed, for example, as shown in FIG. 8A, 13A, 14A, or 15B.

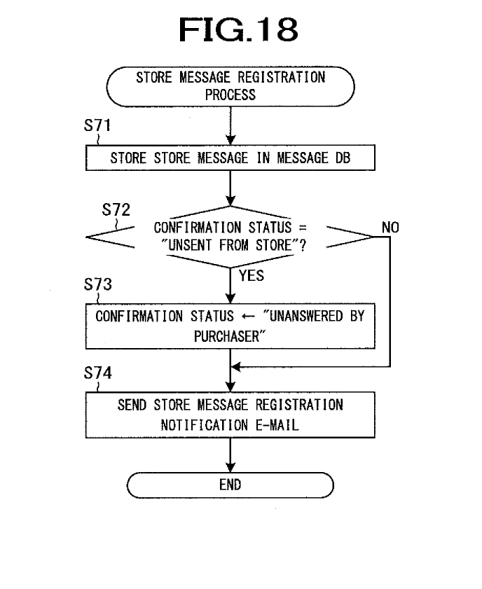

FIG. 18 is a flowchart showing an example of a store message registration process in the system controller 14 of the online shopping mall server 1 according to this embodiment. When a store message is received from the store terminal 2, the system controller 14 performs the store message registration process (e.g., Step S37 of FIG. 6). The store terminal 2 sends, for example, the subject and the order number with the store message to the online shopping mall server 1. As shown in FIG. 18, the message processor 143 searches the message DB 12f for store messages that correspond to the received order number. Here, if no corresponding store messages are stored, the message processor 143 sets a new message number to 1. If the corresponding store messages are stored, the message processor 143 adds the message number with the latest store sent date and time to 1 to set it as the new message number. The message processor 143 also obtains the current date and time as the store sent date and time. Subsequently, the message processor 143 stores the message number, the store sent date and time, the store message, the subject, and the order number in association with each other, in the message DB 12f (Step S71).

Then, the status controller 144 identifies the order information corresponding to the order number from the order DB 12e, and determines whether the confirmation status included in the order information is “unsent from store” (Step S72). If the status controller 144 determines that the confirmation status is “unsent from store” (YES in Step S72), the process proceeds to Step S73. In Step S73, the status controller 144 sets the confirmation status to “unanswered by purchaser”, and the process proceeds to Step S74. On the other hand, if the status controller 144 determines that the confirmation status is not “unsent from store” (NO in Step S72), the process proceeds to Step S74.

In Step S74, the message processor 143 sends the store message registration notification e-mail. Specifically, the message processor 143 retrieves the e-mail address corresponding to the user ID included in the identified order information from the member DB 12a. The message processor 143 then generates and sends the store message registration notification e-mail storing the retrieved e-mail address in its destination address. After Step S74, the message processor 143 terminates the store message registration process.

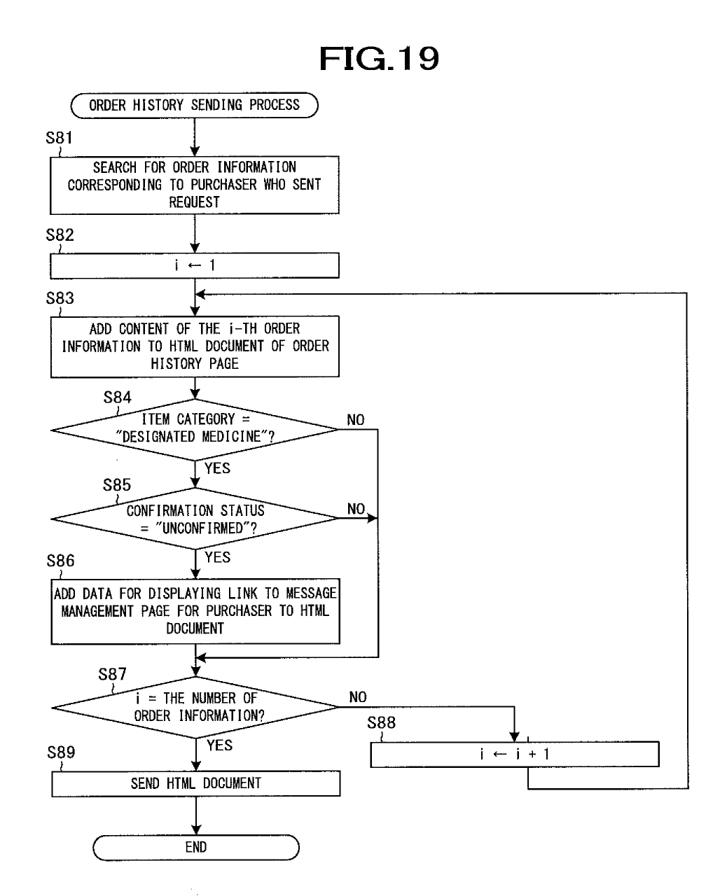

FIG. 19 is a flowchart showing an example of an order history sending process in the system controller 14 of the online shopping mall server 1 according to this embodiment. When a request for the order history page is received from the purchaser terminal 3, the system controller 14 performs the order history sending process (e.g., Step S38 of FIG. 6). The request for the order history page includes, for example, the user ID of the purchaser who requested the order history page and search criteria to search for order information. As shown in FIG. 19, the order history provider 146 searches the order DB 12e for order information that corresponds to the user ID included in the received request (Step S81). At this time, the order history provider 146 searches for order information that meets the search criteria. Subsequently, the order history provider 146 sets a variable i to 1 (Step S82). The order history provider 146 also retrieves an HTML document, a template, of the order history page from the storage unit 12. Then, the order history provider 146 adds the content of part of the i-th order information among the retrieved order information, such as the received date, the store name, the item name, and the price, to the HTML document (Step S83).

Next, the order history provider 146 determines whether the item category included in the i-th order information is “designated medicine” (Step S84). If the order history provider 146 determines that the item category is “designated medicine” here (YES in Step S84), the process proceeds to Step S85. In Step S85, the order history provider 146 determines whether the confirmation status included in the i-th order information is “unconfirmed”. If the order history provider 146 determines that the confirmation status is “unconfirmed” here (YES in Step S85), the process proceeds to Step S86. In Step S86, the order history provider 146 generates the URL of the message confirmation page, for example, based on the order number included in the i-th order information. Subsequently, the order history provider 146 adds, for example, tag data including the URL of the message confirmation page, as information for displaying the store message confirmation link 252, to the HTML document. Then, the process proceeds to Step S87. On the other hand, if the order history provider 146 determines that the item category is not “designated medicine” (NO in Step S84) or that the confirmation status is not “unconfirmed” (NO in Step S85), the process proceeds to Step S87.

In Step S87, the order history provider 146 determines whether the variable i is equal to the number of the retrieved order information. If the order history provider 146 determines that the variable i is not equal to the number of the order information here (NO in Step S87), the process proceeds to Step S88. In Step S88, the order history provider 146 adds 1 to the variable i, and the process proceeds to Step S83. On the other hand, if the order history provider 146 determines that the variable i is equal to the number of the order information (YES in Step S87), the process proceeds to Step S89. In Step S89, the order history provider 146 sends the completed HTML document of the order history page to the purchaser terminal 3. After Step S89, the order history provider 146 terminates the order history sending process. The purchaser terminal 3 that has received the HTML document displays the order history page. When the HTML document includes the tag data including the URL of the message confirmation page, the purchaser terminal 3 displays the store message confirmation link 252 based on the data. The order history page is thus displayed, for example, as shown in FIG. 11.

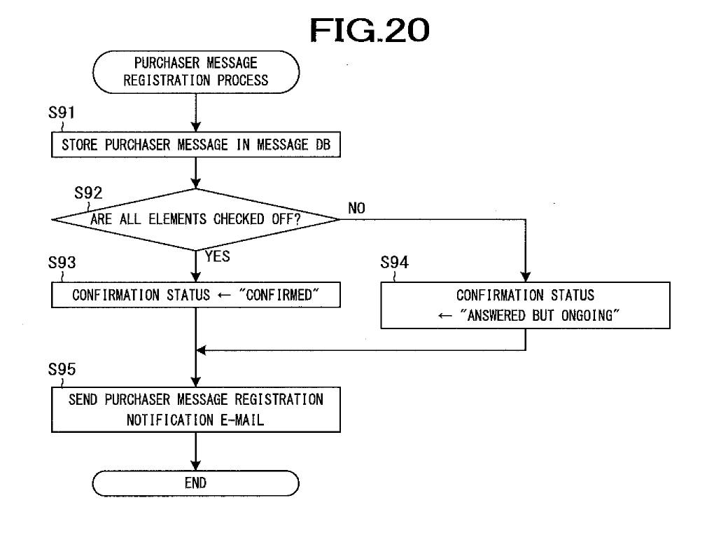

FIG. 20 is a flowchart showing an example of a purchaser message registration process in the system controller 14 of the online shopping mall server 1 according to this embodiment. When a purchaser message is received from the purchaser terminal 3, the system controller 14 performs the purchaser message registration process (e.g., Steps S44 and S45 of FIG. 6). The purchaser terminal 3 sends, for example, the order number with the purchaser message to the online shopping mall server 1. As shown in FIG. 20, the message processor 143 obtains the current date and time as the purchaser sent date and time. The message processor 143 also searches the message DB 12f for message numbers that correspond to the received order number. The message processor 143 then stores the purchaser message and the purchaser sent date and time in association with the latest message number of the retrieved message numbers, in the message DB 12f (Step S91).

Subsequently, the status controller 144 searches the received purchaser message for check-box-representing characters. The status controller 144 then determines whether all of the retrieved check-box-representing characters indicate “checked off” (Step S92). If the message processor 143 determines that all the check-box-representing characters indicate “checked off” here (YES in Step S92), the process proceeds to Step S93. In Step S93, the message processor 143 identifies the order information corresponding to the received order number from the order DB 12e, and sets the confirmation status included in the order information to “confirmed”. Then, the process proceeds to Step S95. On the other hand, if the message processor 143 does not determine that all the check-box-representing characters indicate “checked off” (NO in Step S92), the process proceeds to Step S94. In Step S94, the message processor 143 sets the confirmation status to “answered but ongoing”. Then, the process proceeds to Step S95.

In Step S95, the message processor 143 sends the purchaser message registration notification e-mail. Specifically, the message processor 143 retrieves the e-mail address corresponding to the store ID included in the identified order information from the store DB 12b. The message processor 143 then generates and sends the purchaser message registration notification e-mail storing the retrieved e-mail address as its destination address. After Step S95, the message processor 143 terminates the purchaser message registration process.

As described above, according to this embodiment, when an item ordered by a purchaser is a designated medicine, the system controller 14 receives user condition information of a user of the item from the purchaser. When order details of the item are received from the purchaser, the system controller 14 stores the order details in the storage unit 12. When the item ordered is a designated medicine, the system controller 14 stores the confirmation status set to “unconfirmed” in association with the order details stored in the storage unit 12, in the storage unit 12. The system controller 14 outputs consideration information generated based on the designated medicine indicated in the order details and the received user condition information so that the purchaser can confirm the consideration information. The system controller 14 receives a purchaser message indicating that the purchaser has confirmed that he/she has understood the consideration information. When receiving the purchaser message, the system controller 14 updates the confirmation status stored in the storage unit 12 to “confirmed”. The system controller 14 also outputs the confirmation status stored in the storage unit 12 so that whether the process for finalizing the sale of the designated medicine that is indicated in the order details is ready can be determined. Thus, this embodiment allows for a purchase procedure as easy-to-follow as that for a general item even when order details of a designated medicine is sent, and the provision of individualized information before shipment of the medicine.

When the item ordered is a designated medicine, the system controller 14 also causes the purchaser terminal 3 to present the store message confirmation link 252. When the store message confirmation link 252 is selected, the system controller 14 causes the purchaser terminal 3 to present the message confirmation page. The system controller 14 obtains the purchaser message based on operation of the OK button 265 on the message confirmation page. Thus, the purchaser can easily confirm the consideration information.

The system controller 14 also causes the store terminal 2 to present the received order list page regarding the order details stored in the storage unit 12. Here, when the item ordered is a designated medicine, the system controller 14 causes the store terminal 2 to present the confirmation status icon 211 on the received order list page. Thus, the confirmation status icon 211 enables the store to easily determine whether the purchaser has confirmed the consideration information.

### 1-5. Modification

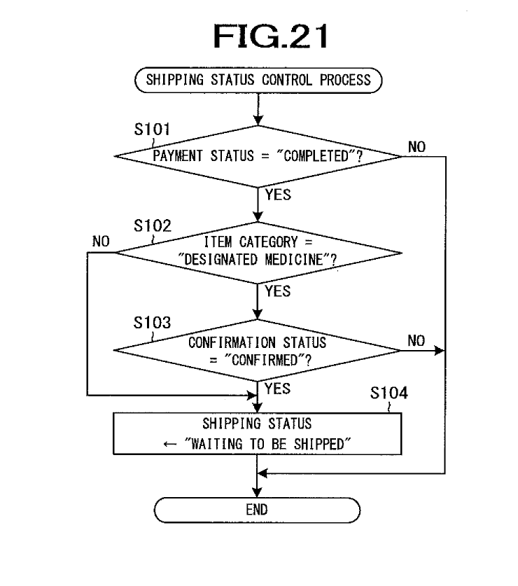

The following describes a modification of this embodiment with reference to FIG. 21. The online shopping mall server 1 may automatically update the shipping status, instead of updating the shipping status to “waiting to be shipped” in response to an operation by the store. For example, the status controller 144 may determine whether to update the shipping status at the time when the confirmation status or the payment status has been changed. In this modification, the status controller 144 is an example of first shipping state updating means and second shipping state updating means.

FIG. 21 is a flowchart showing an example of a shipping status control process in the system controller 14 of the online shopping mall server 1 according to this modification. For example, when the payment status is updated by the process for authorizing the payment with a credit card (Step S26 of FIG. 5), when the payment status is updated in response to a payment status update request, and when the confirmation status is updated to “confirmed” (Step S44 of FIG. 6), the system controller 14 may performs the shipping status control process.

As shown in FIG. 21, the status controller 144 identifies, from the order DB 12e, the order information with the confirmation status or the payment status that has been updated. The status controller 144 then determines whether the payment status included in the identified order information is “completed” (Step S101). If the status controller 144 determines that the payment status is not “completed” here (NO in Step S101), the status controller 144 terminates the shipping status control process. On the other hand, if the status controller 144 determines that the payment status is “completed” (YES in Step S101), the process proceeds to Step S102. In Step S102, the status controller 144 determines whether the item category included in the identified order information is “designated medicine”. If the status controller 144 determines that the item category is not “designated medicine” here (NO in Step S102), the process proceeds to Step S104. On the other hand, if the status controller 144 determines that the item category is “designated medicine” (YES in Step S102), the process proceeds to Step S103. In Step S103, the status controller 144 determines whether the confirmation status included in the identified order information is “confirmed”. If the status controller 144 determines that the confirmation status is not “confirmed” here (NO in Step S103), the status controller 144 terminates the shipping status control process. On the other hand, if the status controller 144 determines that the confirmation status is “confirmed” (YES in Step S103), the process proceeds to Step S104. In Step S104, the status controller 144 sets the shipping status included in the identified order information to “waiting to be shipped” and terminates the shipping status control process.

As described above, according to this modification, when the item ordered is not a designated medicine, the system controller 14 updates the shipping status to “waiting to be shipped” on the condition that the payment status has been updated to “completed”. When the item ordered is a designated medicine, the system controller 14 updates the shipping status to “waiting to be shipped” on the condition that the payment status has been updated to “completed” and the confirmation status has been updated to “confirmed”. Thus, this modification can prevent the store from shipping the item by mistake.

### 2. Second Embodiment

The following describes a second embodiment. In the first embodiment, the online shopping mall server 1 provides the store with user interfaces, for example, for receiving orders, presentation of the conditions of users, entering consideration information, presentation of various statuses (e.g., the received order list page, the received order management page, the message management page, and the message entry page). The second embodiment enables each store to design its own user interface. Thus, the online shopping mall server 1 provides the store with an application programming interface (API). Except for points described below, the second embodiment is basically the same as the first embodiment.

### 2-1. Configuration and Functional Overview of Information Processing System

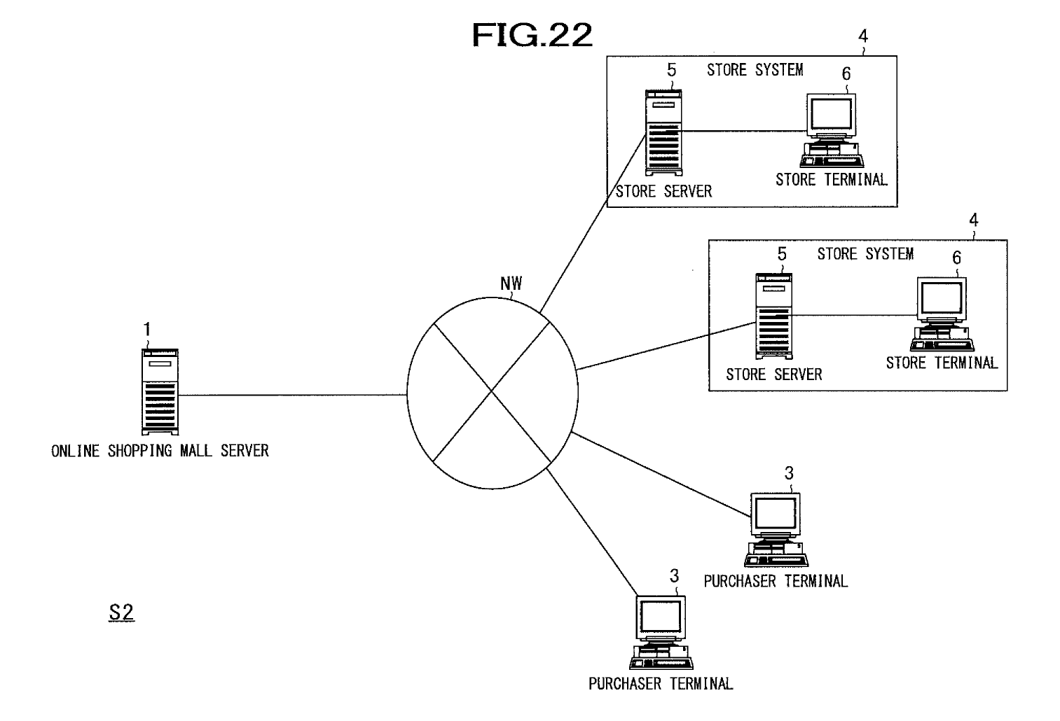

The following describes a configuration and a functional overview of an information processing system S2 according to this embodiment with reference to FIG. 22. FIG. 22 is a diagram showing an example of a schematic configuration of the information processing system S2 according to this embodiment. In FIG. 22, the same components as those shown in FIG. 1 are denoted by the same reference signs.

As shown in FIG. 22, the information processing system S2 includes the online shopping mall server 1, a plurality of store systems 4, and the plurality of purchaser terminals 3. The online shopping mall server 1 can exchange data with each store system 4 and each purchaser terminal 3 via the network NW.

The online shopping mall server 1 in this embodiment outputs a confirmation status to the store system 4 in response to a request from a store through an API so that whether the process for finalizing a sale is ready can be determined.

The store system 4 is a system built by the store. The store system 4 includes, for example, a store server 5 and one or more store terminals 6. The store server 5 and the store terminals 6 can communicate with each other via a network, such as a local area network (LAN). The store server 5 communicates with the online shopping mall server 1, for example, through the API. The store server 5 provides the store terminals 6 with various user interfaces. The provided user interface may be, for example, a web-based user interface or other interfaces. The store server 5 further controls shipping statuses of items ordered. In this embodiment, the combination of the online shopping mall server 1 and the store server 5 is an example of the information system. The store terminal 6 is a terminal device operated by, for example, an employee of the store. The employee, for example, confirms item order details, views user condition information, and enters consideration information through the store terminal 6 that accesses the store server 5.

A process related to communications between the online shopping mall server 1 and the purchaser terminal 3 and an internal process in the online shopping mall server 1 without communicating with the store system 4 are the same as those in the first embodiment. Thus, no further description of these is provided herein.

Each store may be able to choose whether to use its own user interface or use a user interface provided by the online shopping mall server 1. The store server 5 is not necessary for the store that uses the user interface provided by the online shopping mall server 1. In this case, the store terminal 6 may communicate directly with the online shopping mall server 1, so that processes in the online shopping mall server 1 are the same as those in the first embodiment.

### 2-2. Configuration of Store Server

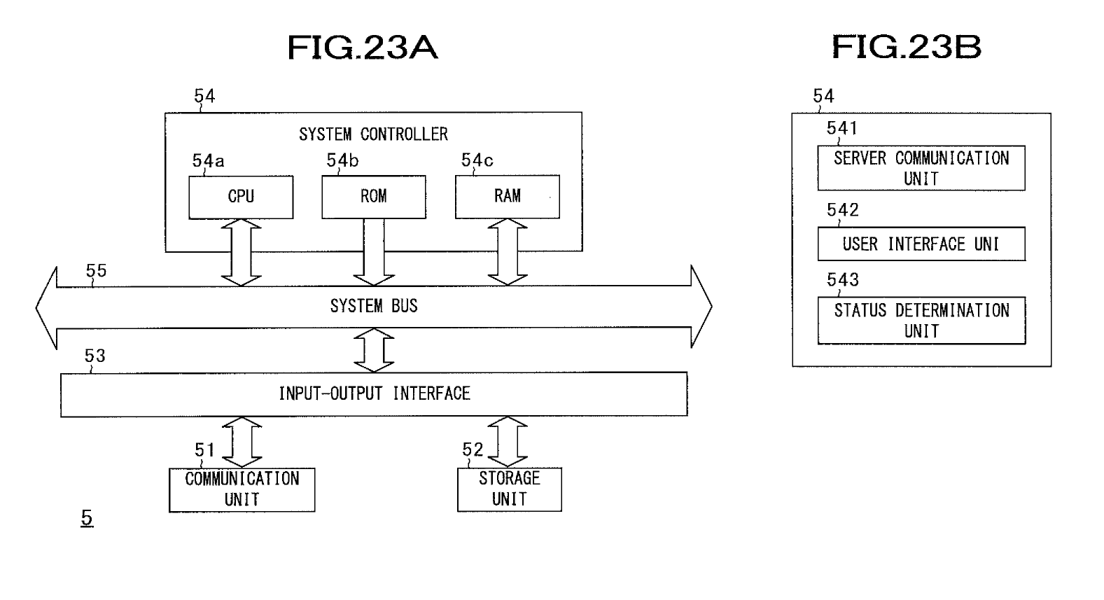

The following describes a configuration of the store server 5 with reference to FIG. 23. FIG. 23A is a block diagram showing an example of a schematic configuration of the store server 5 according to this embodiment. As shown in FIG. 23A, the store server 5 includes a communication unit 51, a storage unit 52, an input-output interface 53, and a system controller 54. The system controller 54 and the input-output interface 53 are connected via a system bus 55.

The communication unit 51 connects to the network NW and controls the state of communications with the online shopping mall server 1, the store terminal 6, and the like. The storage unit 52 includes, for example, a hard disk drive. The storage unit 52 stores information about items sold by the store, information about received orders, and other information. The storage unit 52 also stores various programs, such as an operating system, a WWW server program, a DBMS, and an order management program. The order management program is a program for performing various processes related to managing orders through the online shopping mall. The various programs, for example, may be acquired from another server device or the like via the network NW, or may be recorded in a recording medium, such as an optical disk, and be read via a drive device. The order management program and other programs may be program products. The input-output interface 53 performs interface processing between the communication unit 51 and the storage unit 52, and the system controller 54. The system controller 54 includes, for example, a CPU 54a, a ROM 54b, a RAM 54c.

### 2-3. Functional Overview of System Controller

The following describes a functional overview of the system controller 54 with reference to FIG. 23B. FIG. 23B is a diagram showing an example of functional blocks of the system controller 54 of the online shopping mall server 1 according to this embodiment. As shown in FIG. 23B, programs such as the order management program, read and executed by the CPU 54a, enable the system controller 54 to function as, for example, a server communication unit 541, a user interface unit 542, and a status determination unit 543. The server communication unit 541 sends requests to the online shopping mall server 1 and receives information sent from the online shopping mall server 1 through the API. The user interface unit 542 provides the store terminal 6 with a user interface and controls information exchange between the server communication unit 541 and the store terminal 6. The status determination unit 543 determine whether a shipping status can be updated, based on an item category, a payment status, and a confirmation status.

### 2-4. Operation of Information Processing System

### 2-4-1. Operation of Overall System

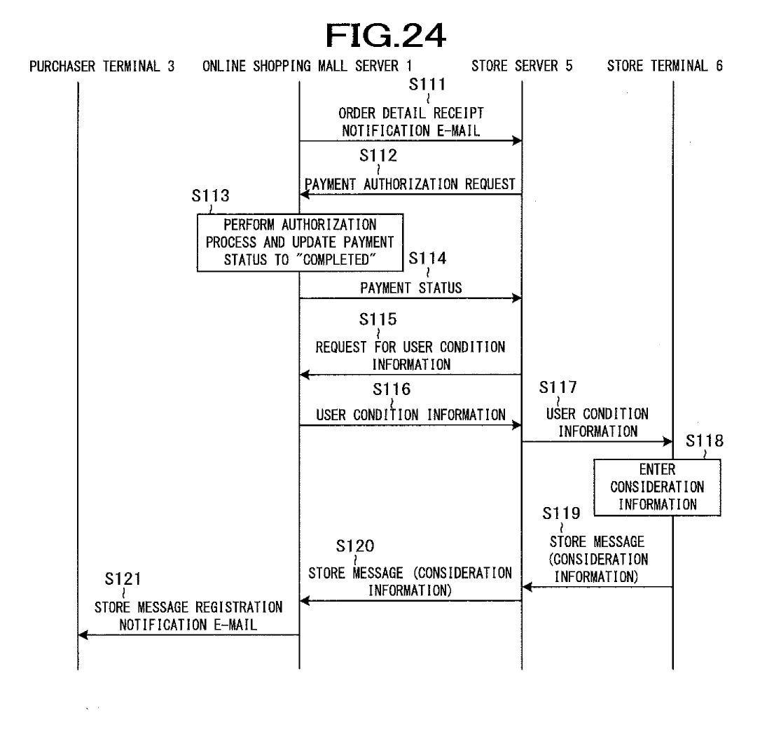

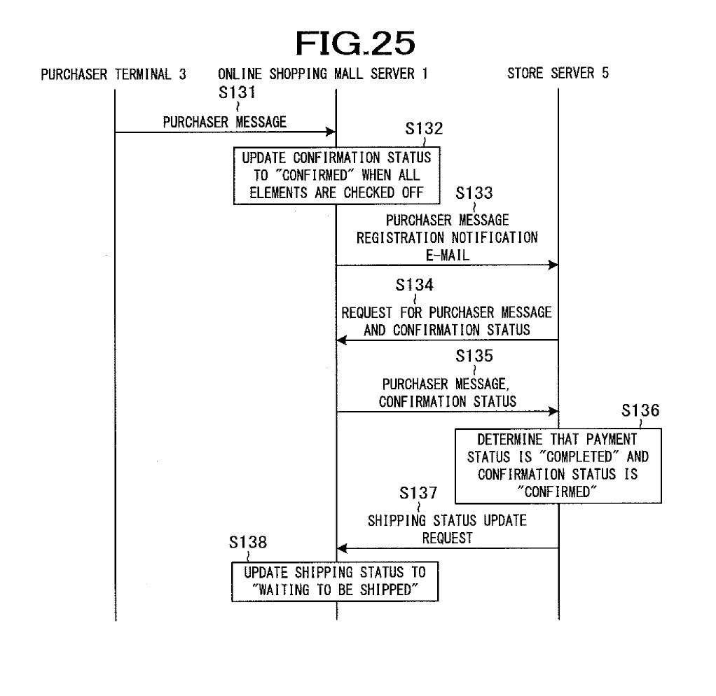

The following describes an overall operation of the information processing system S2 with reference to FIGS. 24 and 25. FIG. 24 is a sequence diagram showing an example of a process, in the information processing system S2 according to this embodiment, for providing consideration information. The order detail receiver 142 that has stored, in the order DB 12e, order information including order details of a designated medicine ordered by a purchaser sends an order detail receipt notification e-mail as shown in FIG. 24 (Step S111). The server communication unit 541 of the store server 5 that has received the order detail receipt notification e-mail stores, for example, the received date and time, the order number, and the order details included in this e-mail in association with each other, in the storage unit 52. The server communication unit 541 also performs a process corresponding to the payment method included in this e-mail. For example, if the payment method is a credit card payment, the server communication unit 541 sends a payment authorization request to the online shopping mall server 1 (Step S112). When the status controller 144 of the online shopping mall server 1 performs an authorization process and then obtains the result indicating that the payment is authorized, the status controller 144 updates the payment status to “completed” (Step S113). If the payment method is not a credit card payment, the store server 5 sends a payment status update request to the online shopping mall server 1, for example, in response to an operation of the store terminal 6 by the store employee. Then the status controller 144 updates the payment status to “completed”. After the authorization process is completed, the system controller 14 of the online shopping mall server 1 sends the current payment status to the store server 5 (Step S114). The status determination unit 543 of the store server 5 stores the received payment status in association with the order information in the storage unit 52.

Subsequently, the server communication unit 541 sends a request for user condition information to the online shopping mall server 1 (Step S115). This request includes the order number. The system controller 14 of the online shopping mall server 1 retrieves, from the order DB 12e, the user condition information corresponding to the order number included in the received request, and sends the user condition information to the store server 5 (Step S116). When the order detail receipt notification e-mail includes the user condition information, Steps 5115 and 5116 are not necessary. The user interface unit 542 of the store server 5 sends the received user condition information to the store terminal 6 (Step S117) and causes the store terminal 6 to display the user condition information. The employee enters consideration information based on the user condition information (Step S118). Then, the store terminal 6 sends the consideration information as a store message to the store server 5 (Step S119), the server communication unit 541 sends the store message to the online shopping mall server 1 (Step S120). The message processor 143 of the online shopping mall server 1 stores the received store message in the message DB 12f, and sends a store message registration notification e-mail to the purchaser (Step S121).

FIG. 25 is a sequence diagram showing an example of a process, in the information processing system S2 according to this embodiment, for updating the confirmation status and the shipping status. When the purchaser enters a purchaser message on the message confirmation page displayed on the purchaser terminal 3, as shown in FIG. 25, the purchaser terminal 3 sends the purchaser message to the online shopping mall server 1 (Step S131). The status controller 144 of the online shopping mall server 1 updates the confirmation status to “confirmed”, when all of the check-box-representing characters included in the purchaser message indicate “checked off” (Step S132). Subsequently, the message processor 143 sends a purchaser message registration notification e-mail to the store (Step S133). The server communication unit 541 of the store server 5 that has received the purchaser message registration notification e-mail sends a request for the purchaser message and the confirmation status to the online shopping mall server 1 (Step S134). This request includes the order number. The system controller 14 of the online shopping mall server 1 retrieves, from the message DB 12f, the purchaser message corresponding to the order number included in the request, and retrieves, from the order DB 12e, the confirmation status corresponding to the order number. The system controller 14 then sends the purchaser message and the confirmation status to the store server 5 (Step S135). When confirming that the payment status is “completed” and the confirmation status is “confirmed” (Step S136), the status determination unit 543 of the store server 5 sends a shipping status update request to the online shopping mall server 1 (Step S137). This request includes the order number. The status controller 144 of the online shopping mall server 1 identifies, from the order DB 12e, the order information corresponding to the order number included in the request, and updates the shipping status included in the order information to “waiting to be shipped” (Step S138).

When the confirmation status received by the store server 5 from the online shopping mall server 1 is “unconfirmed”, the store server 5 sends the purchaser message to the store terminal 6 to have the employee enter a store message to the purchaser message. The store server 5 then sends the entered store message to the online shopping mall server 1.

In the example of the FIGS. 24 and 25, the payment of the purchase price is processed first, and then the consideration information is provided and confirmed. Alternatively, the consideration information may be provided and confirmed first, and then the payment of the purchase price may be processed. Alternatively, these processes may be performed in parallel.

### 2-4-2. Operation of System Controller

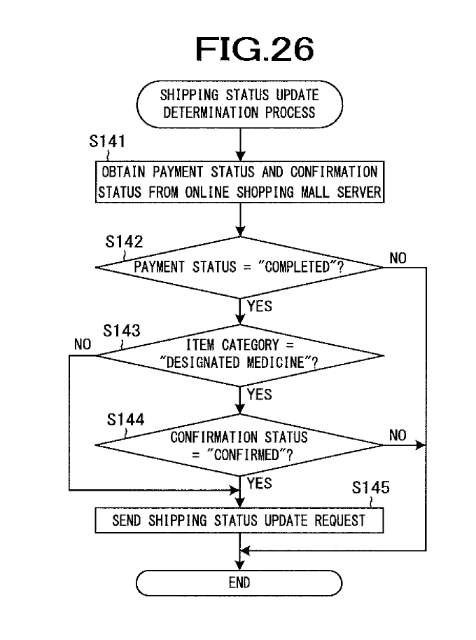

The following describes a specific operation of the system controller 54 of the store server 5 with reference to FIG. 26. FIG. 26 is a flowchart showing an example of a shipping status update determination process in the system controller 54 of the store server 5 according to this embodiment. For example, when the result of an authorization process for payment with a credit card (Step S114 of FIG. 24), when the store server 5 sends a payment status update request to the online shopping mall server 1, and when the store server 5 receives the purchaser message registration notification e-mail (Step S133 of FIG. 25), the system controller 54 may performs the shipping status update determination process.

As shown in FIG. 26, the status determination unit 543 obtains the payment status or the confirmation status corresponding to an order to be handled, or both of the statuses from the online shopping mall server 1 as needed (Step S141). For example, the status determination unit 543 sends a request including an order number to the online shopping mall server 1, and the online shopping mall server 1 sends the payment status and the confirmation status corresponding to the order number to the store server 5. Then, the status determination unit 543 determines whether the payment status is “completed” (Step S142). If the status determination unit 543 determines that the payment status is not “completed” here (NO in Step S142), the status determination unit 543 terminates the shipping status update determination process. On the other hand, if the status determination unit 543 determines that the payment status is “completed” (YES in Step S142), the process proceeds to Step S143. In Step S143, the status determination unit 543 determines whether the item category corresponding to the order number of the order is “designated medicine”. The status determination unit 543 may determine whether the item category is “designated medicine”, for example, based on the genre ID of the item ordered, or may obtain the item category from the online shopping mall server 1. If the status determination unit 543 determines that the item category is not “designated medicine” here (NO in Step S143), the process proceeds to Step S145. On the other hand, if the status determination unit 543 determines that the item category is “designated medicine” (YES in Step S143), the process proceeds to Step S144. In Step S144, the status determination unit 543 determines whether the confirmation status corresponding to the order is “confirmed”. If the status determination unit 543 determines that the confirmation status is not “confirmed” here (NO in Step S144), the status determination unit 543 terminates the shipping status update determination process. On the other hand, if the status determination unit 543 determines that the confirmation status is “confirmed” (YES in Step S144), the process proceeds to Step S145. In Step S145, the status determination unit 543 sends a shipping status update request including the order number of the order to the online shopping mall server 1, and terminates the shipping status update determination process.

As described above, according to this embodiment, when the item ordered is not a designated medicine, the store server 5 sends a shipping status update request and the online shopping mall server 1 updates the shipping status to “waiting to be shipped”, on the condition that the payment status has been updated to “completed”. When the item ordered is a designated medicine, the store server 5 sends the shipping status update request and the online shopping mall server 1 updates the shipping status to “waiting to be shipped”, on the condition that the payment status has been updated to “completed” and the confirmation status has been updated to “confirmed”. Thus, this embodiment can prevent the store from shipping the item by mistake.

### 3. Third Embodiment

### 3-1. Functional Overview of System Controller

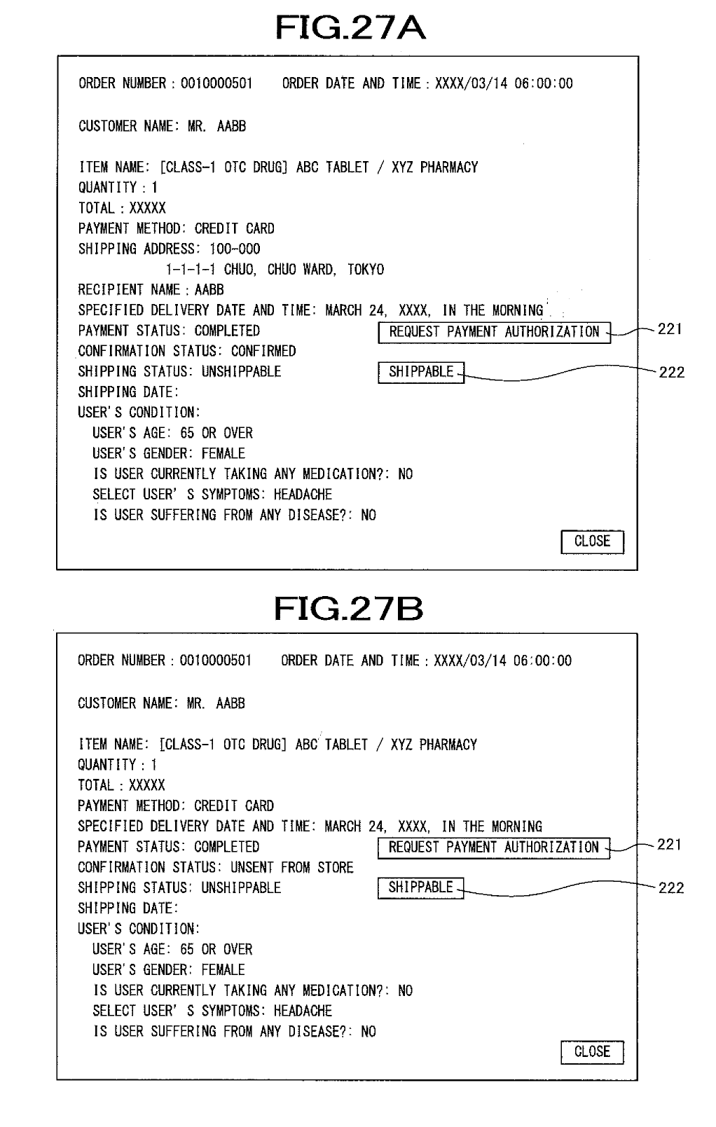

The following describes functions of the system controller 14 according to a third embodiment with reference to FIG. 27. Except for points described below, the third embodiment is basically the same as the first embodiment. In this embodiment, when a designated medicine is ordered, the received order information provider 145 controls whether to provide the shipping address for the item ordered, based on the confirmation status. The received order information provider 145 in this embodiment is an example of order detail output means. FIG. 27A is a diagram showing a display example of the received order management page when the confirmation status is “confirmed”. FIG. 27B is a diagram showing a display example of the received order management page when the confirmation status is “unconfirmed”. As shown in FIG. 27A, when the confirmation status is “confirmed”, the received order information provider 145 causes the shipping address to be displayed. On the other hand, as shown in FIG. 27B, when the confirmation status is “unconfirmed”, the received order information provider 145 causes the shipping address not to be displayed. This can prevent the store from mistakenly shipping the item ordered before the purchaser has confirmed the consideration information. The message processor 143 also does not put the shipping address in the order detail receipt notification e-mail.

### 3-2. Operation of System Controller

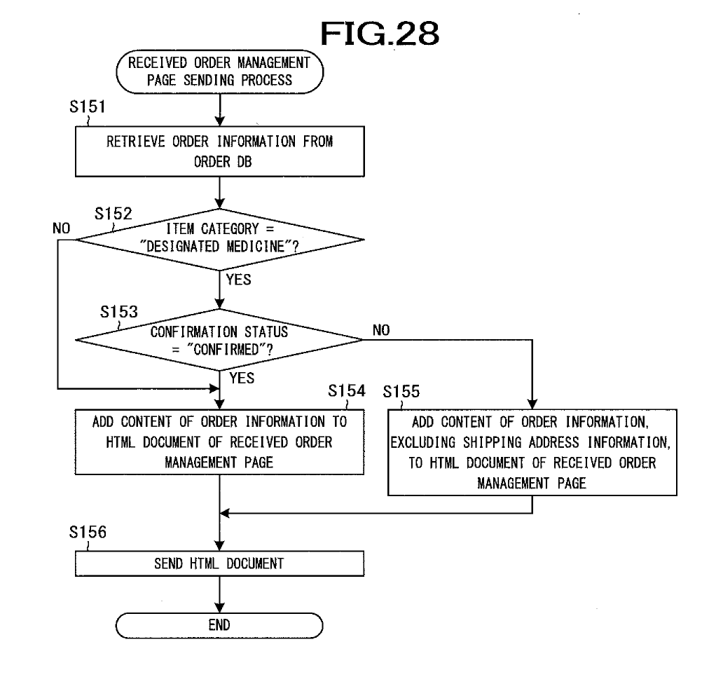

The following describes a specific operation of the system controller 14 of the online shopping mall server 1 with reference to FIG. 28. FIG. 28 is a flowchart showing an example of a received order management page sending process in the system controller 14 of the online shopping mall server 1 according to this embodiment. When a request for the received order management page from the store terminal 2, the system controller 14 performs the received order management page sending process. This request includes an order number. As shown in FIG. 28, the received order information provider 145 retrieves, from the order DB 12e, the order information that corresponds to the order number included in the request (Step S151). The received order information provider 145 also retrieves an HTML document, a template, of the received order management page from the storage unit 12. Subsequently, the received order information provider 145 determines whether the item category included in the order information is “designated medicine” (Step S152). If the received order information provider 145 determines that the item category is not “designated medicine” here (NO in Step S152), the process proceeds to Step S154. On the other hand, if the received order information provider 145 determines that the item category is “designated medicine” (YES in Step S152), the process proceeds to Step S153.

In Step S153, the received order information provider 145 determines whether the confirmation status included in the order information is “confirmed”. If the received order information provider 145 determines that the confirmation status is “confirmed” here (YES in Step S153), the process proceeds to Step S154. In Step S154, the received order information provider 145 adds the content of the order information to the HTML document of the received order management page. At this time, the received order information provider 145 also adds the shipping address information to the HTML document of the received order management page. Then, the process proceeds to Step S156. On the other hand, if the received order information provider 145 determines that the confirmation status is not “confirmed” (NO in Step S153), the process proceeds to Step S155. In Step S155, the received order information provider 145 adds the content of the order information, excluding the shipping address information, to the HTML document of the received order management page. Then, the process proceeds to Step S156. In Step S165, the received order information provider 145 sends the HTML document of the received order management page to the store terminal 2, and terminates the received order management page sending process.

As described above, according to this embodiment, when the item ordered is “designated medicine” and the confirmation status associated with the order details is “unconfirmed”, the system controller 14 outputs the order details excluding the shipping address for the item. Thus, this embodiment can prevent the store from shipping the item before the purchaser has confirmed the consideration information.

According to this exemplary non-limiting embodiment, the exclusion of the shipping address for the item reduces the processing load that would be necessary to output the excluded shipping address. As such, there is an advantageous improvement to the controller 14 (i.e., computer) since the processing load on the controller 14 is reduced.

### 4. Fourth Embodiment

### 4-1. Configuration and Functional Overview of Information Processing System

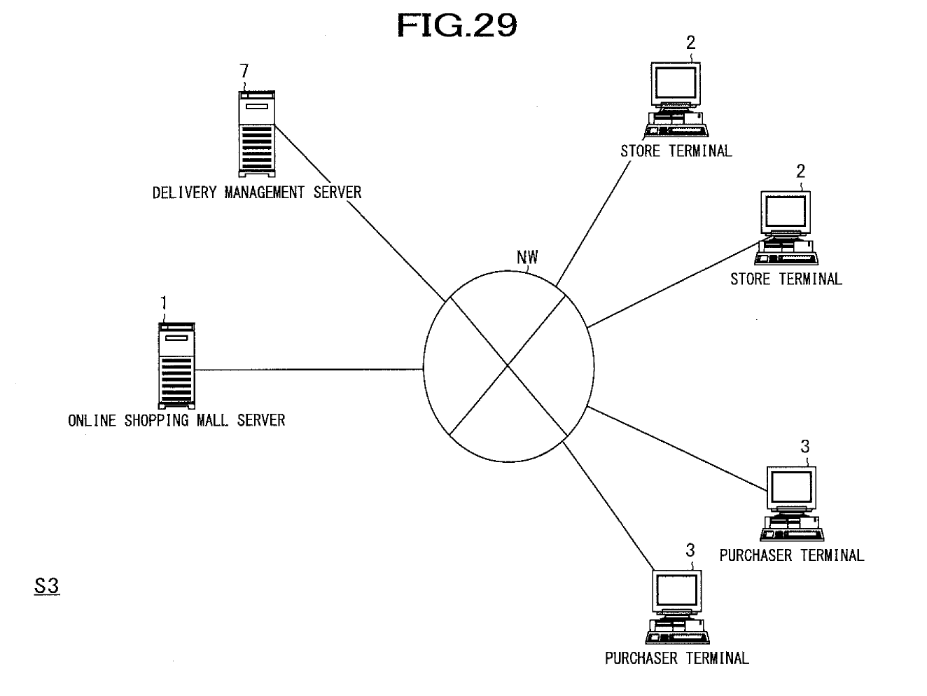

The following describes a fourth embodiment. Except for points described below, the fourth embodiment is basically the same as the first embodiment. First, a configuration and a functional overview of an information processing system S3 according to the fourth embodiment are described with reference to FIG. 29. FIG. 29 is a diagram showing an example of a schematic configuration of the information processing system S3 according to this embodiment. In FIG. 29, the same components as those shown in FIG. 1 are denoted by the same reference signs.

As shown in FIG. 29, the information processing system S3 includes the online shopping mall server 1, the plurality of store terminals 2, the plurality of purchaser terminals 3, and a delivery management server 7. The online shopping mall server 1 can exchange data with each store system 2, each purchaser terminal 3, and the delivery management server 7 via the network NW.

The delivery management server 7 is a server device that manages delivery statuses of items for delivery services, such as home delivery services. The delivery management server 7 may be installed, for example, by a predetermined delivery company. In this embodiment, the online shopping mall server 1 provides the delivery statuses of items purchased through the online shopping mall, in cooperation with the delivery management server 7.

For example, before shipping an item ordered, the store employee enters its delivery slip information into the store terminal 2. The delivery slip information is information shown in a delivery slip. The delivery slip information includes at least a delivery slip number. The delivery slip number is an identification number of the delivery slip. The delivery slip information may further include a shipping address, a name, a telephone number, a delivery date and time, and other information. The store terminal 2 sends the entered delivery slip information with the order number to the online shopping mall server 1. The online shopping mall server 1 stores the delivery slip information in association with the order number in the storage unit 12. For example, the online shopping mall server 1 stores the delivery slip information in the order DB 12e.

The store hands the item ordered with the delivery slip to the delivery company. The delivery company enters the information shown in the delivery slip into the delivery management server 7. After that, for example, when the order history page is displayed on the purchaser terminal 3, the purchaser selects any of the items ordered to display its delivery status. Then, the purchaser terminal 3 sends the order number, and the online shopping mall server 1 identifies the delivery slip number corresponding to the order number and obtains the delivery status corresponding to the delivery slip number from the delivery management server 7. The online shopping mall server 1 then causes the purchaser terminal 3 to display the delivery status. The delivery status may be displayed, for example, on the received order management page displayed on the store terminal 2.

### 4-2. Functional Overview of System Controller

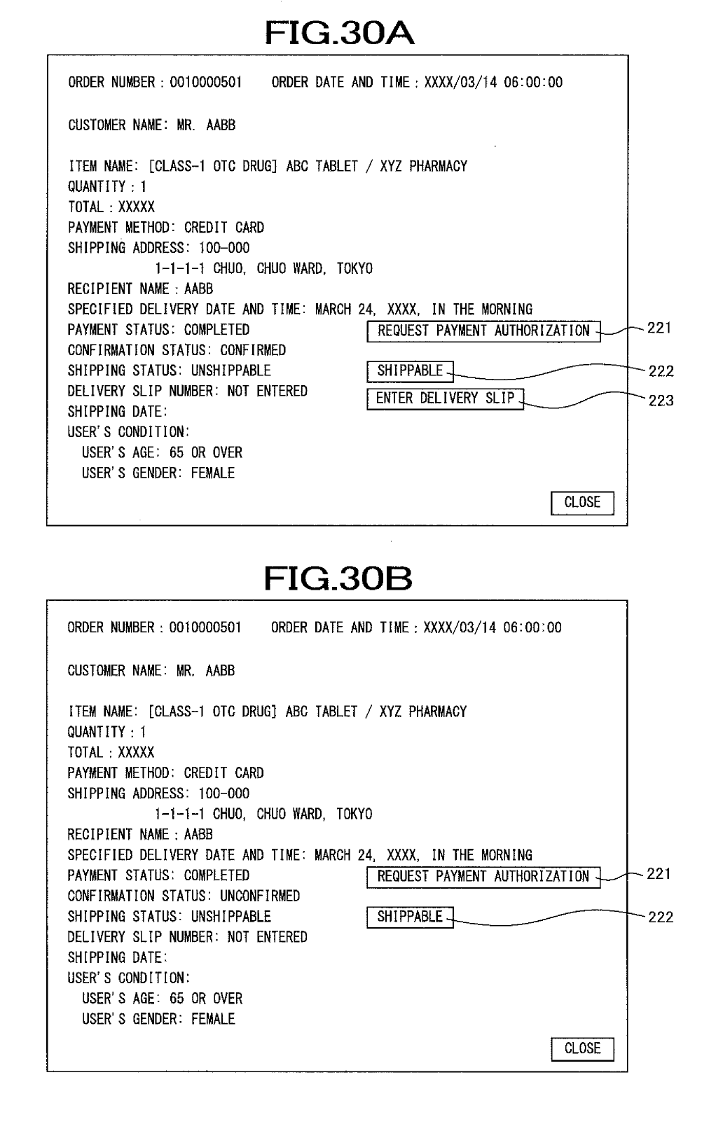

The following describes functions of the system controller 14 with reference to FIG. 30. In this embodiment, the received order information provider 145 receives the entry of delivery slip information from the store. Here, when a designated medicine is ordered, the received order information provider 145 controls whether to allow the store to enter the delivery slip information, based on the confirmation status. The received order information provider 145 is an example of the delivery slip receiving means. FIG. 30A is a diagram showing a display example of the received order management page when the confirmation status is “confirmed”. FIG. 30B is a diagram showing a display example of the received order management page when the confirmation status is “unconfirmed”. As shown in FIG. 30A, when the confirmation status is “confirmed”, the received order information provider 145 causes an “enter delivery slip” button 223 to be displayed on the received order management page. The “enter delivery slip” button 223 is a button for displaying a delivery slip entry page. The delivery slip entry page is a web page for entering delivery slip information. When an employee enters delivery slip information on the delivery slip entry page, the store terminal 2 sends the delivery slip information to the online shopping mall server 1. Then online shopping mall server 1 stores the delivery slip information in the order DB 12e. On the other hand, as shown in FIG. 30B, when the confirmation status is “unconfirmed”, the received order information provider 145 causes the “enter delivery slip” button 223 not to be displayed. This can prevent the store from mistakenly shipping the item ordered before the purchaser has confirmed the consideration information.

The received order information provider 145 may control whether to display the shipping address as in the third embodiment as well as whether to display the “enter delivery slip” button 223. Instead of controlling whether to display the “enter delivery slip” button 223, the received order information provider 145, for example, may cause a warning message or the like indicating that the order cannot be shipped to be displayed on the delivery slip entry page, when the confirmation status is “unconfirmed”.

### 4-3. Operation of System Controller

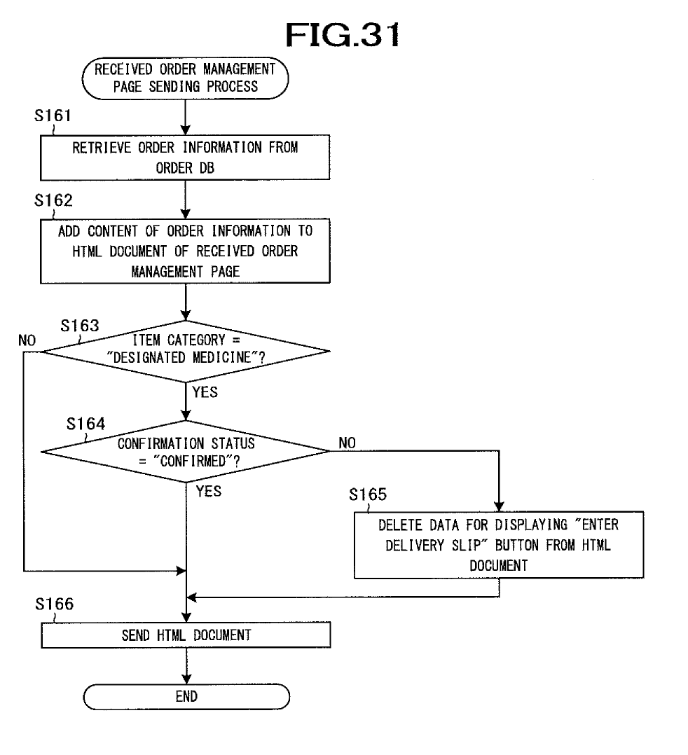

The following describes a specific operation of the system controller 14 of the online shopping mall server 1 with reference to FIG. 31. FIG. 31 is a flowchart showing an example of the received order management page sending process in the system controller 14 of the online shopping mall server 1 according to this embodiment. When a request for the received order management page from the store terminal 2, the system controller 14 performs the received order management page sending process. This request includes an order number. As shown in FIG. 31, the received order information provider 145 retrieves, from the order DB 12e, the order information that corresponds to the order number included in the request (Step S161). The received order information provider 145 also retrieves an HTML document, a template, of the received order management page from the storage unit 12. The HTML document includes data for displaying the “enter delivery slip” button 223. Then, the received order information provider 145 adds the content of the order information to the HTML document of the received order management page. Next, the received order information provider 145 determines whether the item category included in the order information is “designated medicine” (Step S163). If the received order information provider 145 determines that the item category is not “designated medicine” here (NO in Step S163), the process proceeds to Step S166. On the other hand, if the received order information provider 145 determines that the item category is “designated medicine” (YES in Step S163), the process proceeds to Step S164.

In Step S164, the received order information provider 145 determines whether the confirmation status included in the order information is “confirmed”. If the received order information provider 145 determines that the confirmation status is “confirmed” here (YES in Step S164), the process proceeds to Step S166. On the other hand, if the received order information provider 145 determines that the confirmation status is not “confirmed” (NO in Step S164), the process proceeds to Step S165. In Step S165, the received order information provider 145 deletes data for displaying the “enter delivery slip” button 223 from the HTML document of the received order management page. Then, the process proceeds to Step S166. In Step S166, the received order information provider 145 sends the HTML document of the received order management page to the store terminal 2, and terminates the received order management page sending process.

Instead of controlling whether to display the “enter delivery slip” button 223, the system controller 14, for example, may control whether to store the delivery slip information. For example, when the entered delivery slip information is received from the store terminal 2, the system controller 14 may determines whether to store the delivery slip information in the order DB 12e, based on the item category and the confirmation status of the corresponding order information. The steps of determining it is the same as the corresponding steps shown in FIG. 31.

As described above, according to this embodiment, when the item is “designated medicine” and the confirmation status associated with the order details is “unconfirmed”, the system controller 14 does not store the delivery slip information. Thus, this embodiment can prevent the store from shipping the item using the delivery slip before the purchaser has confirmed the consideration information.

According to this exemplary non-limiting embodiment, by not storing the delivery slip information, the storage capacity of the computer storage is improved. As such, there is an advantageous improvement to the computer component (i.e., storage unit) since less data is stored, the storage capacity of the storage unit is improved.

### 5. Fifth Embodiment

### 5-1. Functional Overview of System Controller

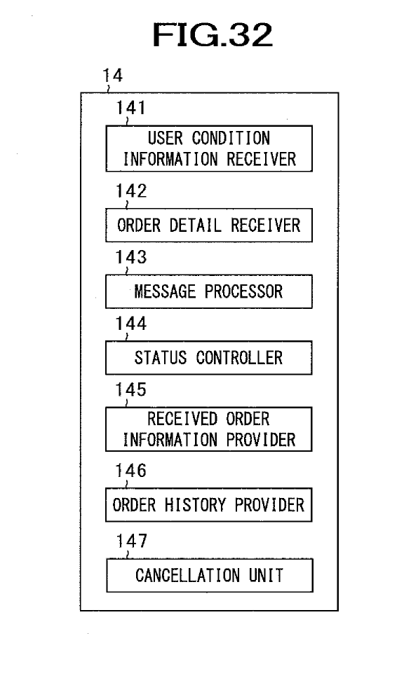

The following describes functions of the system controller 14 according to a fifth embodiment with reference to FIG. 32. Except for points described below, the fifth embodiment is basically the same as the first embodiment to the fourth embodiment. FIG. 32 is a diagram showing an example of functional blocks of the system controller 14 of the online shopping mall server 1 according to this embodiment. In FIG. 32, the same components as those shown in FIG. 3B are denoted by the same reference signs. As shown in FIG. 32, the system controller 14 functions as the user condition information receiver 141, the order detail receiver 142, the message processor 143, the status controller 144, the received order information provider 145, the order history provider 146, a cancellation unit 147, and other units. The cancellation unit 147 is an example of cancellation means.

If the confirmation status is still “unconfirmed” though a predetermined confirmation period has passed since a store message registration notification e-mail, which notifies that consideration information regarding an order for a designated medicine had been stored, was sent, the cancellation unit 147 automatically cancels the order for the designated medicine. When the item ordered is a designated medicine, the store cannot ship the item ordered before the purchaser has confirmed the consideration information. Thus, the store has to stock the item ordered as a backlog before shipping it. When the confirmation has not been received from the purchaser after the elapse of the predetermined period, an automatic cancellation of the order can allow the store to release the backlog. The number of days of the confirmation period may be preset by an administrator of the online shopping mall server 1. The set number of days of the confirmation period is stored in the storage unit 12.

### 5-2. Operation of System Controller

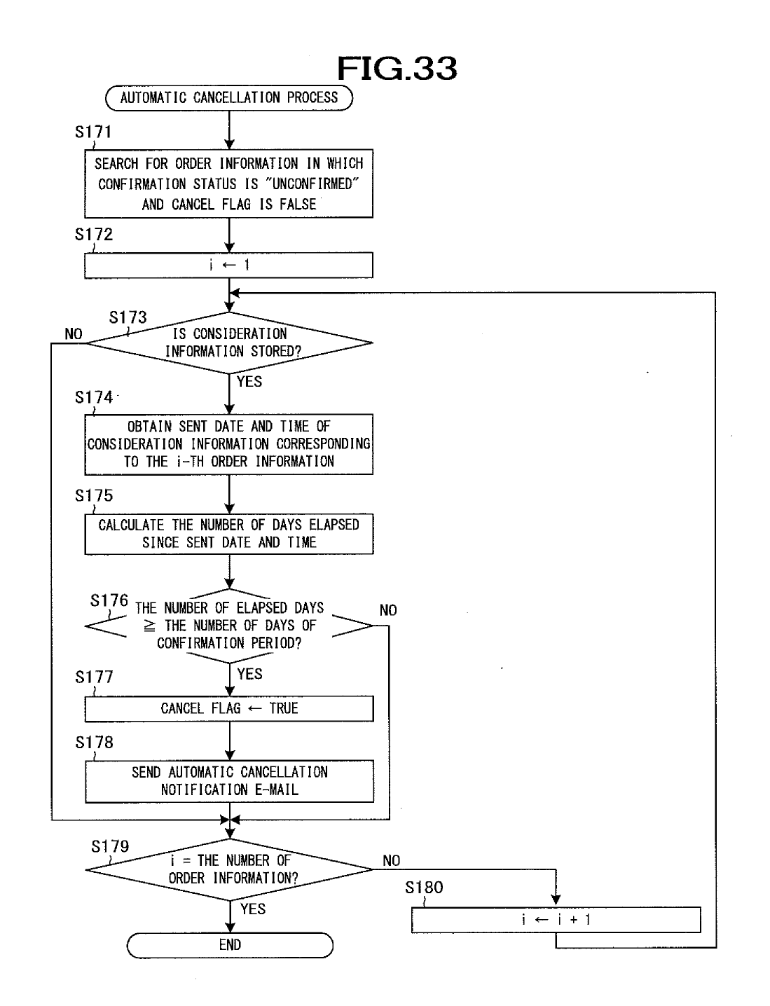

The following describes a specific operation of the system controller 14 of the online shopping mall server 1 with reference to FIG. 33. FIG. 33 is a flowchart showing an example of an automatic cancellation process in the system controller 14 of the online shopping mall server 1 according to this embodiment. For example, the system controller 14 performs the automatic cancellation process regularly. For example, the system controller 14 may performs the automatic cancellation process at predetermined intervals or every a predetermined number of days.

As shown in FIG. 33, the cancellation unit 147 searches the order DB 12e for order information in which the item category is “designated medicine”, the confirmation status is “unconfirmed”, and the cancel flag is FALSE (Step S171). Subsequently, the cancellation unit 147 sets a variable i to 1 (Step S172). Then, the cancellation unit 147 determines whether the consideration information corresponding to the i-th order information among the retrieved order information is stored (Step S173). Specifically, the cancellation unit 147 searches the message DB 12f for the store message corresponding to the order number included in the i-th order information. If the store message is not found, the cancellation unit 147 determines that the consideration information is not stored (NO in Step S173). In this case, the process proceeds to Step S179. On the other hand, if the store message is found, the cancellation unit 147 determines that the consideration information is stored (YES in Step S173). In this case, the process proceeds to Step S174.

In Step S174, the cancellation unit 147 obtains the sent date and time of the consideration information. Specifically, the cancellation unit 147 retrieves the store sent date and time with a message number of 1, among the store sent dates and times corresponding to the order number included in the i-th order information, from the message DB 12f. The store sent date and time is treated as the sent date and time of the store message registration notification e-mail. Subsequently, the cancellation unit 147 subtracts the retrieved sent date and time from the current date and time to calculate the number of elapsed days (Step S175). Then, the cancellation unit 147 determines whether the number of elapsed days is equal to or greater than the number of days of the confirmation period stored in the storage unit 12 (Step S176). If the cancellation unit 147 determines that the number of elapsed days is less than the number of days of the confirmation period here (NO in Step S176), the process proceeds to Step S179. On the other hand, if the cancellation unit 147 determines that the number of elapsed days is equal to or greater than the number of days of the confirmation period (YES in Step S176), the process proceeds to Step S177.

In Step S177, the cancellation unit 147 sets the cancel flag included in the i-th order information to TRUE. Then, the cancellation unit 147 sends an automatic cancellation notification e-mail to each of the purchaser and the store (Step S178). The automatic cancellation notification e-mail is an e-mail notifying that the order has been canceled automatically. The cancellation unit 147 obtains the purchaser's e-mail address and the store's e-mail address based on the user ID and the store ID included in the i-th order information, and sends the automatic cancellation notification e-mails based on these e-mail addresses. Subsequently, the process proceeds to Step S179.

In Step 179, the cancellation unit 147 determines whether the variable i is equal to the number of the retrieved order information. If the cancellation unit 147 determines that the variable i is not equal to the number of the order information (NO in Step S179), the process proceeds to Step S180. In Step S180, the cancellation unit 147 adds 1 to the variable i, and the process proceeds to Step S173. On the other hand, if the cancellation unit 147 determines that the variable i is equal to the number of the order information (YES in Step S179), the cancellation unit 147 terminates the automatic cancellation process.

As described above, according to this embodiment, when consideration information is generated, the system controller 14 outputs a store message registration notification e-mail notifying that the consideration information requires confirming. When the purchaser message has not been received within a predetermined period since the store message registration notification e-mail was output, the system controller 14 cancels receipt of the order details. Thus, this embodiment can decrease the number of backlogs, which cannot be shipped before the corresponding consideration information has been confirmed and also cannot be sold to other purchasers.

According to this exemplary non-limiting embodiment, by decreasing the number of backlogs, the storage capacity of the computer storage is improved. As such, there is an advantageous improvement to the computer component (i.e., storage unit) since less data is stored, the storage capacity of the storage unit is improved.

### 6. Sixth Embodiment

### 6-1. Functional Overview of System Controller

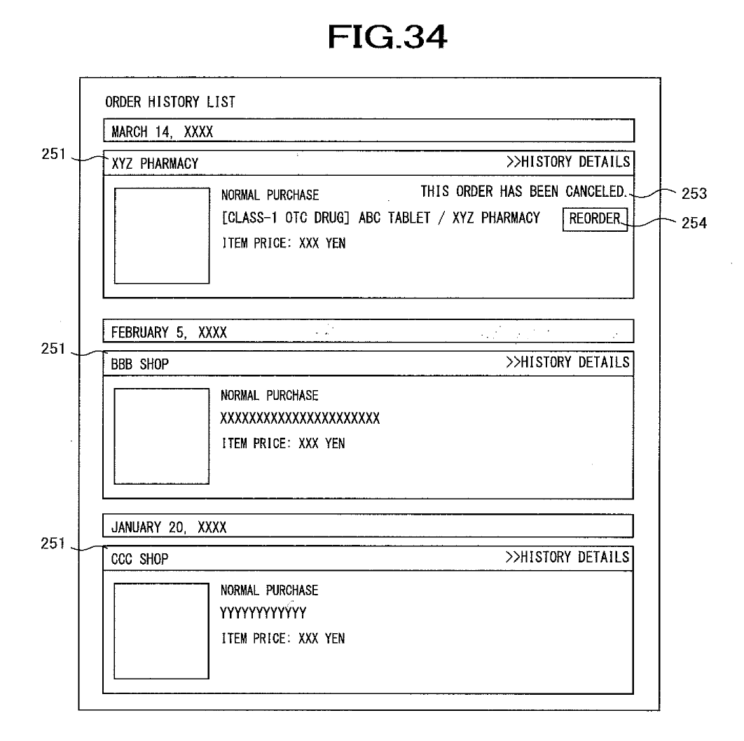

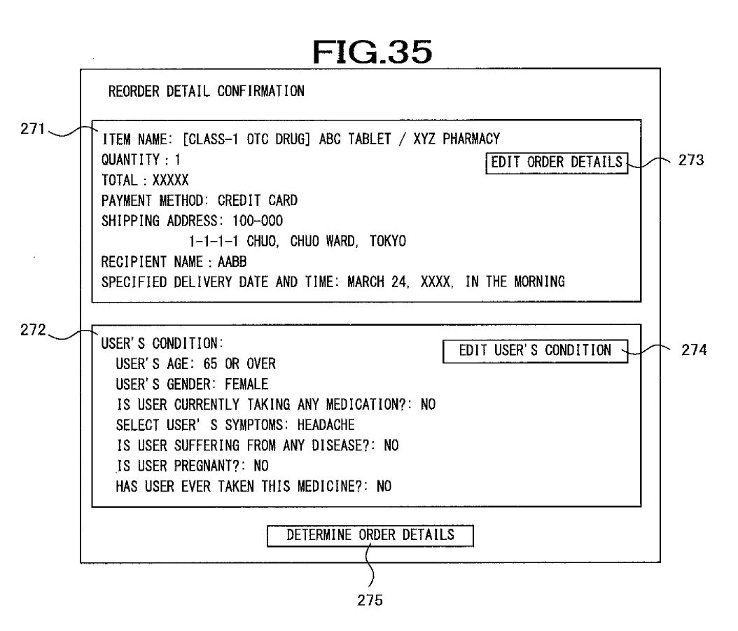

The following describes functions of the system controller 14 according to a sixth embodiment with reference to FIGS. 34 and 35. Except for points described below, the sixth embodiment is basically the same as the fifth embodiment. After the order details are automatically canceled as described in the fifth embodiment, the order detail receiver 142 allows the purchaser to reorder the item indicated by the canceled order details. Additionally, the order detail receiver 142 makes it possible to receive the canceled order details as the order details regarding the reorder and to receive the user condition information associated with the canceled order details as the user condition information regarding the reorder. This can save the purchaser the time and effort of reentering the order details and the user condition information when reordering.

FIG. 34 is a diagram showing a display example of the order history page. In FIG. 34, the same components as those shown in FIG. 11 are denoted by the same reference signs. As shown in FIG. 34, the order history page shows, in the order detail display area 251 corresponding to the order details automatically canceled, a message 253 indicating that the order has been canceled and a reorder button 254. The reorder button 254 is a button for reordering the item indicated in the canceled order details. The reorder button 254 is an example of a reorder element. When the purchaser selects the reorder button 254, the order detail receiver 142 sends a reorder detail confirmation page to the purchaser terminal 3. The reorder detail confirmation page is a web page for confirming the order details and the user condition information regarding the reorder.

FIG. 35 is a diagram showing a display example of the reorder detail confirmation page. As shown in FIG. 35, the reorder detail confirmation page displays an order detail display area 271, a user condition information display area 272, an order detail edit button 273, a user condition information edit button 274, and a determination button 275. The order detail display area 271 shows the order details. The user condition information display area 272 shows the user condition information. The order details and the user condition information displayed on the reorder detail confirmation page are respectively the canceled order details and the user condition information associated with the order details. When the purchaser selects the order detail edit button 273, the order detail receiver 142 sends an order detail edit page to the purchaser terminal 3. On this order detail edit page, the purchaser can edit the order details that was displayed on the reorder detail confirmation page. After the editing ends, the order detail receiver 142 sends the reorder detail confirmation page. When the purchaser selects the user condition information edit button 274, the user condition information receiver 141 sends a user condition information edit page to the purchaser terminal 3. On this user condition information edit page, the purchaser can edit the user condition information that was displayed on the reorder detail confirmation page. After the editing ends, the order detail receiver 142 sends the reorder detail confirmation page. The determination button 275 is a button for determining the order details and the user condition information. If the purchaser selects the determination button 275 without editing any of the order details and the user condition information, the order detail receiver 142 retrieves the canceled order details and the user condition information associated with the canceled order details, from the order DB 12e. The order detail receiver 142 then stores new order information including the retrieved order details and user condition information in the order DB 12e. If the order details are edited, the order detail receiver 142 stores order information including the edited order details and the user condition information associated with the canceled order details in the order DB 12e. If the user condition information is edited, the order detail receiver 142 stores order information including the edited user condition information and the canceled order details in the order DB 12e. If both the order details and the user condition information are edited, the order detail receiver 142 stores order information including the edited information in the order DB 12e.

When the store employee enters consideration information in response to the user condition information regarding the reorder, the message processor 143 may causes the store terminal 2 to display the consideration information associated with the canceled order details. This allows the employee to enter the consideration information regarding the reorder referring to the previous consideration information. For example, the message processor 143 may causes the store terminal 2 to display the message entry page with the message entry field 243 prefilled with the consideration information associated with the canceled order details.

### 6-2. Operation of System Controller

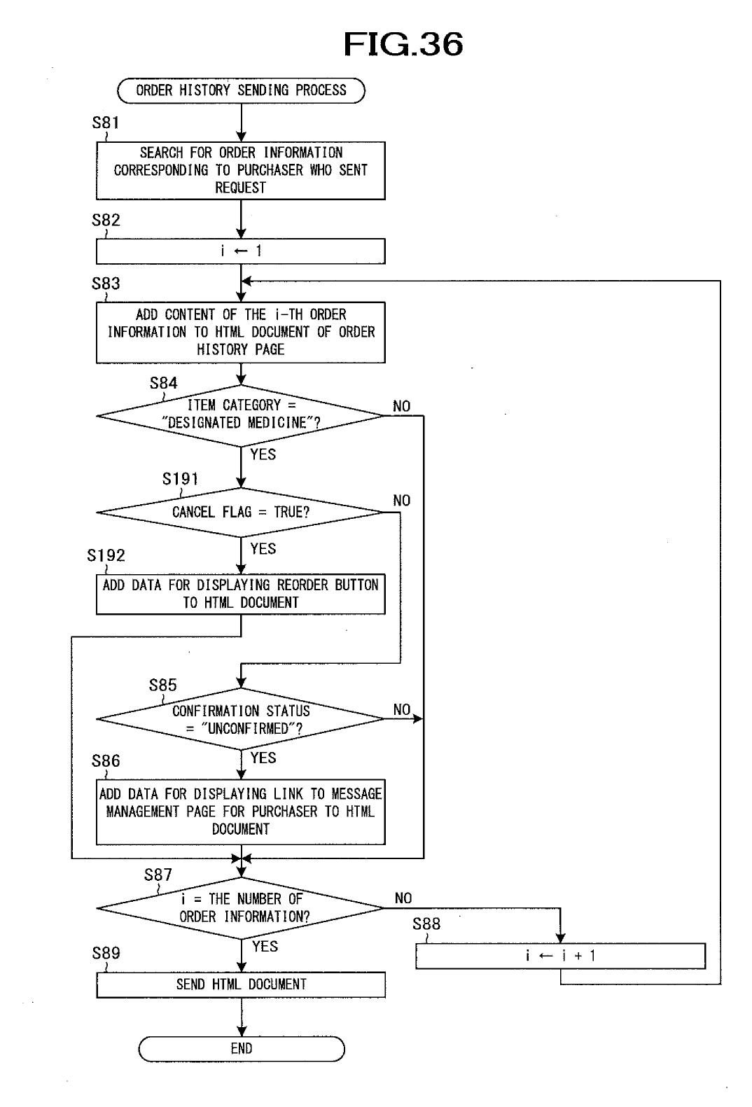

The following describes a specific operation of the system controller 14 of the online shopping mall server 1 with reference to FIGS. 36 to 38. FIG. 36 is a flowchart showing an example of the order history sending process in the system controller 14 of the online shopping mall server 1 according to this embodiment. In FIG. 36, the same steps as those shown in FIG. 19 are denoted by the same reference signs. As shown in FIG. 36, the order detail receiver 142 performs Steps S81 to S84. If the order detail receiver 142 determines that the item category is not “designated medicine” (NO in Step S84), the process proceeds to Step S87. On the other hand, if the order detail receiver 142 determines that the item category is “designated medicine” (YES in Step S84), the process proceeds to Step S191. In Step S191, the order detail receiver 142 determines whether the cancel flag included in the i-th order information to TRUE. If the order detail receiver 142 determines that the cancel flag is not TRUE here (NO in Step S191), the process proceeds to Step S85. On the other hand, if the order detail receiver 142 determines that the cancel flag is TRUE (YES in Step S191), the process proceeds to Step S192. In Step S192, the order detail receiver 142 adds data for displaying the reorder button 254 for the i-th order information to the HTML document of the order history page. Then, the process proceeds to Step S87. Steps S85 to S89 are the same as those in the first embodiment.

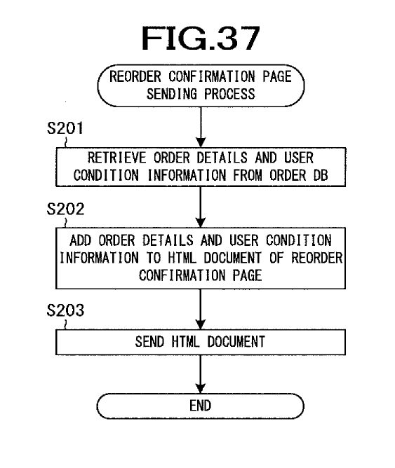

FIG. 37 is a flowchart showing an example of a reorder confirmation page sending process in the system controller 14 of the online shopping mall server 1 according to this embodiment. When the purchaser selects the reorder button 254 on the order history page displayed on the purchaser terminal 3, the purchaser terminal 3 sends a reorder confirmation request to the online shopping mall server 1. The reorder confirmation request includes the order number corresponding to the selected reorder button 254. When the reorder confirmation request is received from the purchaser terminal 3, the system controller 14 performs the reorder confirmation page sending process. As shown in FIG. 37, the order detail receiver 142 retrieves the order details and the user condition information corresponding to the order number included in the reorder confirmation request, from the order DB 12e (Step S201). The order detail receiver 142 also retrieves an HTML document, a template, of the reorder confirmation page from the storage unit 12. Subsequently, the order detail receiver 142 adds the retrieved order details and user condition information to the HTML document of the reorder confirmation page (Step S202). Then, the order detail receiver 142 sends the HTML document of the reorder confirmation page to the purchaser terminal 3 (Step S203), and terminates the reorder confirmation page sending process.

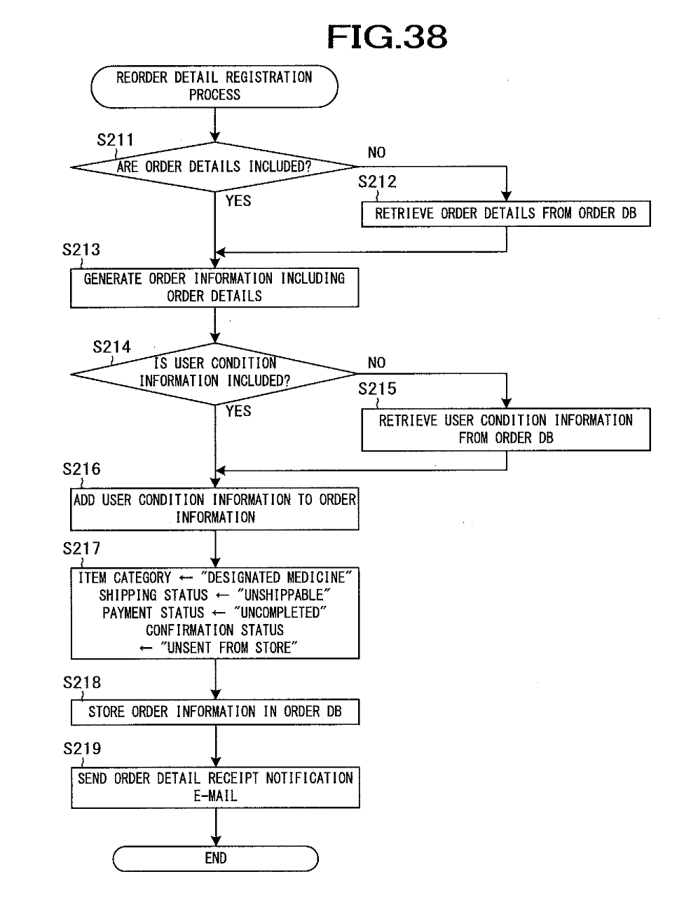

FIG. 38 is a flowchart showing an example of a reorder detail registration process in the system controller 14 of the online shopping mall server 1 according to this embodiment. When the purchaser selects the determination button 275 on the reorder detail confirmation page displayed on the purchaser terminal 3, the purchaser terminal 3 sends a reorder detail determination request to the online shopping mall server 1. The reorder detail determination request includes the order number corresponding to the reorder button 254 selected by the purchaser on the order history page. If the order details are edited, the reorder detail determination request includes the edited order details. If the order details are not edited, the reorder detail determination request does not include the order details. If the user condition information is edited, the reorder detail determination request includes the edited user condition information. If the user condition information is not edited, the reorder detail determination request does not include the user condition information. When the reorder detail determination request is received from the purchaser terminal 3, the system controller 14 performs the reorder detail registration process.

As shown in FIG. 38, the order detail receiver 142 determines whether the reorder detail determination request includes the order details (Step S211). If the order detail receiver 142 determines that the reorder detail determination request includes the order details here (YES in Step S211), the process proceeds to Step S213. On the other hand, if the order detail receiver 142 determines that the reorder detail determination request does not include the order details (NO in Step S211), the process proceeds to Step S212. In Step S212, the order detail receiver 142 retrieves the order details corresponding to the order number included in the reorder detail determination request, from the order DB 12e. Then, the process proceeds to Step S213. In Step S213, the order detail receiver 142 generates order information including the order details included in the reorder detail determination request or the retrieved order details in Step S212. At this time, the order detail receiver 142 generates a new order number and obtains the current date and time as the received date and time.

Subsequently, the user condition information receiver 141 determines whether the reorder detail determination request includes the user condition information (Step S214). If the user condition information receiver 141 determines that the reorder detail determination request includes the user condition information here (YES in Step S214), the process proceeds to Step S216. On the other hand, if the user condition information receiver 141 determines that the reorder detail determination request does not include the user condition information (NO in Step S214), the process proceeds to Step S215. In Step S215, the user condition information receiver 141 retrieves the user condition information corresponding to the order number included in the reorder detail determination request, from the order DB 12e. Then, the process proceeds to Step S216. In Step S216, the user condition information receiver 141 adds the user condition information included in the reorder detail determination request or the user condition information retrieved in Step S215 to the order information.

Next, the order detail receiver 142 sets the information included in the order information (Step S217). Specifically, the order detail receiver 142 sets the item category to “designated medicine”. The order detail receiver 142 also sets the shipping status to “unshippable” and sets the payment status to “uncompleted”. The order detail receiver 142 also sets the confirmation status to “unsent from store” . Subsequently, the order detail receiver 142 stores the generated order information in the order DB 12e (Step S218). Then, the order detail receiver 142 sends an order detail receipt notification e-mail (Step S219), and terminates the reorder detail registration process.

As described above, according to this embodiment, the system controller 14 causes the order detail display area 251 including at least a portion of the canceled order details and the reorder button 254 to be presented. When the order details for the reorder is received based on operation of the reorder button 254, the system controller 14 also obtains the user condition information associated with the canceled order details as the user condition information to be associated with the order details for the reorder. Thus, the purchaser can save the time and effort of reentering the user condition information when reordering.

### 7. Seventh Embodiment

### 7-1. Functional Overview of System Controller

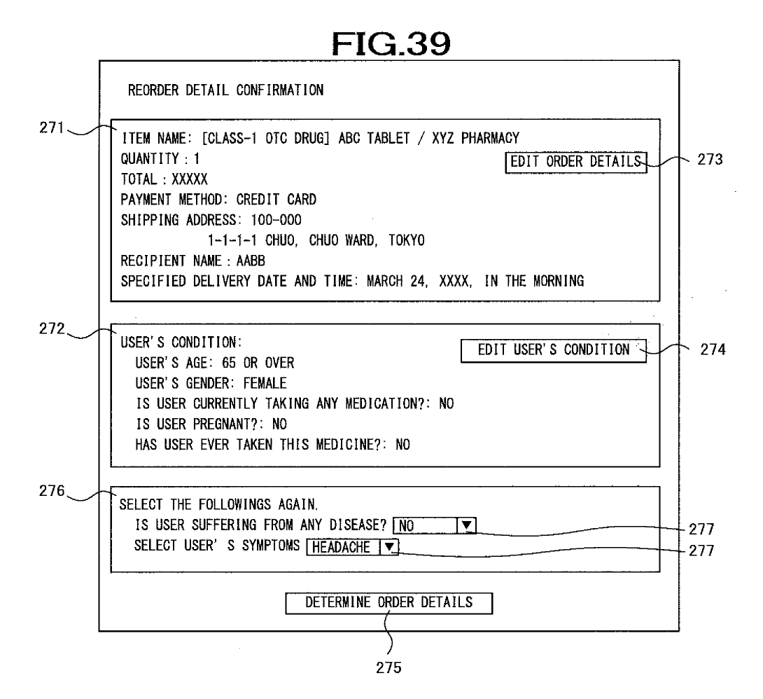

The following describes functions of the system controller 14 according to a seventh embodiment with reference to FIG. 39. Except for points described below, the seventh embodiment is basically the same as the sixth embodiment. In this embodiment, when the user condition information associated with the canceled order details is received for the reorder, the order detail receiver 142 determines whether the user's condition can change for each condition element in the user condition information. The order detail receiver 142 is an example of validity days obtaining means and request information presentation control means. When the user's condition can change for some condition elements, the order detail receiver 142 causes the purchaser terminal 3 to display information requesting reentry of the user' s condition for each of the relevant condition elements, based on the number of days elapsed since the received date and time of the canceled order details. Specifically, if the number of elapsed days is equal to or less than the number of days of validity period, the order detail receiver 142 causes the information requesting the reentry not to be presented. If the number of elapsed days exceeds the number of days of validity period, the order detail receiver 142 causes the information requesting the reentry to be presented. The number of days of the validity period is defined, for example, for each condition element classification or for each condition element type. Alternatively, the number of days of the validity period may be defined for each condition element. Alternatively, the number of days of the validity period, for example, may be predetermined in the information processing system, or be defined for each designated medicine or for each store. The number of days of the validity period may be defined based on the possibility that the user's condition remains the same as when the canceled order details were received. For example, the validity period may be longer for the condition element that usually remains the same for a longer period of time. The process described above can reduce the time and effort required to reenter user condition information when reordering and prevent the entry of wrong user condition information.

For example, the order detail receiver 142 may determine that the user's gender does not change. For example, the user's symptoms and pregnancy status can change. For example, the condition that the user has used the item ordered and the condition that the user has experienced a side effect will not change in the future. On the other hand, the condition that the user who has not used the item ordered and the condition that the user who has not experienced any side effect can change in the future. For example, the condition that the user is aged 65 or over will not change in the future, whereas the condition that the user is under 15 can change.

FIG. 39 is a diagram showing a display example of the reorder detail confirmation page. In FIG. 39, the same components as those shown in FIG. 35 are denoted by the same reference signs. As shown in FIG. 39, the reorder detail confirmation page displays the order detail display area 271, the user condition information display area 272, the order detail edit button 273, the user condition information edit button 274, the determination button 275, and a user condition information reentry area 276. In this embodiment, the user condition information display area 272 shows the unchanged conditions and the conditions within the validity period(s), which are included in the user condition information associated with the canceled order details. The user condition information reentry area 276 shows the questions about the conditions, which are included in the user condition information associated with the canceled order details, beyond the validity period(s) and the corresponding selection menus 277. The user condition information reentry area 276 also shows a message requesting reentry of user condition information shown in the user condition information reentry area 276. The selection menu 277 is a pull-down menu for selecting an answer to the corresponding question. The purchaser selects the user's condition by operating the selection menu 277. When the purchaser selects the determination button 275, the purchaser terminal 3 sends, to the online shopping mall server 1, the user condition information reflecting answers, selected from the selection menus 277, to the questions shown in the user condition information reentry area 276.

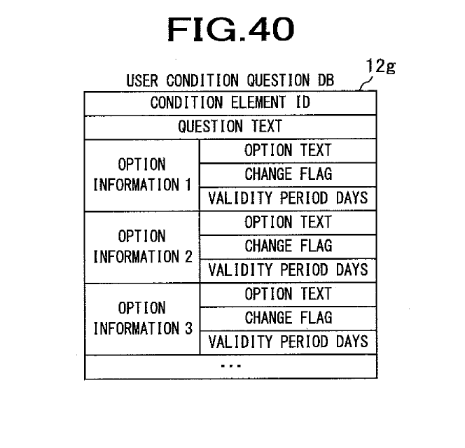

To determine, for each condition element, whether the user's condition can change and whether the validity period expires, for example, the online shopping mall server 1 has a user condition question DB 12g created in the storage unit 12. FIG. 40 is a diagram showing an example of information stored in the user condition question DB 12g. The user condition question DB 12g stores, for example, questions about the condition of a user, options for answer to each question, and validity periods for each question. Specifically, the user condition question DB 12g stores a condition element ID, a question text, and multiple pieces of option information in association with each condition element included in user condition information. The condition element ID is identification information of the condition element in the user condition information. Each option information includes a text of an option for answer, a change flag, and the number of days of a validity period. The change flag indicates whether the condition indicated by the text of the option can change. The number of days of the validity period is the number of days for which the condition indicated by the text of the option is valid. For example, the administrator of the online shopping mall server 1 may enter this information into the user condition question DB 12g. When the store prepares questions about user condition information, the online shopping mall server 1 sends a question preparation page to the store terminal 2, for example, in response to a request from the store terminal 2. The question preparation page enables the store employee to select a question from among the questions indicated by the texts stored in the user condition question DB 12g and to select a plurality of answerable options from among the options indicated by the texts stored in the user condition question DB 12g. The store terminal 2 sends the selected contents as condition question information to the online shopping mall server 1, and the online shopping mall server 1 stores the condition question information in the item DB 12c.

The order detail receiver 142 may determine whether the condition that can change has changed to a certain condition between the receipt of the canceled order details and the reorder. If the order detail receiver 142 determines that the user's condition has changed to the certain condition, the order detail receiver 142 may modify the user condition information to reflect the certain condition. In this case, the order detail receiver 142 causes the information requesting reentry of the user's condition not to be displayed. On the other hand, if the order detail receiver 142 determines that the user's condition has not necessarily changed to the certain condition, the order detail receiver 142 causes the information requesting reentry of the user's condition to be presented. For example, assume that the user's condition at the time of receiving the canceled order was the condition that “Your due date is less than 12 weeks away: YES”. Thus, if the 12 weeks has passed at the time of receiving the order details regarding the reorder, the user has already given a birth. In this case, the order detail receiver 142 changes this condition to “Your due date is less than 12 weeks away: NO”. Moreover, the order detail receiver 142 causes the question asking if the due date less than 12 weeks away not to be displayed. On the other hand, if the 12 weeks has not passed at the time of receiving the order details regarding the reorder, the user may or may not have given a birth. Thus, the order detail receiver 142 causes the information requesting the reentry to be presented.

### 7-2. Operation of System Controller

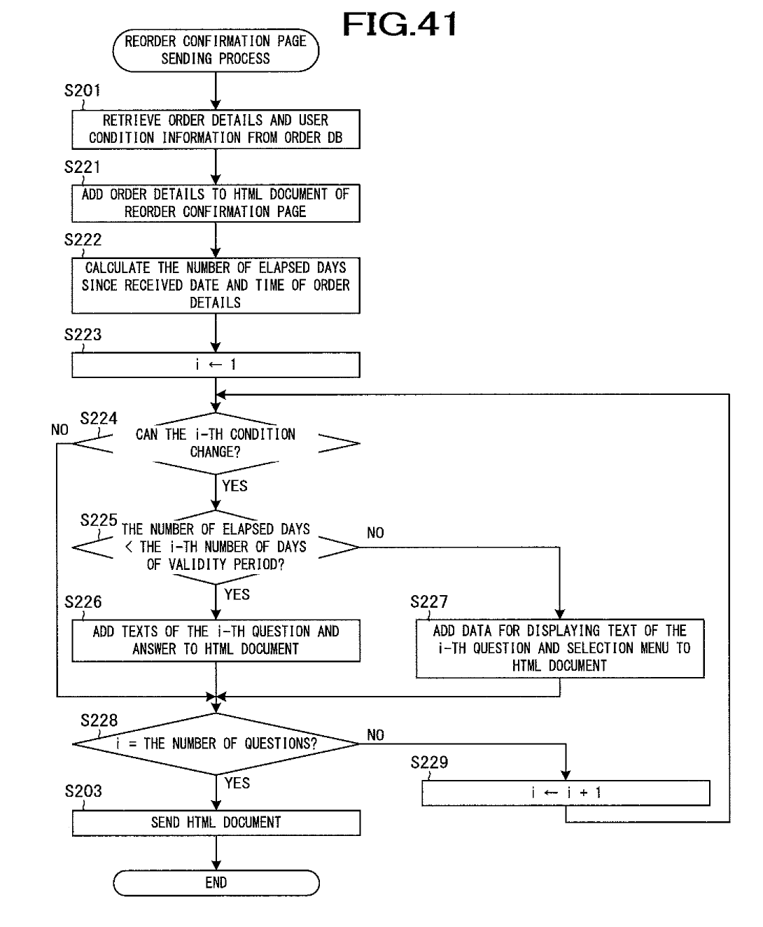

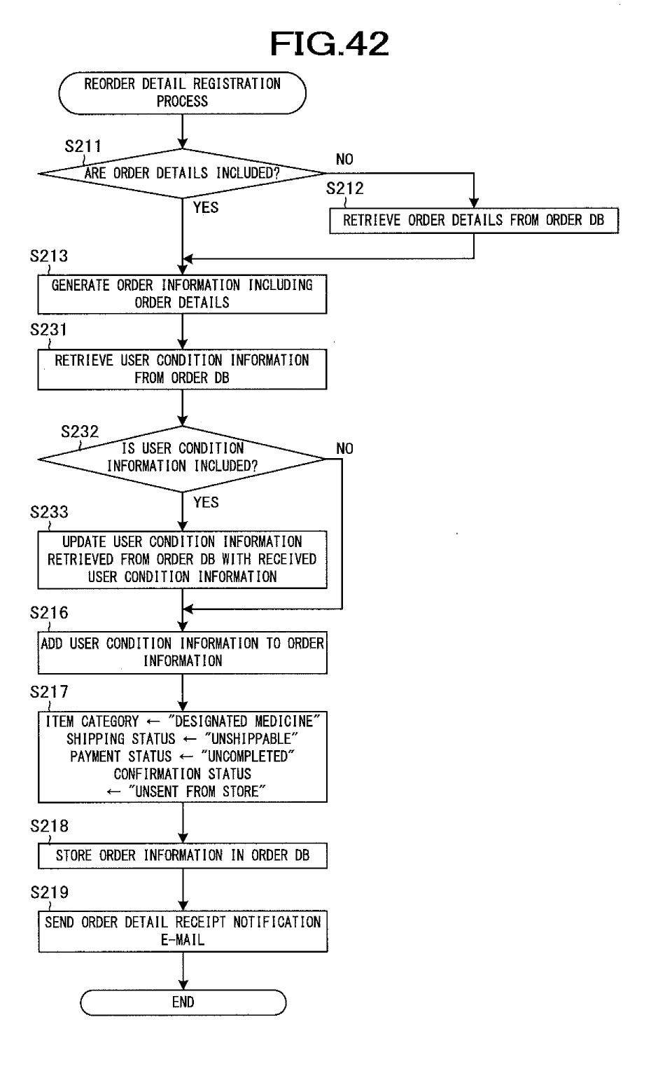

The following describes a specific operation of the system controller 14 of the online shopping mall server 1 with reference to FIGS. 41 and 42. FIG. 41 is a flowchart showing an example of the reorder confirmation page sending process in the system controller 14 of the online shopping mall server 1 according to this embodiment. In FIG. 41, the same components as those shown in FIG. 37 are denoted by the same reference signs. As shown in FIG. 41, the order detail receiver 142 retrieves the order details and the user condition information corresponding to the order number included in the reorder confirmation request, from the order DB 12e (Step S201). Subsequently, the order detail receiver 142 adds the retrieved order details to the HTML document of the reorder confirmation page (Step S221). Then, the order detail receiver 142 retrieves the received date and time corresponding to the order number included in the reorder confirmation request, from the order DB 12e. Next, the order detail receiver 142 subtracts the received date and time from the current date and time to calculate the number of elapsed days (Step S222). After that, the order detail receiver 142 sets a variable i to 1 (Step S223).

Subsequently, the order detail receiver 142 determines whether the i-th condition in the retrieved user condition information can change (Step S224). Specifically, the order detail receiver 142 searches the user condition question DB 12g for questions that matches the i-th question in the user condition information, and searches the user condition question DB 12g for the option that matches the i-th answer in the user condition information, among the options associated with the retrieved question. Then, the order detail receiver 142 obtains the change flag and the number of days of the validity period corresponding to the retrieved option. If the change flag is FALSE, the order detail receiver 142 determines that the i-th condition cannot change (NO in Step S224). In this case, the process proceeds to Step S228. On the other hand, if the change flag is TRUE, the order detail receiver 142 determines that the i-th condition can change (YES in Step S224). In this case, the process proceeds to Step S225.

In Step S225, the order detail receiver 142 determines whether the number of elapsed days is less than the number of days of the validity period. If the order detail receiver 142 determines that the number of elapsed days is less than the number of days of the validity period here (YES in Step S225), the process proceeds to Step S226. In Step S226, the order detail receiver 142 adds the texts of the i-th question and answer in the user condition information to the user condition information display area 272 of the HTML document of the reorder confirmation page. Then, the process proceeds to Step S228. On the other hand, if the order detail receiver 142 determines that the number of elapsed days is equal to or greater than the number of days of the validity period (NO in Step S225), the process proceeds to Step S227. In Step S227, the order detail receiver 142 adds the text of the i-th question in the user condition information and the data for displaying the selection menu 277 to the user condition information reentry area 276 of the HTML document of the reorder confirmation page. At this time, the order detail receiver 142 retrieves, from the order DB 12e, the store ID and the item ID corresponding to the order number included in the reorder confirmation request, and retrieves the condition question information corresponding to the store ID and the item ID from the item DB 12c. The order detail receiver 142 then adds data based on the condition question information. Then, the process proceeds to Step S228.

In Step S228, the order detail receiver 142 determines whether the variable i is equal to the number of the questions included in the user condition information. If the order detail receiver 142 determines that the variable i is not equal to the number of the questions here (NO in Step S228), the process proceeds to Step S229. In Step S229, the order detail receiver 142 adds 1 to the variable i, and the process proceeds to Step S224. On the other hand, if the order detail receiver 142 determines that the variable i is equal to the number of the questions (YES in Step S228), the process proceeds to Step S203. In Step S203, the order detail receiver 142 sends the HTML document of the reorder confirmation page to the purchaser terminal 3, and terminates the reorder confirmation page sending process.

FIG. 42 is a flowchart showing an example of the reorder detail registration process in the system controller 14 of the online shopping mall server 1 according to this embodiment. In FIG. 42, the same components as those shown in FIG. 38 are denoted by the same reference signs. As shown in FIG. 38, the order detail receiver 142 performs Steps S211 to S213. Subsequently, the order detail receiver 142 retrieves the user condition information corresponding to the order number included in the reorder detail determination request, from the order DB 12e (Step S231). Then, the user condition information receiver 141 determines whether the reorder detail determination request includes the user condition information (Step S232). If the user condition information receiver 141 determines that the reorder detail determination request includes the user condition information here (YES in Step S232), the process proceeds to Step S233. In Step S233, the user condition information receiver 141 updates the user condition information retrieved from the order DB 12e with the user condition information included in the reorder detail determination request. Specifically, the user condition information receiver 141 searches the user condition information retrieved from the order DB 12e for the question that matches the question included in the user condition information included in the reorder detail determination request. Then, the user condition information receiver 141 overwrites the answer corresponding to the retrieved question with the answer included in the user condition information included in the reorder detail determination request. The user condition information receiver 141 performs such a process for each question included in the user condition information included in the reorder detail determination request. Next, the process proceeds to Step S216. On the other hand, if the user condition information receiver 141 determines that the reorder detail determination request does not include the user condition information (NO in Step S232), the process proceeds to Step S216.

In Step S216, the user condition information receiver 141 adds the user condition information retrieved from the order DB 12e or the user condition information updated in Step S233 to the order information. After that, the order detail receiver 142 performs Steps S217 to S219.

As described above, according to this embodiment, when the user condition information associated with the canceled order details can change, the system controller 14 obtains the number of days of the validity period for this user condition information. When the number of days elapsed between the receipt of the canceled order details and the operation of the reorder button 254 exceeds the number of days of the validity period, the system controller 14 causes the user condition information reentry area 276 to be displayed on the reorder detail confirmation page. Consequently, this embodiment can save the purchaser the time and effort of reentering the user condition information, while preventing the wrong user condition information from being stored.

According to this exemplary non-limiting embodiment, by only preforming the processing related to and necessary for reentry of user condition information that has expired (i.e., exceeded the validity period, etc.) the processing load on the computer processor would be reduced. As such, there is an advantageous improvement to the controller 14 (i.e., computer) since the processing load on the controller 14 is reduced.

### 8. Eighth Embodiment

### 8-1. Functional Overview of System Controller

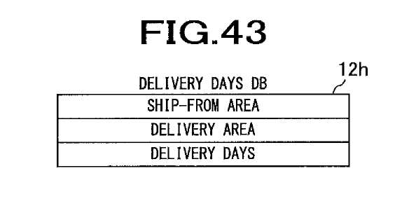

The following describes functions of the system controller 14 according to an eighth embodiment with reference to FIG. 43. Except for points described below, the eighth embodiment is basically the same as the fifth embodiment to the seventh embodiment. As described in the fifth embodiment, unless the purchaser confirms the considerations before the confirmation period has passed, the cancellation unit 147 cancels receipt of the order details. In the fifth embodiment, the number of days of the confirmation period is predetermined. In this embodiment, when the delivery time (delivery date, or delivery date and time) for the item ordered has been specified by the purchaser, the cancellation unit 147 sets the confirmation period so that the item order can be delivered by the specified delivery time. The cancellation unit 147 is an example of shipping deadline obtaining means and confirmation deadline determination means. When the delivery time for the item ordered has been specified by the purchaser, the store have to ship the item ordered so that it will be delivered by the delivery time. The latest shipping time (shipping date, or shipping date and time) the item ordered can be delivered by the delivery time is referred to as the shipping deadline. Thus, the purchaser have to confirm the considerations before the store ships the item ordered, by the shipping deadline at the latest. The confirmation time (confirmation date, or confirmation date and time) for the considerations the item ordered can be delivered by the delivery time is referred to as the confirmation deadline. The cancellation unit 147 may set the confirmation deadline, for example, based on the shipping deadline. For example, the cancellation unit 147 may determine the shipping deadline as the confirmation deadline, or determine one or two days before the shipping deadline as the confirmation deadline.

To set the confirmation deadline, for example, the online shopping mall server 1 has a delivery days DB 12h created in the storage unit 12. FIG. 43 shows an example of information stored in the delivery days DB 12h. The delivery days DB 12h stores the number of days required to deliver an item. Specifically, the delivery days DB 12h stores a ship-from area, a delivery area, and the number of delivery days in association with each combination of the ship-from area and the delivery area. The ship-from area is the area from which the item is shipped. The delivery area is the area to which the item is delivered. The ship-from area and the delivery area may each be, for example, one of the 47 prefectures of Japan. The number of delivery days indicates the number of days required to deliver the item from the ship-from area to the delivery area. For example, the administrator of the online shopping mall server 1 may set the number of delivery days. Alternatively, for example, the online shopping mall server 1 may set the number of delivery days based on past results. For example, each store enters actual shipping dates and delivery dates, and the online shopping mall server 1 may calculate the numbers of delivery days based on the shipping dates and the corresponding delivery dates and determine the numbers of delivery days to be stored in the delivery days DB 12h based on these numbers of the delivery days. Alternatively, the online shopping mall server 1 may obtain the date of receiving an item from a store and the date for delivering the item in the past from the delivery management server 7 for each combination of the ship-from area and the delivery area, and determine the numbers of delivery days to be stored in the delivery days DB 12h.

### 8-2. Operation of System Controller

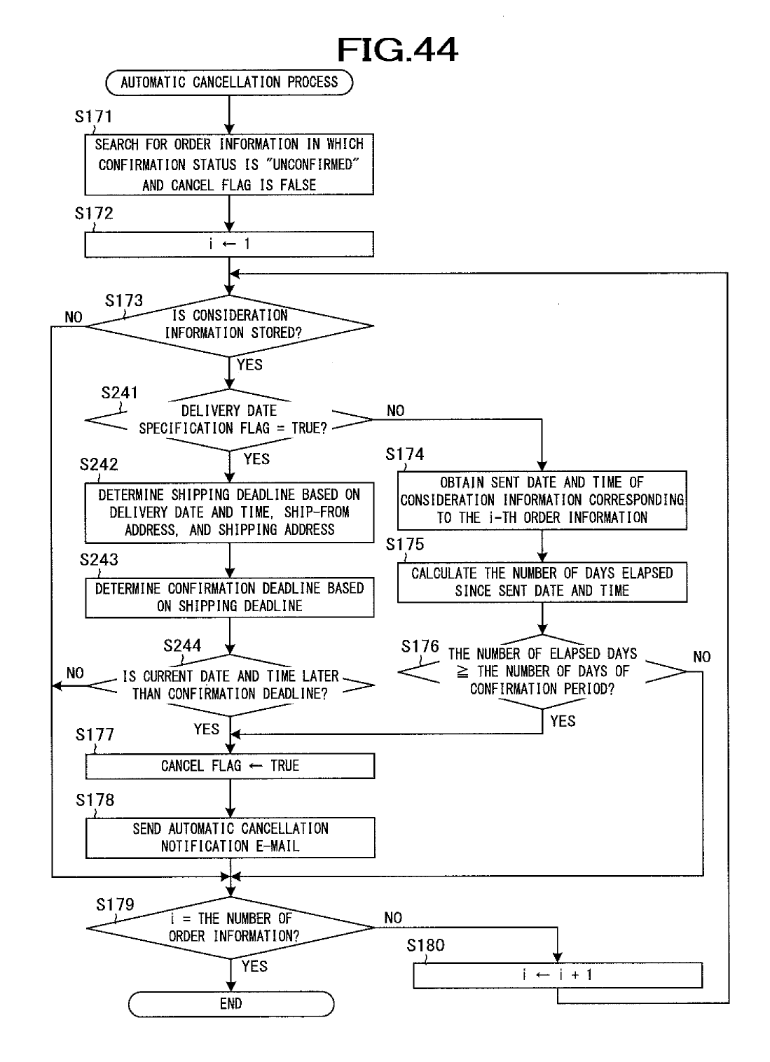

The following describes a specific operation of the system controller 14 of the online shopping mall server 1 with reference to FIG. 44. FIG. 44 is a flowchart showing an example of the automatic cancellation process in the system controller 14 of the online shopping mall server 1 according to this embodiment. In FIG. 44, the same steps as those shown in FIG. 33 are denoted by the same reference signs. As shown in FIG. 44, the cancellation unit 147 performs Steps S171 to S173. In Step S173, if the cancellation unit 147 determines that the consideration information is not stored (NO in Step S173), the process proceeds to Step S179. On the other hand, if the cancellation unit 147 determines that the consideration information is stored (YES in Step S173), the process proceeds to Step S241.

In Step S241, the cancellation unit 147 determines whether the delivery date specification flag included in the i-th order information is TRUE. If the cancellation unit 147 determines that the delivery date specification flag is not TRUE here (NO in Step S241), the process proceeds to Step S174. The cancellation unit 147 then performs Steps S174 to S176, and the process proceeds to Step S177 or Step S179 based on the determination result in Step S176. On the other hand, if the cancellation unit 147 determines that the delivery date specification flag is TRUE (YES in Step S241), the process proceeds to Step S242.

In Step S242, the cancellation unit 147 determines the shipping deadline. Specifically, the cancellation unit 147 obtains the store ID and the user ID from the i-th order information. Subsequently, the cancellation unit 147 retrieves the address corresponding to the store ID from the store DB 12b, and identifies the ship-from area corresponding to this address. The cancellation unit 147 also retrieves the address corresponding to the user ID from the member DB 12a, and identifies the delivery area corresponding to this address. Then, the cancellation unit 147 retrieves the number of delivery days corresponding to the combination of the ship-from area and the delivery area from the delivery days DB 12h. Next, the cancellation unit 147 subtracts the number of delivery days from the specified delivery date and time included in the i-th order information to calculate the shipping deadline.

Subsequently, the cancellation unit 147 determines the confirmation deadline based on the shipping deadline (Step S243). For example, the cancellation unit 147 may determine the shipping deadline as the confirmation deadline. Alternatively, for example, the cancellation unit 147 may subtract the number of days prestored in the storage unit 12 from the shipping deadline to calculate the confirmation deadline. The number of days stored in the storage unit 12 may be, for example, 0 or more. Then, the cancellation unit 147 determines whether the current date and time is later than the confirmation deadline (Step S244). If the cancellation unit 147 determines that the current date and time is later than the confirmation deadline here (YES in Step S244), the process proceeds to Step S177. The cancellation unit 147 sets the cancel flag to TRUE (Step S177), and sends the automatic cancellation notification e-mail (Step S178). Then the process proceeds to S179. On the other hand, if the cancellation unit 147 determines that the current date and time is not later than the confirmation deadline (NO in Step S244), the process proceeds to Step S179. The cancellation unit 147 performs Steps S179 to S180.

The cancellation unit 147, for example, may determine the confirmation deadline in the order detail registration process shown in FIG. 16, and put the confirmation deadline in the order information. Then, the cancellation unit 147 may obtain the confirmation deadline from the order information and determine the confirmation deadline in the automatic cancellation process.

As described above, according to this embodiment, when the order details received from the purchaser include a specified delivery date, the system controller 14 obtains the shipping deadline to deliver the item on the delivery date. The system controller 14 also determines the confirmation deadline for the consideration information based on the shipping deadline. When the system controller 14 has not received the purchaser message by the determined confirmation deadline, the system controller 14 cancels receipt of the order details. Thus, the confirmation period for the consideration information can be set properly.

### 9. Ninth Embodiment

### 9-1. Functional Overview of System Controller

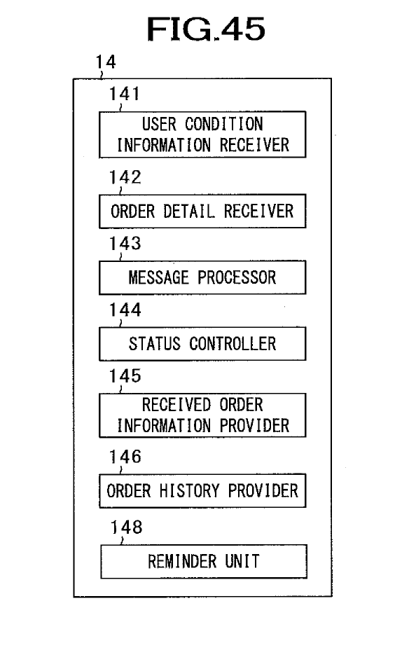

The following describes functions of the system controller 14 according to a ninth embodiment with reference to FIG. 45. Except for points described below, the ninth embodiment is basically the same as the first embodiment to the eighth embodiment. FIG. 45 is a diagram showing an example of functional blocks of the system controller 14 of the online shopping mall server 1 according to this embodiment. In FIG. 45, the same components as those shown in FIG. 3B are denoted by the same reference signs. As shown in FIG. 45, the system controller 14 functions as the user condition information receiver 141, the order detail receiver 142, the message processor 143, the status controller 144, the received order information provider 145, the order history provider 146, a reminder unit 148, and other units. The reminder unit 148 is an example of count obtaining means and time interval determination means.

When the purchaser message indicating that he/she has confirmed the consideration information has not been received after the store message registration notification e-mail notifying the purchaser that the consideration information was stored, the reminder unit 148 outputs information prompting the purchaser to confirm the consideration information. Specifically, the reminder unit 148 sends a consideration information confirmation reminder e-mail to the purchaser as such information. The reminder e-mail is an example of reminder information.

In particular, in this embodiment, the reminder unit 148 sends the consideration information confirmation reminder e-mail at predetermined time intervals. Moreover, the reminder unit 148 determines the time interval to send the consideration information confirmation reminder e-mails, based on the number of reminder e-mails sent between the storage of the store message registration notification e-mail and the receipt of the purchaser message indicating that the consideration information has been confirmed. The number of consideration information confirmation reminder e-mails sent before the purchaser message has been received is referred to as the number of reminders. A time interval to send the consideration information confirmation reminder e-mails is referred to as a reminder time interval. A default value of the reminder time interval is, for example, may be preset by the administrator of the online shopping mall server 1. For example, the default value may be a predetermined time or a predetermined number of days.

For example, assume that the default value is one day. When the purchaser confirms the consideration information after the consideration information confirmation reminder e-mail was sent three times, the first and second consideration information confirmation reminder e-mails might have been unnecessary. Thus, the reminder unit 148 changes the reminder time interval to, for example, three days. On the other hand, the reminder time interval may be shortened. Thus, the reminder unit 148 determines the reminder time interval so as to reflect when the purchaser will probably confirm the consideration information in response to the consideration information confirmation reminder e-mail. This can reduce unnecessary sending processes performed by the reminder unit 148 or enhance sending efficiency.

For the reminder unit 148 to determine when to send the consideration information confirmation reminder e-mail, the member DB 12a, for example, further stores the current reminder time interval for each purchaser. At first, the reminder time interval is set to the default value. The order DB 12e, for example, further stores the next reminder date and time, and the number of reminders. The next reminder date and time indicates the date and time at which the next consideration information confirmation reminder e-mail will be sent.

### 9-2. Operation of System Controller

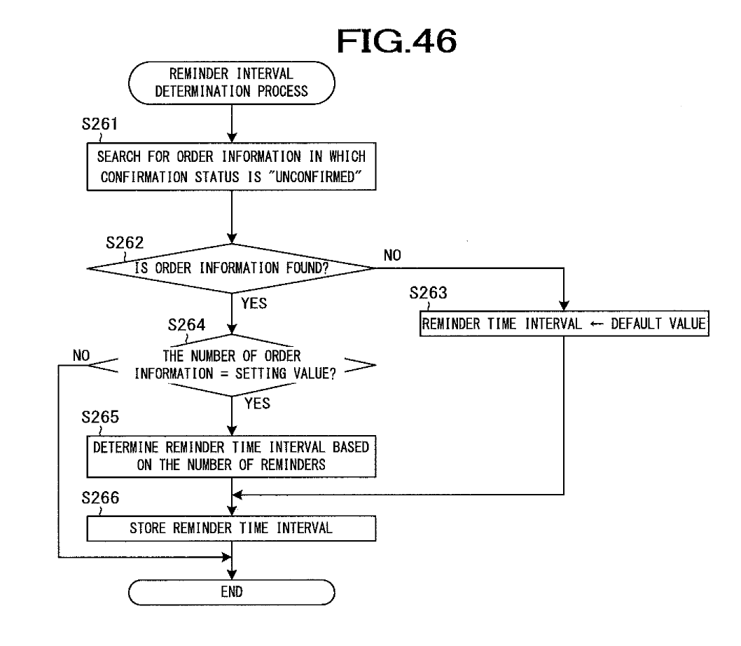

The following describes a specific operation of the system controller 14 of the online shopping mall server 1 with reference to FIGS. 46 to 48. FIG. 46 is a flowchart showing an example of a reminder interval determination process in the system controller 14 of the online shopping mall server 1 according to this embodiment. For example, when the confirmation status has been set to “confirmed” in the purchaser message registration process shown in FIG. 20, the system controller 14 may perform the reminder interval determination process. As shown in FIG. 46, the reminder unit 148 obtains the user ID from the order information in which the confirmation status is set to “confirmed”. The reminder unit 148 then searches the order DB 12e for order information in which the item category is “designated medicine” and the confirmation status is “confirmed”, among the order information corresponding to the obtained user ID (Step S261). Subsequently, the reminder unit 148 determines whether such order information is found (Step S262). If the reminder unit 148 determines that the order information is not found here (NO in Step 5262), the process proceeds to Step S263. In Step S263, the reminder unit 148 sets the reminder time interval to the default value, and the process proceeds to Step S266. On the other hand, if the reminder unit 148 determines that the order information is found (YES in Step S262), the process proceeds to Step S264.

In Step S264, the reminder unit 148 determines whether the number of found order information is equal to the setting value prestored in the storage unit 12. If the reminder unit 148 determines that the number of the order information is not equal to the setting value here (NO in Step S264), the reminder unit 148 terminates the reminder interval determination process. On the other hand, if the reminder unit 148 determines that the number of the order information is equal to the setting value (YES in Step S264), the process proceeds to Step S265. In Step S265, the reminder unit 148 obtains the number of past reminders from each piece of the found order information. The reminder unit 148 then determines the reminder time interval based on the numbers of past reminders. For example, the reminder unit 148 may multiply a representative value, such as the maximum value or the average value, of the numbers of past reminders by the default value to calculate the reminder time interval. When the representative value is 0 here, the reminder unit 148 may, for example, keep the reminder time interval the default value or make the reminder time interval shorter than the default value. After the reminder unit 148 finishes Step S265, the process proceeds to Step S266. In Step S266, the reminder unit 148 stores the set reminder time interval in association with the obtained user ID in the member DB 12a. After Step S266, the reminder unit 148 terminates the reminder interval determination process.

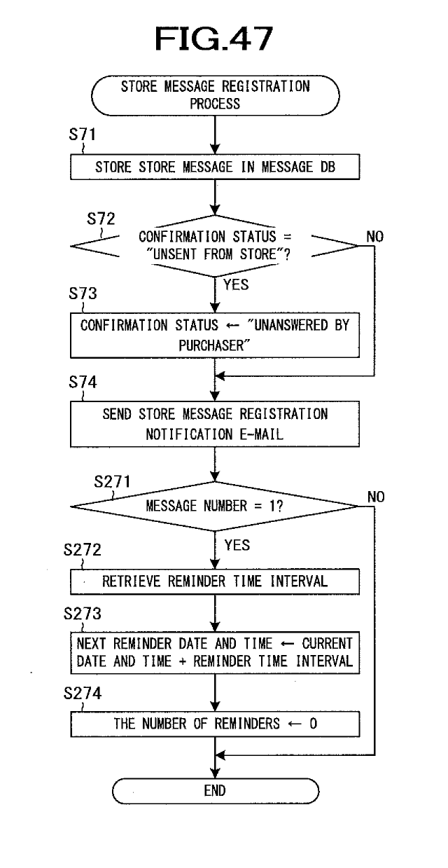

FIG. 47 is a flowchart showing an example of the store message registration process in the system controller 14 of the online shopping mall server 1 according to this embodiment. In FIG. 47, the same steps as those shown in FIG. 18 are denoted by the same reference signs. As shown in FIG. 47, the message processor 143 performs Steps S71 to S74. Subsequently, the reminder unit 148 determines whether the message number set this time is equal to 1 (Step S271). That is, the reminder unit 148 determines whether the consideration information is stored this time. If the reminder unit 148 determines that the message number is not equal to 1 here (NO in Step S271), the reminder unit 148 terminates the store message registration process. On the other hand, if the reminder unit 148 determines that the message number is equal to 1 (YES in Step S271), the process proceeds to Step S272. In Step S272, the reminder unit 148 retrieves the user ID corresponding to the order number received from the store terminal 2, from the order DB 12e. The reminder unit 148 then retrieves the reminder time interval corresponding to the user ID from the member DB 12a. Next, the reminder unit 148 adds the reminder time interval to the current date and time to calculate the next reminder date and time (Step S273). After that, the reminder unit 148 stores the next reminder date and time in association with the received order number in the order DB 12e. The reminder unit 148 also stores the number of reminders set to 0 in association with the order number in the order DB 12e (Step S274). After Step S274, the reminder unit 148 terminates the store message registration process.

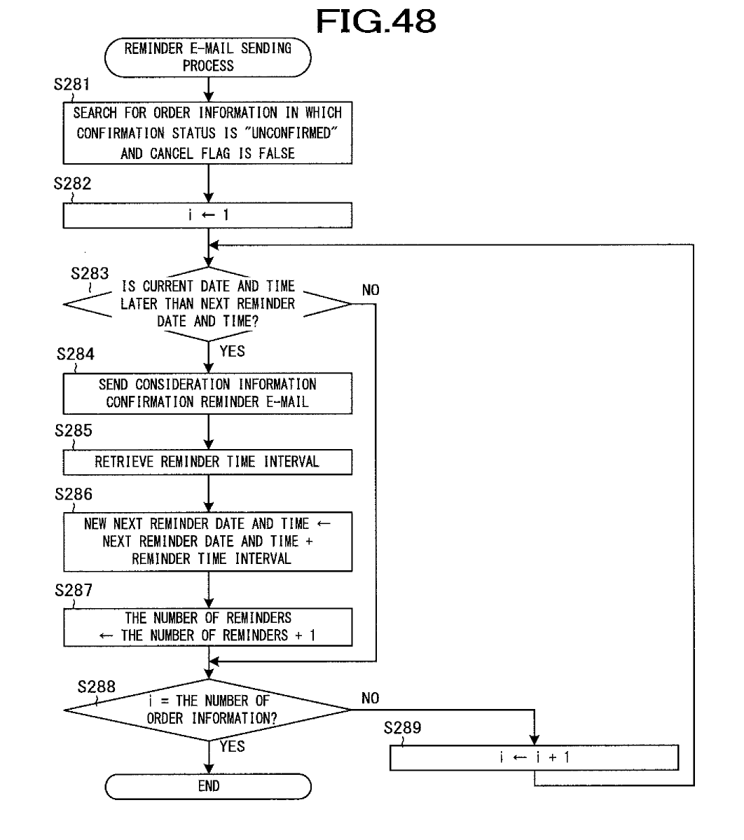

FIG. 48 is a flowchart showing an example of a reminder e-mail sending process in the system controller 14 of the online shopping mall server 1 according to this embodiment. For example, the system controller 14 performs the reminder e-mail sending process regularly. For example, the system controller 14 may performs the reminder e-mail sending process at predetermined intervals.

As shown in FIG. 48, the reminder unit 148 searches the order DB 12e for order information in which the item category is “designated medicine”, the confirmation status is “unconfirmed”, and the cancel flag is FALSE (Step S281). Subsequently, the reminder unit 148 sets a variable i to 1 (Step S282). Next, the reminder unit 148 obtains the next reminder date and time from the i-th order information among the retrieved order information. The reminder unit 148 then determines whether the current date and time is later than the next reminder date and time (Step S283). If the reminder unit 148 determines that the current date and time is not later than the next reminder date and time here (NO in Step S283), the process proceeds to Step S288. On the other hand, if the reminder unit 148 determines that the current date and time is later than the next reminder date and time (YES in Step S283), the process proceeds to Step S284.

In Step S284, the reminder unit 148 sends the consideration information confirmation reminder e-mail. Specifically, the reminder unit 148 retrieves the e-mail address corresponding to the user ID included in the i-th order information from the member DB 12a. The reminder unit 148 then generates the consideration information confirmation reminder e-mail storing the retrieved e-mail address in its destination address. The reminder unit 148 also adds the order number, the item name, and other information to the body of the consideration information confirmation reminder e-mail, based on the i-th order information. After that, the reminder unit 148 sends the generated consideration information confirmation reminder e-mail.

Subsequently, the reminder unit 148 retrieves the reminder time interval corresponding to the user ID included in the i-th order information from the member DB 12a (Step S285). Next, the reminder unit 148 adds the retrieved reminder time interval to the next reminder date and time to calculate a new next reminder date and time. The reminder unit 148 then updates the next reminder date and time included in the i-th order information with the new next reminder date and time (Step S286). Subsequently, the reminder unit 148 adds 1 to the number of reminders included in the i-th order information to calculate a new number of reminders. The reminder unit 148 then updates the number of reminders included in the i-th order information with the new number of reminders (Step S287). Next, the process proceeds to Step S288.

In Step S288, the reminder unit 148 determines whether the variable i is equal to the number of the retrieved order information. If the reminder unit 148 determines that the variable i is not equal to the number of the order information (NO in Step S288), the process proceeds to Step 5289. In Step 5289, the reminder unit 148 adds 1 to the variable i, and the process proceeds to Step S283. On the other hand, if the reminder unit 148 determines that the variable i is equal to the number of the order information (YES in Step S288), the reminder unit 148 terminates the reminder e-mail sending process.

In the reminder interval determination process shown in FIG. 46, the reminder unit 148 determines the reminder time interval only when the number of orders for which the purchaser has confirmed the consideration information is equal to the setting value, that is, only once. However, regardless of the number of orders for which the purchaser has confirmed the consideration information, the reminder unit 148 may determine the reminder time interval for each of the orders, for example. In this case, the reminder unit 148 have to determine a new reminder time interval using not only the number of past reminders but also the reminder time interval at that time. The reason is that the reminder time interval at that time may be different from the default value. Specifically, in the store message registration process shown in FIG. 47, the reminder unit 148 stores the reminder time interval retrieved from the member DB 12a (Step S272) in the order information. In the reminder interval determination process shown in FIG. 46, reminder unit 148 multiplies, for each piece of the found order information, the number of its past reminders by the reminder time interval at that time to calculate a time during which the consideration information was unconfirmed. Then, the reminder unit 148 may determine, for example, a representative value, such as the maximum value or the average value, of the times during which the consideration information was unconfirmed, as the reminder time interval.

As described above, according to this embodiment, the system controller 14 obtains the number of consideration information confirmation reminder e-mails output between the output of the store message registration notification e-mail and the receipt of the purchaser message. The system controller 14 then determines the time interval to output the consideration information confirmation reminder e-mails, based on the obtained number. Thus, the consideration information confirmation reminder e-mail can be efficiently output.

### 10. Tenth Embodiment

### 10-1. Functional Overview of System Controller

The following describes functions of the system controller 14 according to a tenth embodiment. Except for points described below, the tenth embodiment is basically the same as the ninth embodiment. In this embodiment, the reminder unit 148 determines the time interval to send the consideration information confirmation reminder e-mails, based on the time of receiving the purchaser message indicating that the consideration information has been confirmed. The reminder unit 148 is an example of time obtaining means. For example, the reminder unit 148 identifies a time period during which the purchaser tends to confirm the consideration information confirmation reminder e-mail, and sends the consideration information confirmation reminder e-mail before the time period. This can increase the probability that the purchaser will confirm the consideration information. For example, the length of the time period is preset. The member DB 12a further stores a reminder time for each purchaser. The reminder time is the time at which the consideration information confirmation reminder e-mail is sent.

### 10-2. Operation of System Controller

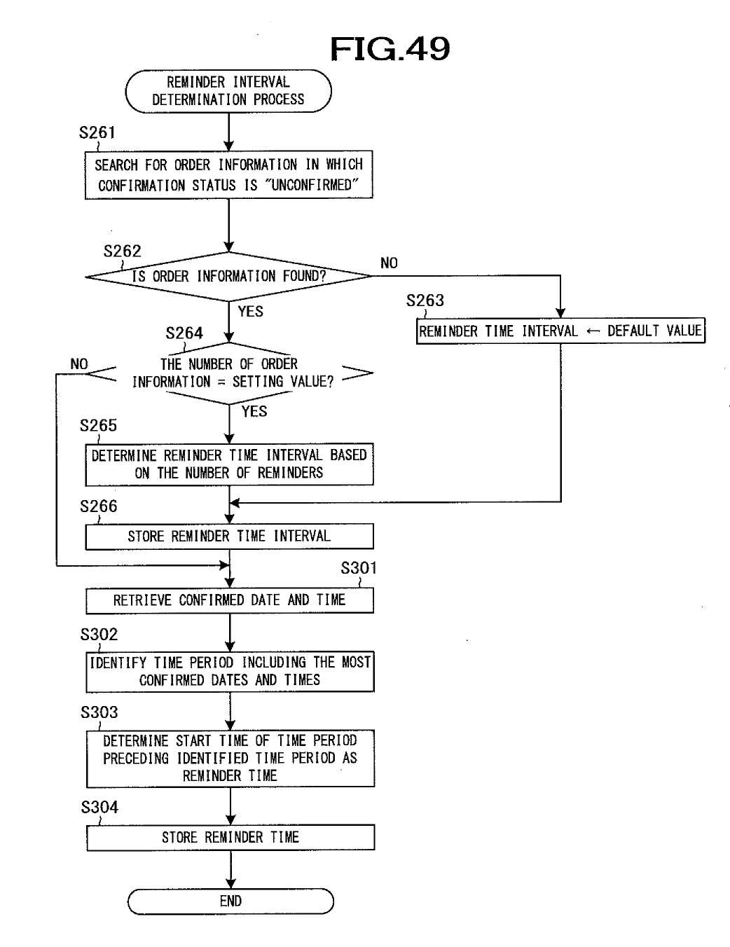

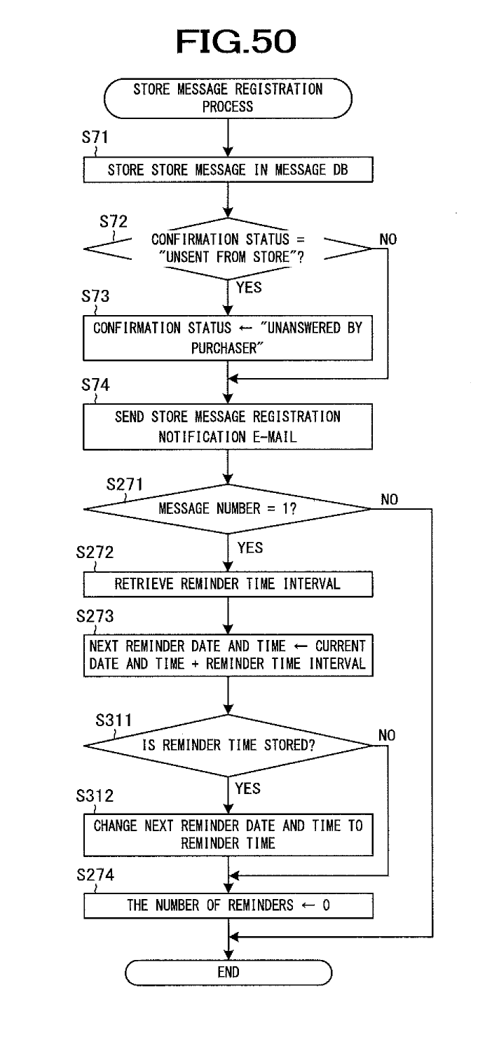

The following describes a specific operation of the system controller 14 of the online shopping mall server 1 with reference to FIGS. 49 and 50. FIG. 49 is a flowchart showing an example of the reminder interval determination process in the system controller 14 of the online shopping mall server 1 according to this embodiment. In FIG. 49, the same steps as those shown in FIG. 46 are denoted by the same reference signs. As shown in FIG. 49, the reminder unit 148 performs Steps S261 to S266. Subsequently, the reminder unit 148 obtains the order number from each piece of the found order information. Then the reminder unit 148 retrieves, for each of the obtained order numbers, the latest purchaser sent date and time of the purchaser sent dates and times corresponding to the order number as a confirmed date and time, from the message DB 12f (Step S301). Next, the reminder unit 148 identifies the time period including the most confirmed dates and times from among a plurality of time periods, into which a day is divided (Step S302). Subsequently, the reminder unit 148 determines the start time of the time period preceding the identified time period as the reminder time (Step S303). Then, the reminder unit 148 stores the reminder time in association with the user ID obtained from the order information in which the confirmation status is “confirmed”, in member DB 12a (Step S304). After Step S304, the reminder unit 148 terminates the reminder interval determination process.

FIG. 50 is a flowchart showing an example of the store message registration process in the system controller 14 of the online shopping mall server 1 according to this embodiment. In FIG. 50, the same steps as those shown in FIG. 47 are denoted by the same reference signs. As shown in FIG. 50, the message processor 143 performs Steps S71 to S74, and the reminder unit 148 performs Steps S271 to S273. Subsequently, the reminder unit 148 identifies, from the member DB 12a, the member information corresponding to the user ID retrieved from the order DB 12e, and determines whether the reminder time is stored in the member information (Step S311). If the reminder unit 148 determines that the reminder time is stored here (YES in Step S311), the process proceeds to Step S312. In Step S312, the reminder unit 148 changes the time included in the calculated next reminder date and time to the reminder time. The reminder unit 148 then stores the changed next reminder date and time in association with the received order number in the order DB 12e. Next, the process proceeds to Step S274.

The reminder unit 148 may not send the consideration information confirmation reminder e-mail at the reminder time intervals. For example, the reminder unit 148 may send the consideration information confirmation reminder e-mail, for example, a predetermined number of days after the store message registration notification e-mail notifying that the consideration information had been stored was sent, a predetermined number of days before the order details will be automatically canceled, on a predetermined day of the week, or on a predetermined date. In this case, the reminder unit 148 only has to send the consideration information confirmation reminder e-mail at the determined reminder time.

As described above, according to this embodiment, the system controller 14 determines the time to output the consideration information confirmation reminder e-mail, based on the time of receiving the purchaser message. Thus, this embodiment can increase the probability that the purchaser will confirm the consideration information.

### 11. Eleventh Embodiment

### 11-1. Functional Overview of System Controller

The following describes functions of the system controller 14 according to an eleventh embodiment. Except for points described below, the eleventh embodiment is basically the same as the first embodiment to the eighth embodiment. In this embodiment, the system controller 14 functions as the user condition information receiver 141, the order detail receiver 142, the message processor 143, the status controller 144, the received order information provider 145, the order history provider 146, the reminder unit 148, and other units, as in the ninth embodiment. The reminder unit 148, however, determines when to send the consideration information confirmation reminder e-mail, in a manner different from that described in the ninth embodiment. The reminder unit 148 is an example of item quantity obtaining means.

Specifically, the reminder unit 148 determines, for each designated medicine, a reminder frequency indicating how frequently to send the consideration information confirmation reminder e-mail, based on the number of items ordered that have not yet been shipped. The number of items ordered that have not yet been shipped is referred to as the unshipped ordered item quantity. The more the unshipped ordered item quantity is, the higher the reminder unit 148 may set the reminder frequency. A higher reminder frequency can increase the probability that the purchaser will confirm the consideration information. After the purchaser confirms the consideration information and completes payment for an item, the store can ship the item. Thus, if the reminder unit 148 increases the reminder frequency, the store can reduce the unshipped ordered item quantity.

Alternatively, the reminder unit 148 may determine the reminder frequency, for example, based on the unshipped ordered item quantity and the stock quantity. For example, the higher the ratio of the unshipped ordered item quantity to the stock quantity is, the higher the reminder unit 148 sets the reminder frequency higher. This can prevent unshipped items ordered from consisting mostly of stocks.

### 11-2. Operation of System Controller

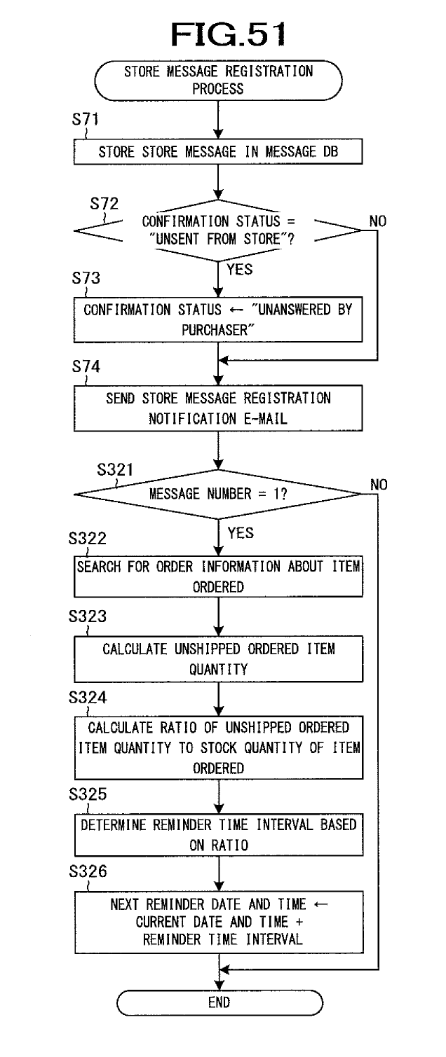

The following describes a specific operation of the system controller 14 of the online shopping mall server 1 with reference to FIG. 51. In the following example, the reminder frequency is represented by the reminder time interval. FIG. 51 is a flowchart showing an example of the store message registration process in the system controller 14 of the online shopping mall server 1 according to this embodiment. In FIG. 51, the same steps as those shown in FIG. 18 are denoted by the same reference signs. As shown in FIG. 51, the message processor 143 performs Steps S71 to S74. Subsequently, the reminder unit 148 determines whether the message number set this time is equal to 1 (Step S321). If the reminder unit 148 determines that the message number is not equal to 1 here (NO in Step 5321), the reminder unit 148 terminates the store message registration process. On the other hand, if the reminder unit 148 determines that the message number is equal to 1 (YES in Step S321), the process proceeds to Step S322.

In Step S322, the reminder unit 148 retrieves the store ID and the item ID corresponding to the order number received from the store terminal 2, from the order DB 12e. Then, the reminder unit 148 searches the order DB 12e for order information corresponding to the combination of the store ID and the item ID. Next, the reminder unit 148 extracts order information in which the shipping status is not “shipped” from the retrieved order information. Subsequently, the reminder unit 148 obtains the item quantity from each piece of the extracted order information. The reminder unit 148 then calculates the sum of the item quantities as the unshipped ordered item quantity (Step S323). Next, the reminder unit 148 retrieves the stock quantity corresponding to the store ID and the item ID from the item DB 12c. The reminder unit 148 then calculates the ratio of the unshipped ordered item quantity to the stock quantity (Step S324). Subsequently, the reminder unit 148 determines the reminder time interval based on the calculated ratio (Step S325). Specifically, the higher the ratio is, the shorter reminder unit 148 sets the reminder time interval. For example, the storage unit 12 may store a table storing a reminder time interval in association with each ratio. Then, the reminder unit 148 may determine the reminder time interval by referring to this table. Next, the reminder unit 148 adds the reminder time interval to the current date and time to calculate the next reminder date and time (Step S326). After that, the reminder unit 148 stores the next reminder date and time in association with the received order number in the order DB 12e. After Step S326, the reminder unit 148 terminates the store message registration process. Also in this embodiment, the reminder unit 148 only has to perform the reminder e-mail sending process shown in FIG. 48.

As described above, according to this embodiment, when the item ordered is a designated medicine, the system controller 14 obtains the unshipped ordered item quantity based on the details of order(s) that have not yet been shipped among one or more orders that have been received for this item. Then, the more the unshipped ordered item quantity is, the more frequently the system controller sends the consideration information confirmation reminder e-mail. Thus, this embodiment can reduce the number of items that the store cannot ship because purchasers have not confirmed the consideration information.

### 12. Twelfth Embodiment

### 12-1. Functional Overview of System Controller

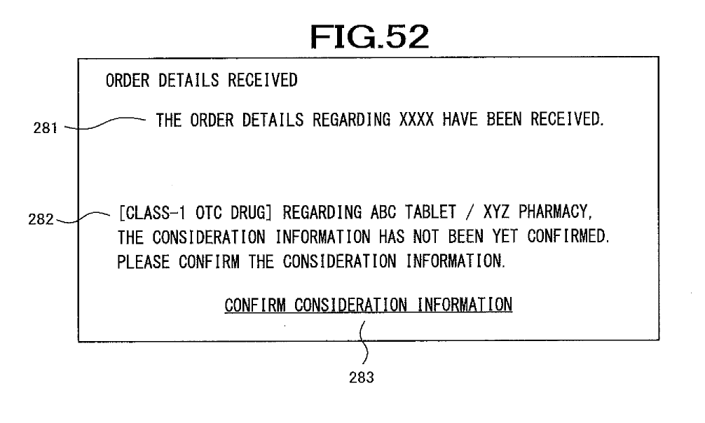

The following describes functions of the system controller 14 according to a twelfth embodiment with reference to FIG. 52. Except for points described below, the twelfth embodiment is basically the same as the first embodiment to the eleventh embodiment. In this embodiment, when sending the order detail receipt completion page for any item to the purchaser terminal 3, if the confirmation status associated with the order details, which were received from the purchaser in the past, of a designated medicine is “unconfirmed”, the order detail receiver 142 causes information prompting the purchaser to confirm the consideration information to be displayed on the order detail receipt completion page. This can remind the purchaser to confirm the consideration information at a time of not disturbing the purchaser. The order detail receiver 142 is an example of receipt information presentation control means.

FIG. 52 is a diagram showing a display example of the order detail receipt completion page. As shown in FIG. 52, the order detail receipt completion page displays a message 281 indicating that the order details have been received. The message 281 is an example of receipt information. When the purchaser has the consideration information that he/she has not confirmed, the order detail receipt completion page further displays a message 282 prompting the purchaser to confirm the consideration information and a store message confirmation link 283. The store message confirmation link 283 is a hyperlink to the message confirmation page indicated by the message 282.

### 12-2. Operation of System Controller

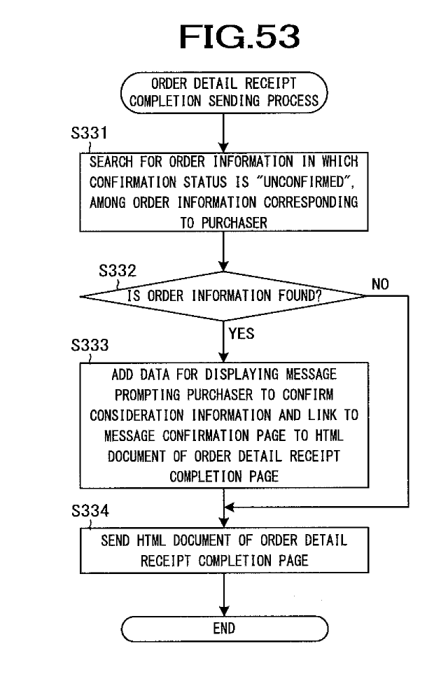

The following describes a specific operation of the system controller 14 of the online shopping mall server 1 with reference to FIG. 53. FIG. 53 is a flowchart showing an example of an order detail receipt completion sending process in the system controller 14 of the online shopping mall server 1 according to this embodiment. When the order detail registration process shown in FIG. 16 is completed, the order detail receiver 142 performs the order detail receipt completion sending process. As shown in FIG. 53, the order detail receiver 142 retrieves an HTML document, a template, of the order detail receipt completion page from the storage unit 12. Subsequently, the order detail receiver 142 obtains the user ID from the order information stored in the order detail registration process. Then, the order detail receiver 142 searches the order DB 12e for order information in which the confirmation status is “unconfirmed”, among the order information corresponding to the obtained user ID (Step S331). Next, the order detail receiver 142 determines whether such order information is found (Step S332). If the order detail receiver 142 determines that the order information is not found here (NO in Step S332), the process proceeds to Step S334. On the other hand, if the order detail receiver 142 determines that the order information is found (YES in Step S332), the process proceeds to Step S333.

In Step S333, the order detail receiver 142 adds data for displaying the message 282 and the store message confirmation link 283 to the HTML document of the order detail receipt completion page. Specifically, the order detail receiver 142 retrieves the item name corresponding to the store ID and item ID included in the found order information from the item DB 12c. Subsequently, the order detail receiver 142 generates a text, including the retrieved item name, of the message 282. The order detail receiver 142 then adds this text to the HTML document. The order detail receiver 142 also generates the URL of the message confirmation page based on the order number included in the order information. Next, the order history provider 142 adds, for example, tag data including the URL of the message confirmation page, as information for displaying the store message confirmation link 283, to the HTML document. After the order detail receiver 142 finishes Step S333, the process proceeds to Step S334. In Step S334, the order detail receiver 142 sends the HTML document of the order detail receipt completion page to the purchaser terminal 3, and terminates the order detail receipt completion sending process.

As described above, according to this embodiment, when the confirmation status associated with the past order details, which were received from the purchaser, of a designated medicine is “unconfirmed”, the system controller 14 causes the message 282 prompting the purchaser to confirm the consideration information to be presented with the message 281 indicating that the present order details have been received on the order detail receipt completion page. Thus, this embodiment can reminds the purchaser to confirm the consideration information at a time of not disturbing the purchaser.

Each of the above embodiments is applied to the online shopping mall through which the plurality of stores sell items, but may be applied to a web site through which a single store sells items.

Each of the above embodiments is applied to medicines and foodstuffs, but may be applied to other items. For example, the designated items may be an electric appliances, etc. The condition information, which is received from a purchaser, may indicate a condition of a person by whom the purchaser intends the designated item to be used, that is, a user of the designated item, or may be a condition in which the purchaser or the user intends to use the designated item. The condition in which the designated item is to be used may be a condition of a place where the designated item to be used. For example, if the item ordered is a refrigerator, which is one of the designated items, the condition of the place may be the size of a space for the refrigerator. In this case, the condition information may indicate that the width of a space for the refrigerator is 0.9 meter, and the consideration information may be “You can place the refrigerator on the space since the width of the refrigerator is 0.6 meter, and the distance between the refrigerator and the wall should be 0.1 meter or more The condition in which the designated item is to be used may be a condition of the designated item when it is used. For example, if the item ordered is a DVD recorder, which is one of the designated items, the condition of the item may be the way or the position in which the DVD recorder is placed. In this case, the condition information may indicate that the DVD recorder is to be placed in the horizontal position.

The aspects of the disclosure are not confined to the configuration listed in the foregoing embodiments, but it is easily understood that the person skilled in the art can modify such configurations into various other modes, within the scope of the aspects of the disclosure described in the claims.

1. An information system comprising:
(a) a computer storage operable to store program code;
(b) a computer processor coupled to the computer storage to read said program code and programmed to:
receive, when an item ordered by a purchaser is a designated item, condition information indicating a condition related to the use of the item, the designated item requiring a seller of the item to provide consideration information for use to the purchaser;
store order details of the items in the computer storage, when the order details of the item are received from the purchaser;
scan the received order details and determine whether the item indicated in the received order details is the designated item;
store a confirmation state of the consideration information in association with the order details stored in the computer storage, when the item indicated in the received order details is the designated item;
receive, in response to the received order details, consideration information generated based on the designated item in the order details and the received condition information;
automatically generate a confirmation webpage based on the consideration information and transmit the confirmation webpage page so that for confirmation of the consideration information by the purchaser;
receive a confirmation notification indicating that the purchaser has confirmed that the purchaser has understood the consideration information;
automatically update the confirmation state stored in the computer storage to a completed state, when the confirmation notification is received; and
output the confirmation state stored in the computer storage to determine whether a process for finalizing a sale of the designated item indicated in the order details is ready.

2. The information system according to claim 1, wherein the computer processor is further programmed to:
store, in computer storage, a processing state of payment of a purchase price of the item indicated in the order details and a shipping state of the item in association with the order details;
perform a first update of updating the shipping state to a shippable state on a condition that the processing status has been updated to the completed state, when the item indicated in the order details is not the designated item;
perform a second update of updating the shipping state to the shippable state on a condition that both the processing status and the confirmation state have been updated to the completed state, when the item indicated in the order details is the designated item; and
output the shipping state stored in the computer storage.

3. The information system according to claim 1, wherein the computer processor is further programmed to: generate a notification message webpage by embedding link information to the consideration information, when the item indicated in the order details is the designated item;
transmitting the confirmation webpage included the consideration information and a confirmation element operable for indicating that understanding of the consideration information has been confirmed, when the link information in the message webpage is selected; and
receive the confirmation notification based on operation of the confirmation element.

4. The information system according to claim 1, wherein the computer processor is further programmed to:
generates and transmits a webpage containing information for the seller regarding the order details by embedding an image that changed in appearance depending on the confirmation state to be presented with the information for the seller, when the item indicated in the order details is the designated item.

5. The information system according to claim 1, wherein the computer processor is further programmed to:
output the order details to the seller excluding a shipping address for the item when the item indicated in the order details is the designated item and the confirmation state associated with the order details is the uncompleted state.

6. The information system according to claim 1, wherein the computer processor is further programmed to:
receive entry of delivery slip information for the item indicated in the order details, wherein the delivery slip information is not received when the item is the designated item and the confirmation state associated with the order details is the uncompleted state.

7. The information system according to claim 1, wherein the computer processor is further programmed to:
output notification information notifying the purchaser that the consideration information requires confirming, when the consideration information is generated; and
cancel receipt of the order details, when the confirmation notification is not within a determined period since the notification information was output.

8. The information system according to claim 7, wherein the computer processor is further programmed to:
store, in the computer storage, the received condition information in association with the received order details; and
generate, based on at least a portion of the canceled order details, a past order webpage including a reorder element operable for reordering the item indicated in the order details and transmitting the past order webpage,
wherein,
when order details for the reorder are received based on operation of the reorder element, the computer processor obtains the condition information associated with the canceled order details as condition information to be associated with the order details for the reorder and generates a confirmation webpage related to the reorder based on the designated item in the order details and the obtained condition information and transmit the confirmation webpage for confirmation of the consideration information by the purchaser.

9. The information system according to claim 8, wherein the computer processor is further programmed to:
obtain, when the condition information associated with the canceled order details can change, the number of validity days for which the condition information is valid;
request the purchaser to reenter condition information, when the number of days elapsed between receipt of the canceled order details and operation of the reorder element exceeds the number of validity days, request information requesting; and
receive the condition information reentered by the purchaser.

10. The information system according to claim 7, wherein the computer processor is further programmed to:
obtain, when the order details received from the purchaser include a specified delivery date, a shipping deadline to deliver the item on the delivery date;
determin a confirmation deadline for the consideration information based on the shipping deadline; and
cancel receipt of the order details, when the confirmation notification is not received by the confirmation deadline.

11. The information system according to claim 1, wherein the computer processor is further programmed to:
obtain the number of reminder information output between output of notification information and receipt of the confirmation notification, the reminder information being output at a predetermined time intervals to prompt the purchaser to confirm the consideration information, the notification information notifying the purchaser that the generated consideration information requires confirming; and
determine a time interval to output the reminder information based on the obtained number, the reminder information being for the order details for which the confirmation notification has not been received since the output of the notification information.

12. The information system according to claim 1, wherein the computer processor is further programmed to:
obtain a time at which the confirmation notification is received; and
determine a time to output reminder information when the confirmation notification has not been received since output of notification information, based on the obtained time, the reminder information prompting the purchaser to confirm the consideration information, the notification information notifying the purchaser that the generated consideration information requires confirming.

13. The information system according to claim 1, wherein the computer processor is further programmed to: obtain, when the item indicated in the order details received from the purchaser is the designated item, a quantity of the item based on details of one or more orders that have not been shipped among one or more orders that have been received; and
determine a frequency to output reminder information when the confirmation notification has not been received since output of notification information, the reminder information prompting the purchaser to confirm the consideration information, the notification information notifying the purchaser that the generated consideration information requires confirming, wherein
the frequency is set higher when the number obtained quantity is higher.

14. The information system according to claim 1, wherein the computer processor is further programmed to:
presenting receipt information indicating that the order details have been received, when order details of any item are received from the purchaser, and
presenting information prompting the purchaser to confirm the consideration information with the receipt information when the confirmation state associated with past order details, received from the purchaser, of the designated item is the uncompleted state.

15. The information system according to claim 1, the condition is a condition of a person who uses the item or a condition in which the item is to be used.

16. An information processing method, which is performed by a computer, the information processing method comprising:
receiving, when an item ordered by a purchaser is a designated item, condition information indicating a condition related to the use of the item, the designated item requiring a seller of the item to provide consideration information for use to the purchaser;
storing order details of the items in a computer storage, when the order details of the item are received from the purchaser;
scanning the received order details and determine whether the item indicated in the received order details is the designated item;
storing a confirmation state of the consideration information in association with the order details stored in the computer storage, when the item indicated in the received order details is the designated item;
receiving, in response to the received order details, consideration information generated based on the designated item in the order details and the received condition information;
automatically generating a confirmation webpage based on the consideration information and transmitting the confirmation webpage page so that for confirmation of the consideration information by the purchaser;
receiving a confirmation notification indicating that the purchaser has confirmed that the purchaser has understood the consideration information;
automatically updating the confirmation state stored in the computer storage to a completed state, when the confirmation notification is received; and
outputting the confirmation state stored in the computer storage to determine whether a process for finalizing a sale of the designated item indicated in the order details is ready.

17. A non-transitory computer readable recording medium having stored thereon a computer program, the computer program when executed on a computer, causing the computer to:
receive, when an item ordered by a purchaser is a designated item, condition information indicating a condition related to the use of the item, the designated item requiring a seller of the item to provide consideration information for use to the purchaser;
store order details of the items in the computer storage, when the order details of the item are received from the purchaser;
scan the received order details and determine whether the item indicated in the received order details is the designated item;
store a confirmation state of the consideration information in association with the order details stored in the computer storage, when the item indicated in the received order details is the designated item;
receive, in response to the received order details, consideration information generated based on the designated item in the order details and the received condition information;
automatically generate a confirmation webpage based on the consideration information and transmit the confirmation webpage page so that for confirmation of the consideration information by the purchaser;
receive a confirmation notification indicating that the purchaser has confirmed that the purchaser has understood the consideration information;
automatically update the confirmation state stored in the computer storage to a completed state, when the confirmation notification is received; and
output the confirmation state stored in the computer storage to determine whether a process for finalizing a sale of the designated item indicated in the order details is ready.
